(19) United States
(12) Patent Application Publication
(10) Pub. No.: US 2026/0366313 A1
(43) Pub. Date: Nov. 19, 2026

(54) Construction 3D Printer for Printing Structures Without Utilizing a Gantry, and System Including the Same

(71) Applicant: VeruStruct, P.B.C., Dover, DE (US)

(72) Inventors: Nicholas Paul CALLEGARI, New Haven, CT (US); Konstantinos MARKOPOULOS, New Haven, CT (US)

(21) Appl. No.: 19/653,576

(22) Filed: Apr. 21, 2026

Related U.S. Application Data
(63) Continuation-in-part of application No. 19/184,732, filed on Apr. 21, 2025.
(60) Provisional application No. 63/637,141, filed on Apr. 22, 2024.

(51) Int. Cl. E04G 21/04; B33Y 10/00; B33Y 30/00; B33Y 40/20; B33Y 50/02; B33Y 80/00

(52) U.S. Cl. CPC E04G 21/04; B33Y 10/00; B33Y 30/00; B33Y 40/20; B33Y 50/02; B33Y 80/00

(57) ABSTRACT

A 3D printing apparatus can include an extruder in communication with a print material reservoir The 3D printing apparatus can be configured to print at least one layer of the print material from the at least one chamber to form a printed wall. At least one door can be configured to be maintained in the closed position for transferring the print material from the reservoir to the at least one chamber, and the at least one door can be configured to be maintained in the open position for printing a portion of the at least one layer of the print material. The 3D printing apparatus can include a locomotion device to cause the apparatus to move along a path while printing a wall. The 3D printing apparatus can include mechanisms for installing pretensioned reinforcement members and/or insulation, and an inspection system.

### CROSS REFERENCE TO RELATED APPLICATIONS

This application is a Continuation-in-Part of U.S. application Ser. No. 19/184,732 filed on Apr. 21, 2025 which claims priority to U.S. Provisional Application No. 63/637,141 filed on Apr. 22, 2024, the contents of which are incorporated herein by reference in their entirety.

### TECHNOLOGY FIELD

The present disclosure relates to 3D printers and, more particularly, to larger-scale 3D printers for construction applications.

### BACKGROUND

In recent years, 3D printing technology has become a field of great interest, with a variety of potential applications being explored across a variety of industries. One implementation of this technology involves printing large structures for use in residential and commercial building applications. The first 3D printers to garner widespread adoption were small-scale, extrusion-based desktop 3D printers that printed with plastic filaments, such as polylactic acid (PLA), acrylonitrile butadiene styrene (ABS), and polyethylene terephthalate (PET). As these printers were refined and the benefits became more tangible, other applications for 3D printing methods were explored, including larger-scale printing of structures. Filaments for these structures were not plastic-based but were more akin to concrete and pozzolanic in nature. These printers were modeled after the extrusion-based 3D printers, utilizing a Cartesian-XYZ-head gantry system that allowed the extruder head to move along the X-axis of the gantry while moving the upper portion of the gantry frame along the Y-axis and the entire gantry along the Z-axis.

Other variations of gantry-based construction printers have emerged with various methods of positioning the extruder via the gantry system, and even decoupling of the printer nozzle and the extruder (the extruder is disposed separate from the printer nozzle, with the printer nozzle being disposed on the gantry), but these printers are still gantry-based. Additionally, these printers also employ filament-based printhead nozzles, extruding a tubular stream of filament in layers via the gantry system, and resulting in a print with rotund features and uneven surface profiles (e.g., not a flat surface for finished walls of the printed structure). In these printers, accessory components necessary for the printed structure, including electrical harnessing, plumbing, HVAC ducting, insulation foam, fenestration items such as doors, windows, etc., need to be installed after the print is completed, with additional measures being necessary to appropriately hide many of these components for safety and aesthetic considerations.

### SUMMARY

In one general aspect, a 3D printing apparatus includes an extruder including at least one form chamber in communication with a print material reservoir via at least one feed line to receive a print material from the reservoir. Each chamber among the at least one chamber can include at least one door configured to transition between a closed position and an open position. The 3D printing apparatus can be configured to print at least one layer of the print material from the at least one chamber to form a printed wall. The at least one door can be configured to be maintained in the closed position for transferring the print material from the reservoir to the at least one chamber. The at least one door can be configured to be maintained in the open position for printing a portion of the at least one layer of the print material.

In some embodiments, the 3D printing apparatus can further include at least one translational mechanism configured to translate at least the extruder along a printing path to print the at least one layer of the print material in sections along the printing path.

In some embodiments, the 3D printing apparatus can be further configured to continuously print the at least one layer of the print material as the at least one translational mechanism translates the at least one extruder along the printing path.

In some embodiments, the at least one layer of the print material can include multiple layers of the print material that are vertically stacked one on top of another.

In some embodiments, the 3D printing apparatus can further include a lift mechanism configured to vertically lift at least the extruder to print a subsequent layer among the multiple layers of the print material on a previously printed layer among the multiple layers of the print material.

In some embodiments, the at least one layer of print material can include multiple layers of print material. The extruder can further include a wall channel embossment configured to form a wall channel in each layer of the multiple layers of the print material, the wall channel extending in a direction of the printing path. The 3D printing apparatus can be further configured to: insert the at least one translational mechanism in the wall channel of a previously printed layer among the multiple layers of the print material; and move within the wall channel of the previously printed layer when printing, on the previously printed layer, a current layer among the multiple layers of the print material.

In some embodiments, the 3D printing apparatus can further include a lift assembly configured to vertically lift the at least one translational mechanism and insert the at least one translational mechanism in the wall channel of the previously printed layer.

In some embodiments, the 3D printing apparatus can further include at least one armature configured to route any one or more of electrical harnessing, flexible plumbing, conduit, and associated hardware within the wall channel.

In some embodiments, the previously printed layer can be disposed two or more layers below the current layer.

In some embodiments, the 3D printing apparatus can further include at least one armature or truss device configured to stabilize the printer during the printing of the current layer, wherein the at least one armature is configured to follow a profile of the printed wall formed and correct an orientation of the printing apparatus based on signals from one or more on-board sensors.

In some embodiments, the 3D printing apparatus can be further configured to have sections of the chambers extend past the length of a singular printed layer, allowing for orientation of the printing apparatus based on moment reactions from the chamber walls on the previously disposed layer.

In some embodiments, the at least one translational mechanism can be further configured to move at least the extruder along a ground surface when printing a ground layer among the at least one layer of the print material.

In some embodiments, the at least one translational mechanism can include at least one set of wheels.

In some embodiments, the 3D printing apparatus can further include a curing device configured to cure at least a portion of the print material within the at least one chamber.

In some embodiments, the curing device can be further configured to at least partially cure the at least a portion of the print material while printing the at least one layer of the print material.

In some embodiments, the curing device can include any one or any combination of any two or more of a UV curing device, a dehydration or drying device, a pressurizing device, and a chemical insertion device configured to harden the print material within the at least one chamber.

In some embodiments, the 3D printing apparatus can further include any one or any combination of any two or more vibration mechanisms, including pivotal rotational and oscillating devices and lineal vertical and uniform devices, operating, e.g., via eccentric rotating mass motors, piezoelectric actuators, or other mechanical transmission devices to agitate and help the material disposed within the form chambers settle.

In some embodiments, the 3D printing apparatus can further include any one or any combination of any two or more pressure application mechanisms, including pneumatic, hydraulic, or mechanical systems to translate force over an area within the form chambers to compress the disposed material within the chambers.

In some embodiments, the 3D printing apparatus can further include at least one tension rod installation mechanism configured to install at least one vertically extending tension rod member in the at least one layer of the print material or in the cavity formed between at least two sections of the printed material disposed from two separate chambers.

In some embodiments, the 3D printing apparatus can further include at least one tension rod installation mechanism configured to place a vertically extending tension rod member in an uncured portion of the print material being filled in the at least one chamber. The at least one tension rod installation mechanism can include either one of an armature mechanism and an insertion mechanism including a gear assembly and a threaded rod driven by the gear assembly.

In some embodiments, the vertically extending tension rod member can be disposed in one layer among the at least one layer of the print material. The at least one armature mechanism can be further configured to interlock the vertically extending tension rod member with another vertically extending tension rod member disposed in another layer, among the at least one layer of the print material, that is below the one layer.

In some embodiments, the 3D printing apparatus can further include at least one tension rod installation mechanism. The at least one tension rod installation mechanism can include: a drilling mechanism configured to drill a vertically extending hole through the at least one layer of material; an armature mechanism configured to insert a vertically extending tension rod member in the vertically extending hole; and a filling mechanism configured to fill a space around the vertically extending tension rod member in the vertically extending hole with a filler material to set the vertically extending tension rod member in the vertically extending hole.

In some embodiments, the 3D printing apparatus can be configured to translate at least the extruder along a printing path to print the at least one layer of the print material in sections along the printing path. The at least one door can include a front door and a rear door. When in the closed position, the front and rear doors can create a sealed volume that prevents leakage of the print material outside of the chamber when the chamber is in communication with a ground surface or a previously printed layer beneath the chamber, among the at least one layer. The front and rear doors can be configured to open at an angle sufficient to allow the 3D printing apparatus to move along the previously printed layer without the previously printed layer contacting the front and rear doors. The 3D printing apparatus can be further configured to maintain the front and rear doors in the closed position during printing initiation for a given layer, among the at least one layer of the print material. The 3D printing apparatus can be further configured to open the rear door when the at least one extruder starts translating and printing the at least one layer along the printing path in a forward direction, and to maintain the rear door in the open position while printing the at least one layer along the printing path in the forward direction.

In some embodiments, the 3D printing apparatus can be further configured to open the front door when the at least one extruder starts translating and printing the at least one layer along the printing path in a rearward direction, and to maintain the front door in the open position while printing the at least one layer along the printing path in the rearward direction.

In some embodiments, the at least one chamber can include at least one inner chamber and at least one outer chamber laterally spaced apart from the at least one inner chamber. The 3D printing apparatus can be further configured to print at least one laterally inner wall layer, in the at least one layer of the print material, from the at least one inner chamber. The 3D printing apparatus can be further configured to print at least one laterally outer wall layer, in the at least one layer of the print material, from the at least one outer chamber. The at least one laterally outer wall layer can be laterally spaced apart from the at least one laterally inner wall layer. The at least one laterally inner wall layer can form an inner wall and the at least one laterally outer wall layer can form an outer wall.

In some embodiments, the at least one chamber can further include at least one middle chamber disposed between and laterally spaced apart from the at least one inner chamber and the at least one outer chamber. The 3D printing apparatus can be further configured to print at least one laterally central wall layer, in the at least one layer of the print material, from the at least one middle chamber. The central wall layer can be disposed between and laterally spaced apart from the laterally inner wall layer and the laterally outer wall layer. The at least one laterally central wall layer can form a central wall.

In some embodiments, the 3D printing apparatus can further include an insulation installation mechanism configured to spray, pump, or mechanically insert an insulation material within a space formed between the inner wall and the outer wall.

In some embodiments, the 3D printing apparatus can further include at least one tension rod installation mechanism configured to install a horizontal tension rod member between a section of the at least one inner wall layer and a section of the at least one outer wall layer.

In some embodiments, the at least one tension rod installation mechanism can include an armature mechanism configured to install the horizontal tension rod member between an uncured portion of the print material formed by the at least one inner chamber and an uncured portion of the print material formed by the at least one outer chamber.

In some embodiments, the at least one tension rod installation mechanism can include an armature mechanism configured to install a horizontal tension rod member between a partially cured section of the at least one inner wall layer and a partially cured section of the at least one outer wall layer while the extruder is moving along a path to print a next section of the at least one inner wall layer and a next section of the at least one outer wall layer.

In some embodiments, the at least one chamber can include flexible chamber walls formed of at least a shape-memory material, a silicone material, or an elastomer material, and the 3D printing apparatus can further include a chamber shaping device configured to shape the flexible chamber walls to radius a section of the at least one layer of print material.

In some embodiments, the chamber shaping device can include any one or more of a heating device configured to heat the flexible chamber walls, a cooling device configured to cool the flexible chamber walls, and an electromagnetic device configured to apply an electromagnetic field to the flexible chamber walls.

In some embodiments, the 3D printing apparatus can further include shaping arm members and any one of pneumatic actuators, hydraulic actuators, and electric actuators configured to actuate the shaping arm members to apply mechanical pressure to bend a section of the at least one layer of print material to a specified radius.

In some embodiments, the 3D printing apparatus can further include a routing assembly configured to route the print material to the at least one chamber and control a flow rate of the print material to the at least one chamber.

In some embodiments, the 3D printing apparatus can further include at least one controller configured to control the receipt of the print material from the reservoir, the printing of the at least one layer of the print material, the transitioning of the door between the closed position and the open position.

In some embodiments, the 3D printing apparatus can further include a power supply configured to supply power to the extruder, wherein the power supply is configured to be recharged via connection to either one or both of an AC current supply and photovoltaic cells.

In some embodiments, the 3D printing apparatus can further include: at least one sensor configured to sense a quality of the print material; and at least one controller configured to control the printing of the at least one layer based on the sensed quality of the print material.

In some embodiments, the 3D printing apparatus can further include: at least one sensor configured to sense the position of the 3D printing apparatus in space; and at least one controller configured to control the printing dynamics of the at least one layer and the position of the 3D printing apparatus based on the sensed position.

In other embodiments, the a translational slipform device for three-dimensional (3D) printing of a structure comprises an extruder comprising at least one chamber for receiving a print material, a material supply in communication with the at least one chamber via at least one feed line, a translational mechanism configured to translate the extruder along a printing path, an outer formwork structure defining an outer perimeter of a wall section to be printed, an inner formwork structure coupled to the rigid outer formwork structure, the inner formwork structure being configured to move relative to the outer formwork structure between a proximal state, wherein the inner framework structure defines a cross section of a wall element in combination with the outer formwork structure, and a remote state for creating clearance between the inner formwork structure and the cross section of a wall element and a plurality of internal doors disposed within the at least one chamber, each internal door configured to transition between an engaged position to direct a flow of the print material and a disengaged position to permit unobstructed flow of the print material.

In some implementations, the inner formwork structure comprises at least one set of inner formwork structures extending in an X-orientation and at least one set of inner formwork structures extending in a Y-orientation, each set of inner formwork structures being movable between the proximal state and the remote states and wherein the device is configured to selectively activate the plurality of internal doors to define at least two distinct channels for the print material within the at least one chamber, thereby defining at least two wythes as wall elements of the structure when 3D printing is accomplished.

Other features and aspects will be apparent from the following detailed description, the drawings, and the claims.

### BRIEF DESCRIPTION OF THE DRAWINGS

FIG. 1 depicts a printing system including a 3D printing apparatus for printing a structure formed of a print material, a material supply for supplying the print material to the 3D printing apparatus, and a feed line connecting the material supply to the 3D printing apparatus.

FIG. 2 depicts a profile view of the 3D printing apparatus of FIG. 1, illustrating a dual-section extruder configuration, with an outer extruder section and inner extruder section respectively printing sections of an inner wall and an outer wall of the structure in parallel, according to an embodiment.

FIG. 3 depicts a profile view of the 3D printing apparatus of FIG. 1, with wheels of a wheel articulator apparatus disposed on a ground surface, according to an embodiment.

FIG. 4 depicts cross-sections of the 3D printing apparatus of FIG. 1, showing a print material flow routing assembly configured to selectively route print material to each of front and rear extruder chambers, according to an embodiment.

FIGS. 5A and 5B depict profile views of the 3D printing apparatus of FIG. 1, illustrating internal volumes of the extruder chambers, according to an embodiment.

FIG. 6 depicts a cross-section of two volumes in an extruder chamber, according to an embodiment.

FIGS. 7A to 7E depict a process for extruder chamber actuation during forward-direction printing operations, including first-layer printing, according to an embodiment.

FIG. 8 depicts an accessory routing mechanism including armatures for routing accessory components within a wall channel, according to an embodiment.

FIGS. 9A and 9B depict accessory component clamps for clamping a routed accessory component in a wall channel, according to embodiments.

FIG. 10 depicts a printing system including the 3D printing apparatus and the material supply of FIG. 1, a spool holding one or more routed accessory components, and a main feed line connecting the material supply to the 3D printing apparatus and configured to feed the one or more routed accessory components to the 3D printing apparatus, according to an embodiment.

FIGS. 11 and 12 depict profile views of triple-section extruders, according to embodiments.

FIG. 13 depicts a configuration of the 3D printing apparatus of FIG. 1 in which a wheel articulator apparatus includes six total wheel articulators each having a respective set of wheels that are attached thereto and disposed in the wall channels of previously printed layers of the inner and outer walls to print current layers of the inner and outer walls, according to an embodiment.

FIGS. 14A to and 14B depict a process for moving the 3D printing apparatus of FIG. 1 upward to print respective next layers on top of most recently printed layers of the inner and outer walls using the wheel articulator apparatus, according to an embodiment.

FIGS. 15A and 15B depict profile views of a wheel articulator apparatus including eight wheel articulators, according to an embodiment.

FIGS. 16A and 16B depict profile views of a wheel articulator apparatus including four wheel articulators, according to an embodiment.

FIG. 17 depicts a profile view of a fenestration being printed, with limiting dimensional parameters of the 3D printer apparatus of FIG. 1 labeled to show a relationship between these dimensional parameters and a size of a fenestration to be included in a printed wall, according to an embodiment.

FIG. 18 depicts example curved walls, along with limiting extruder chamber parameters to illustrate the relationship between the extruder chamber parameters and a radius of wall sections, according to an embodiment.

FIGS. 19-47 depict a process of printing corners of first and second walls, according to an embodiment.

FIG. 48 depicts a base plate and the wheel articulators, and movement vectors for the base plate and the wheel articulator bases, according to an embodiment.

FIG. 49 depicts a profile view of a 3D printing system configured to form flexible vertical tension rods in a printed structure, according to an embodiment.

FIG. 50 depicts an example process flow for a method of inserting a flexible vertical tension rod into a wall of a printed structure, according to an embodiment.

FIG. 51 depicts an example process flow for a method of inserting a flexible vertical tension rod that does not require insertion of substrate into a drilled interstitial volume, according to an embodiment.

FIGS. 52A and 52B depict a rigid vertical tension rod formed of rigid vertical tension rod segments connected by interlocking elements, according to an embodiment.

FIG. 53 depicts a tension rod sorting and funneling mechanism, according to an embodiment.

FIG. 54 depicts a cross-section view of a method for inserting a rigid vertical tension rod segment into an uncured layer of a wall and interlocking the inserted rigid vertical tension rod segment with another rigid vertical tension rod segment below, according to an embodiment.

FIG. 55 depicts rigid horizontal tension rods being inserted into an outer wall and an inner wall of a structure, according to an embodiment.

FIG. 56 depicts a profile view of a 3D printing apparatus including a power supply, according to an embodiment.

FIG. 57 is a profile view of a printing system including two alternative locations for a power supply for a 3D printing apparatus, according to embodiments.

FIG. 58 depicts a printing system including a 3D printing apparatus configured to print windows in addition to a main structural body of a structure, a window material mixing chamber, and a window material feed line, according to an embodiment.

FIG. 59 depicts a partial view of a printing assembly of the printing apparatus of FIG. 58, illustrating structural filament extruder chambers and dedicated window extruder chambers, according to an embodiment.

FIGS. 60A and 60B depict an extruder chamber and an angle adjustment mechanism configured to adjust an angle of incline of sidewalls of the extruder chamber with respect to a vertical direction, according to an embodiment.

FIG. 61A depicts a profile view of a door of the extruder chamber of FIGS. 60A and 60B in open and closed position, when the side walls of the extruder chamber are substantially vertical.

FIG. 61B depicts a profile view of the door of the extruder chamber of FIGS. 60A and 60B in open position and a closed position, when the sidewalls of the extruder chamber are inclined with respect to the vertical direction.

FIG. 62 depicts a profile view of an extruder chamber having flexible sidewalls formed of a shape-memory material, and a chamber shaping device configured to shape the flexible sidewalls.

FIG. 63 depicts a view of wall bending or shaping device for bending or shaping a layer of a print structure, according to an embodiment.

FIGS. 64A to 64H depict a printing assembly of a 3D printing apparatus printing a corner portion of a structure, according to an embodiment.

FIG. 65A schematically depicts an embodiment of a 3D printing apparatus,

FIGS. 65B-65H schematically depict various stages of operation of the apparatus depicted in FIG. 65A,

FIGS. 66A and 66B are schematic drawings depicting controllers in communication with various mechanisms and components of a 3D printing apparatus, according to an embodiment.

FIG. 67A is a perspective view of a 3D printing apparatus in accordance with another disclosed implementation.

FIG. 67B is a top view of the 3D printing apparatus shown in FIG. 67A

FIG. 68A is a partial view of a chamber defined by a form in accordance with disclosed implementations.

FIG. 68B is a cross sectional view of a form in an engaged/printing position.

FIG. 68C is a cross-sectional view of a form in a disengaged position.

FIG. 68D is a cross sectional view of a pair of two layer wythes printed in accordance with disclosed implementations.

FIG. 69 is a schematic diagram of a 2D printer in accordance with disclosed implementations showing a specific printing state.

FIG. 70 is a schematic diagram of a 2D printer in accordance with disclosed implementations showing a specific printing state.

FIG. 71 is a schematic diagram of a 2D printer in accordance with disclosed implementations showing a specific printing state.

FIG. 72 is a schematic diagram of a 2D printer in accordance with disclosed implementations showing a specific printing state.

FIG. 73 is a schematic diagram of a 2D printer in accordance with disclosed implementations showing a specific printing state.

FIG. 74 is a schematic diagram of a 2D printer in accordance with disclosed implementations showing a specific printing state.

FIG. 75 illustrates a wheel arrangement in accordance with disclosed implementations.

FIG. 76A illustrates a cantilever track extension mechanism, in a retracted position, for printing fenestrations in accordance with disclosed implementations.

FIG. 76B illustrates a cantilever track extension mechanism, in an extended position, for printing fenestrations in accordance with disclosed implementations.

FIG. 77 illustrates a movable mass mechanism for changing the center of mass of a printer in accordance with disclosed implementations.

FIG. 78 illustrates use of a filler material for printing fenestrations in accordance with disclosed implementations.

FIG. 79 78 illustrates another example of use of a filler material for printing fenestrations in accordance with disclosed implementations.

FIG. 80 illustrates a mechanism for providing changeable forms in accordance with disclosed implementations.

FIG. 81 illustrates translational slipform device equipped with an integrated inspection system in accordance with disclosed implementations.

FIG. 82 illustrates a top view of a slipform device with possible locations of various sensors in accordance with disclosed implementations.

FIG. 83 illustrates a bottom view of a slipform device with possible locations of various sensors in accordance with disclosed implementations.

FIG. 84 illustrates a slip form device configured to install a continuous reinforcing material in accordance with disclosed implementations.

FIG. 85A illustrates a reinforcement installation mechanism mounted on a multi-axis robotic armature in accordance with disclosed implementations.

FIG. 85B illustrates a reinforcement installation mechanism mounted on a multi-axis robotic armature in accordance with disclosed implementations.

FIG. 86A illustrates pre-tensioning mechanism that includes a mechanical actuator system in accordance with disclosed implementations.

FIG. 86BA illustrates pre-tensioning mechanism that includes a mechanical actuator system in accordance with disclosed implementations.

FIG. 87A illustrates a gripper and reaction frame system as pre tensioning mechanism in accordance with disclosed implementations.

FIG. 87B illustrates a gripper and reaction frame system as pre tensioning mechanism in accordance with disclosed implementations.

FIG. 88A illustrates how holes can be formed by controlling material flow to commence at the specific section where the hole is being created in accordance with disclosed implementations.

FIG. 88B illustrates how holes can be formed by controlling material flow to commence at the specific section where the hole is being created in accordance with disclosed implementations.

FIG. 89A illustrates how a core piece is lifted up and utilized to create the hole at the next layer in accordance with disclosed implementations.

FIG. 89B illustrates how a core piece is lifted up and utilized to create the hole at the next layer in accordance with disclosed implementations.

FIG. 89C illustrates how a core piece is lifted up and utilized to create the hole at the next layer in accordance with disclosed implementations.

FIG. 90 illustrates how anchors are placed in accordance with disclosed implementations.

FIG. 91 illustrates an anchor being installed on an inner surface of a wythe in accordance with disclosed implementations.

FIG. 92 illustrates an eyehook anchor 9200 with a cast-in anchor plate 9204 being installed between the inner and outer wythes in accordance with disclosed implementations.

FIG. 93 illustrates a winch or capstan drive utilized to pull a cable taught to the appropriate amount of tension in accordance with disclosed implementations.

FIG. 94 illustrates telescopic feeding of reinforcing members via an extendable insertion guide in accordance with disclosed implementations.

FIG. 95 illustrates an insulation installation system designed to deposit loose-fill insulation materials in accordance with disclosed implementations.

FIG. 96 illustrates an anchor element of various configurations in accordance with disclosed implementations.

FIG. 97 illustrates an example of reinforcement element installation in accordance with disclosed implementations.

FIG. 98 illustrates the reinforcement placement process during construction of a subsequent wall layer in accordance with disclosed implementations.

FIG. 99 illustrates a representative wall section in which a continuous configured reinforcing bar runs through successive wall wythes in accordance with disclosed implementations.

FIG. 100 illustrates sleeves and reinforcing elements including couplings to allow connection of element segments into a single reinforcing element in accordance with disclosed implementations.

FIG. 101 illustrates a first segment of a hollow bar inserted into a formed opening as reinforcing segment in accordance with disclosed implementations.

FIG. 102 illustrates a sequential process of installing and attaching threaded steel bar reinforcement segments within a wall during a second layer printing stage in accordance with disclosed implementations.

FIG. 103 illustrates a representative wythe section illustrating segmented threaded reinforcing elements connected by a mechanical coupler in accordance with disclosed implementations.

### DETAILED DESCRIPTION

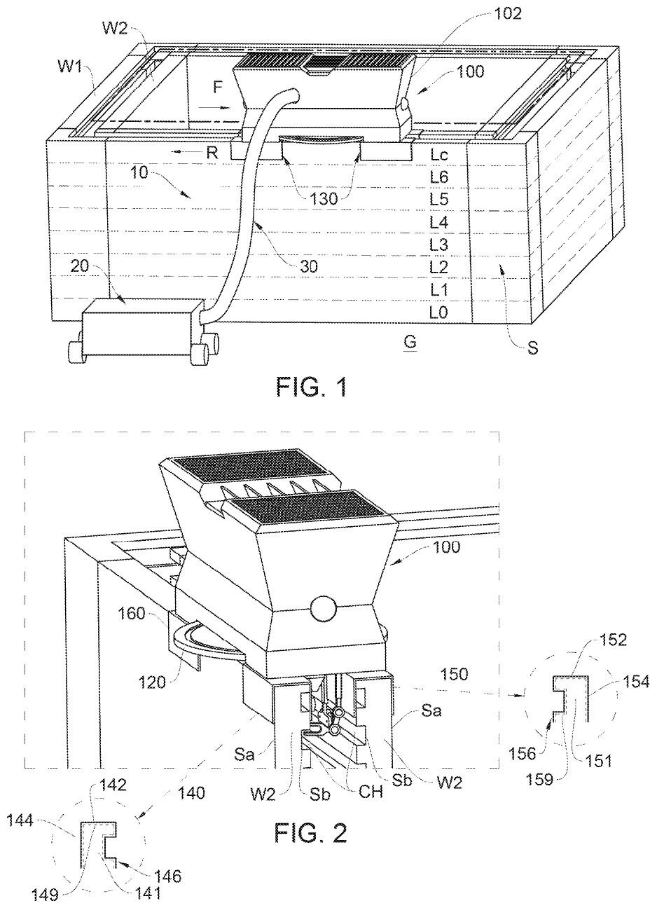

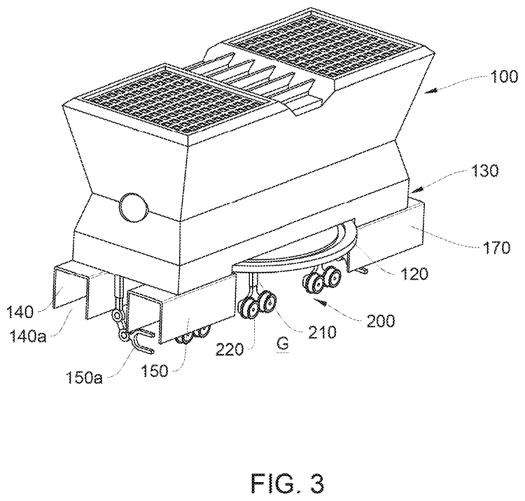

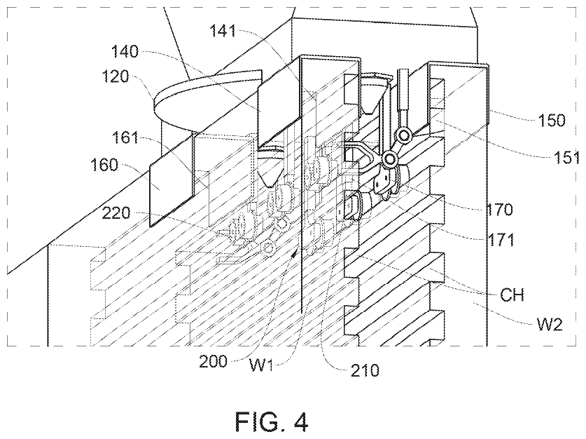

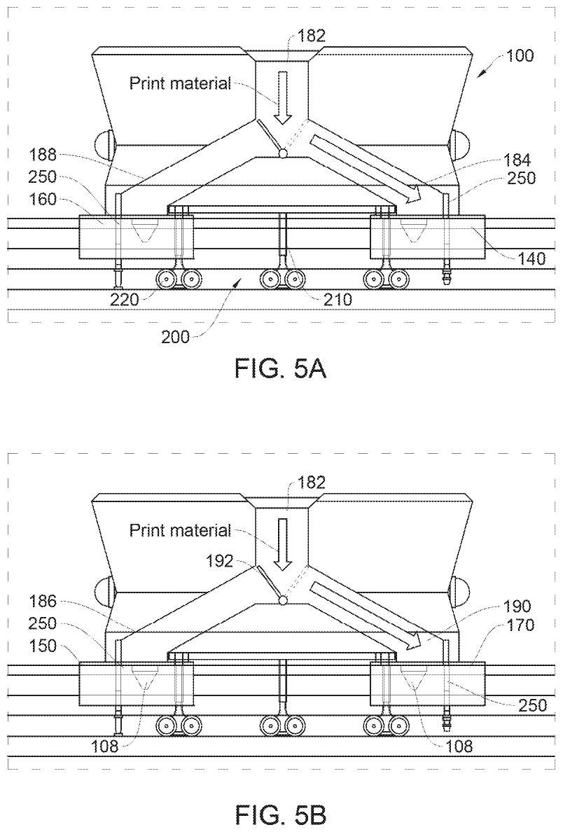

FIG. 1 depicts a printing system 10 including a 3D printing apparatus 100 for printing a structure S formed of a print material, a material supply 20 for supplying the print material to the 3D printing apparatus 100, and a feed line 30 connecting the material supply 20 to the 3D printing apparatus 100. FIG. 2 depicts a profile view of the 3D printing apparatus 100, illustrating a dual-section extruder configuration, with an outer extruder section E1 and an inner extruder section E2 respectively printing sections of an outer wall W1 and an inner wall W2 of the structure S in parallel, according to an embodiment. FIG. 3 depicts a profile view of the 3D printing apparatus 100, with wheels of a wheel articulator apparatus 200 disposed on a ground surface G, according to an embodiment. FIG. 4 depicts cross-sections of the 3D printing apparatus 100, showing a print material flow routing assembly (“routing assembly”) 110 configured to selectively route print material from the feed line 30 to an outer front extruder chamber 140, an inner front extruder chamber 150, an outer rear extruder chamber 160, and an inner rear extruder chamber 170. FIG. 5 depicts a profile view of the 3D printing apparatus 100, illustrating internal volumes 148, 158, 168, and 178 of the extruder chambers 140, 150, 160, and 170, according to an embodiment.

Referring to FIG. 1, the material supply 20 includes a reservoir storing a volume of the print material (e.g., structural filament). The print material can be, for example, a concrete material or a pozzolanic material, which may include a variety of admixtures, including water-reducing admixtures, accelerating admixtures, retarding admixtures, air-entraining admixtures, superplasticizers, binding admixtures, and other admixtures, and a variety of aggregates, including calcined clay, limestone, basalt rock, sand, crushed rocks of various forms, olivine sand, and other granular materials. However, the print material is not limited to these materials and can be, for example, plastic materials, such as polylactic acid (PLA), acrylonitrile butadiene styrene (ABS), and polyethylene terephthalate (PET), hemp plant materials, soil and earth-based materials, steel and iron dust deposit waste materials, mycelium mushroom materials, epoxy resin materials, wax materials, and clay materials including natural clays, oil-based clays, epoxy clays, and polymer clays. In some embodiments, as illustrated in FIG. 1, the material supply 20 can be a follower cart configured to follow the 3D printing apparatus 100, by rolling or otherwise translating along the ground surface G, as the 3D printing apparatus 100 moves to print the structure S. However, the material supply 20 is not limited to a follower cart. In some embodiments, the material supply 20 can be a stationary device, and in other embodiments, the material supply 20 can be mounted on or incorporated in the 3D printing apparatus 100.

The material supply 20 can include a pump configured to pump the print material to the 3D printing apparatus 100 through the feed line 30. Alternatively, the material supply 20 can be positioned at a higher elevation than the 3D printing apparatus 100 and can be configured to flow the print material to the 3D printing apparatus 100 through the feed line 30 by a gravity feed.

As shown in FIGS. 1-3, 5A, and 5B, the 3D printing apparatus (“printing apparatus”) 100 includes a housing 102 having an internal volume, and to which the extruder 130 is attached. Referring to FIGS. 1-6, the extruder 130 is configured to receive the print material from the material supply 20/feed line 30 and print the print material to form the structure S. In the example illustrated in FIG. 1, the structure S includes the outer wall W1 and the inner wall W2 extending substantially parallel to each other. Each wall W1, W2 can be formed of multiple layers L0-Lc of print material. The layers L0 to Lc are stacked vertically in sequence, with a next layer among the layers L0 to Lc being formed on top of a previously printed layer among the layers L0 to Lc. L0 is a first, or ground layer, and Lc is a top, or current layer.

In the example illustrated in FIGS. 1 and 2, the walls W1, W2 are laterally spaced apart, and each extends along a rectangular path corresponding to a printing path P of the extruder 130/printing apparatus 100, and thus forms the structure S to have a substantially rectangular perimeter shape. As will be described later in more detail, the extruder 130 can be mounted on a rotatable base plate 120, as shown in FIG. 2, to enable the extruder 130 to rotate with respect to the housing 102 for printing corner regions of the walls W1, W2. Although the example walls W1, W2 and structure S are formed in a rectangular pattern, the apparatus 100 is not limited to forming walls and structures of any particular shape. For example, the apparatus 100 can print walls and structures along a circular or oval path, or a path having serpentine or stepped sections. Printing of various wall/structure shapes are facilitated by the extruder 130 being rotatably mounted on the base plate 120.

Although FIG. 1 shows each wall W1, W2 including eight layers or printed material, any number of layers is possible. Further, in FIG. 1, L0 is a ground layer printed directly on a ground surface. However, in some embodiments, the first layer L0 can be printed on top of a base or a platform that is supported on the ground surface G.

As shown in FIG. 1, the extruder 130 can be configured to move along the printing path P in a forward direction F or a rearward direction R, driven by a translational mechanism, to print each layer L0 to Lc, one layer at a time, and can print a layer of each wall W1, W2 in a same operation (e.g., at approximately the same time). That is, as will be described later in more detail, the extruder 130 can print one layer of the print material, among the layers layer L0 to Lc, of each wall W1, W2 and, after completing the one layer, the extruder 130 can rise up and print a subsequent layer, among the layers layer L0 to Lc, of each wall W1, W2 on top of the previously printed one layer. A more specific description of the extruder 130 is provided below with reference to FIGS. 2 to 5B.

Referring to FIGS. 2 to 5B, the extruder 130 can include the outer front extruder chamber 140, the inner front extruder chamber 150, the outer rear extruder chamber 160, and the inner rear extruder chamber 170. The outer front extruder chamber 140 and the outer rear extruder chamber 160 are included in the outer extruder section E1 and are configured to print the layers L0 to Lc of the outer wall W1. The inner front extruder chamber 150 and the inner rear extruder chamber 170 are included in the inner extruder section E2 and are configured to print the layers L0 to Lc of the inner wall W2. The outer front extruder chamber 140 and the outer rear extruder chamber 160 are laterally spaced apart from the inner front extruder chamber 150 and the inner rear extruder chamber 170. The extruder chambers 140, 150, 160, 170 receive the print material from the material supply 20/feed line 30 and form a respective section of a layer (e.g., one of layers L0 to Lc) of the respective wall W1, W2 in an inner volume 141, 151, 161, 171 (see FIG. 4) of each extruder chamber 140, 150, 160, 170. After one or more extruder chambers 140, 150, 160, 170 print the respective section(s) of a layer of the respective wall W1, W2, the extruder 130/printing apparatus 100 can move a predetermined distance along the path P.

Each extruder chamber 140, 150, 160, 170 can be configured to print a respective section of a layer of the respective wall W1, W2 having a shape corresponding to the shape of the respective inner volume 141, 151, 161, 171. In the illustrated embodiments, the inner volumes 141, 151, 161, 171 have a generally rectangular prism shape, and thus the printed sections also have a generally rectangular prism shape. FIG. 2 shows example configurations of the outer front extruder chamber 140 and the inner front extruder chamber 150. As shown in FIG. 2, the outer front extruder chamber 140 includes a top wall 142, an outer side wall 144, and an inner side wall 146 that define the inner volume 141. Similarly, the inner front extruder chamber 150 includes a top wall 152, an outer side wall 154, and an inner side wall 156 that define the inner volume 151. The outer front extruder chamber 140 has an open bottom 140a and the inner front extruder chamber 150 has an open bottom 150a. The inner side walls 146, 156 can have an inwardly projecting embossment or protrusion 147, 157. The embossment or protrusion forms a rectangular wall channel section in each printed section that, in combination with the wall channel sections of a remainder of the printed sections in a layer of the respective wall W1, W2, forms a continuous rectangular-shaped wall channel CH in the inner side surface SB of the layer of the respective wall W1, W2 (see FIGS. 2 and 4-5B). As will be described later in more detail, the wall channel CH can be engaged by the translational mechanism of the extruder 130/printing apparatus 100 to support the extruder 130/3D printing apparatus 100 while the extruder 130/printing apparatus 100 moves along the path P and prints a subsequent layer of each wall W1, W2 on top of the layer including the wall channel CH that is engaged by the translational mechanism. The outer side surface SA of the layer of each wall W1, W2 can be substantially flat.

Although the embodiments of FIGS. 2 and 4-5B are shown and described as providing wall channels CH in the inner side surfaces SB of the layers of the walls W1, W2, the extruder chambers 140, 150, 160, 170 can be configured in any number of ways to provide different configurations of the wall channels CH. For example, the extruder chambers 140, 150, 160, 170 can be configured to form the wall channels on the outer side surfaces SA of the walls W1, W2 in addition to or instead of the inner side surfaces SB. Additionally or alternatively, the extruder chambers 140, 150, 160, 170 can be configured to form decorative features on the outer side surfaces SA.

While FIG. 2 only illustrates the detailed configurations of the outer front extruder chamber 140 and the inner front extruder chamber 150, it is to be understood that the outer rear extruder chamber 160 and the inner rear extruder chamber 170 can have the same or similar configurations.

The extruder chambers 140, 150, 160, 170 can selectively and repeatedly print respective sections of a layer (e.g., one of layers L0 to Lc) as the extruder 130/printing apparatus 100 moves along the path P in increments, until the layer is completed. In some embodiments, the 3D printing apparatus can partially or fully cure printed sections of a layer before moving itself/the extruder 130 to print subsequent sections. FIG. 2 illustrates curing devices 149, 159 installed in the outer front and inner front extruder chambers 140, 150. The curing devices 149, 159 can be substantially flat devices shaped to conform to the inner surfaces of the outer front and inner front extruder chambers 140, 150, respectively, and thus can form part of the structure for shaping the sections of printed material. For example, the curing devices 149, 159 can be UV curing devices, dehydration or drying devices, pressurizing devices, and chemical insertion devices.

As shown in FIGS. 5A and 5B, the printing apparatus 100 can include a print material routing assembly 180 configured to selectively route the print material to the extruder chambers 140, 150, 160, 170 and control a flow rate of the print material to the extruder chambers 140, 150, 160, 170. The material routing assembly 180 includes an inlet path 182 configured to receive the print material from the feed line 30, a first extruder feed path 184 configured to flow the print material to the outer front extruder 140, a second extruder feed path 186 configured to flow the print material to the inner front extruder 140, a third extruder feed path 188 configured to flow the print material to the outer rear extruder 160, and a fourth extruder feed path 190 configured to flow the print material to the inner rear extruder chamber 170. The print material routing assembly 180 can further include a flow control apparatus 192 configured to selectively place the inlet path 182 in communication with any one or more of the first, second, third, and fourth extruder feed paths 184, 186, 188, thereby controlling which one(s) of the first, second, third, and fourth extruders 140, 150, 160, 170 print a section of a layer of print material in a respective wall W1, W2. The flow control apparatus 192 can include a multi-way valve or door, or multiple valves or doors. Operation of the flow control apparatus 192 to determine one or more specific extruder chambers 140, 150, 160, 170 to print a respective section of a layer of print material can be based on desired configuration of a portion of the layer.

While the embodiment of FIGS. 5A and 5B includes four extruder feed paths, any number of extruder feed paths can be provided, and the number of extruder feed paths can correspond to the number of extruder chambers such that each extruder feed path is in communication with a respective extruder chamber.

The inner front extruder chamber 150, the outer rear extruder chamber 160, and the outer rear extruder chamber 170 can each be configured to selectively receive the print material from the material supply 20/feed line 30 and form (e.g., print) respective sections of the respective wall (the outer wall W1 or the inner wall W2).

The structure S can be a large-scale structure, such as a portion of a residential or commercial building. However, the structure S can be any type of structure, including a small-scale structure. In the example of FIG. 1, the structure S is a double-wall rectangular structure. However, a structure printed by the printing system 10 is not limited to such a rectangular structure. Any shape is possible for the printed structure, including circular structures, oval structures, and other structures with non-linear wall shapes.

Referring to FIGS. 1-5, the 3D printing apparatus 100 can include the routing assembly 110, which is configured to receive the print material from the material supply 20, and an extruder 130 including the outer front extruder chamber 140, the inner front extruder chamber 150, the outer front extruder chamber 160, and the outer rear extruder chamber 170, each of which is in communication with the reservoir via the feed line 30 to receive the print material from the material supply 20.

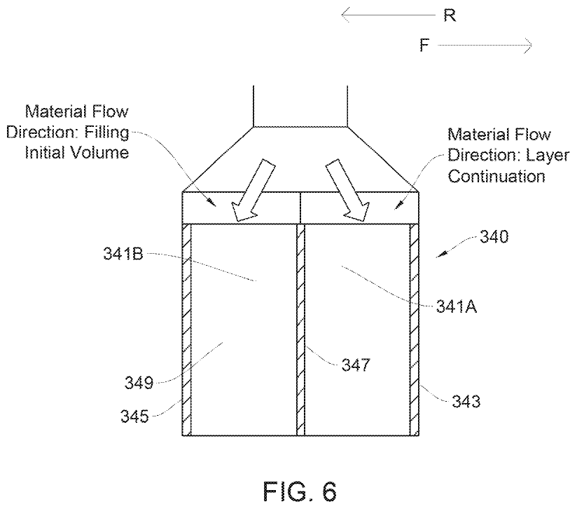

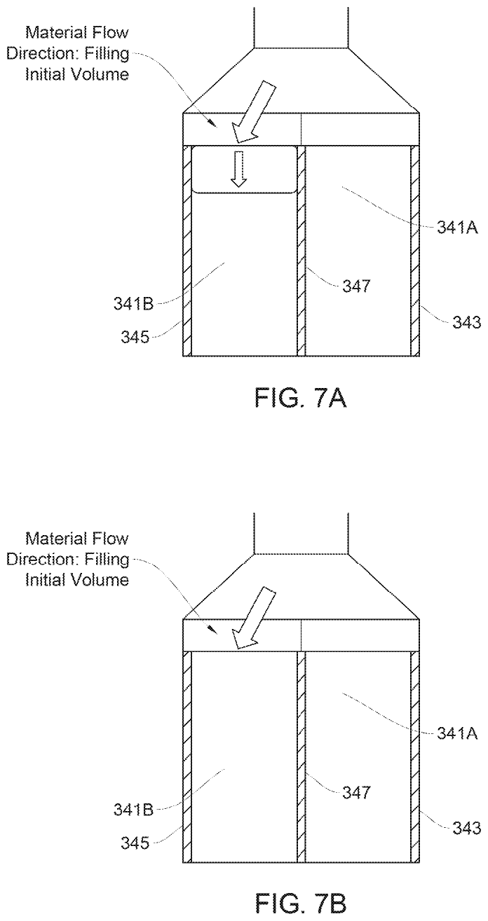

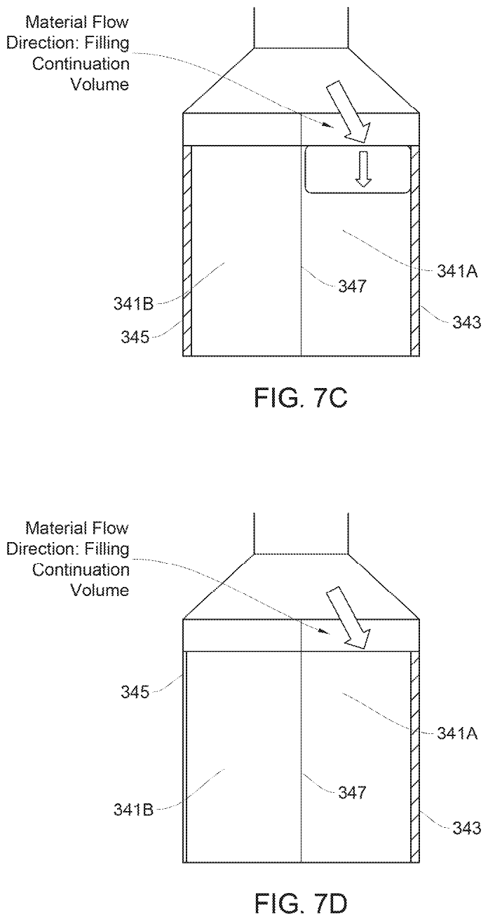

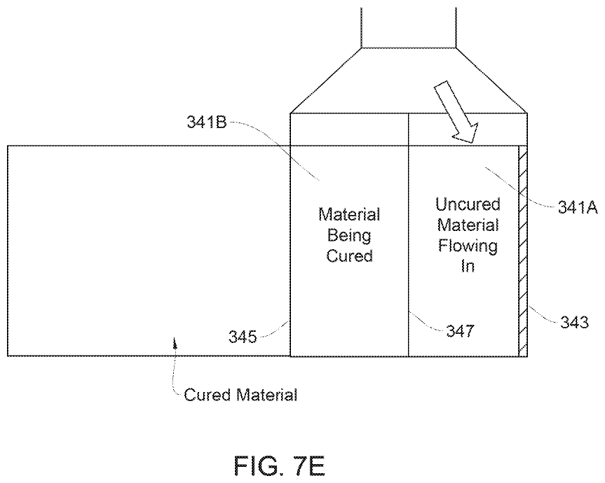

FIG. 6 depicts a cross-section of two volumes in an extruder chamber 340, according to an embodiment. The extruder chamber 340 is configured for printing a layer of a wall (e.g., the outer wall W1 or the inner wall W2), with the extruder (e.g., the extruder 130) moving in increments in the forward direction F (“forward-direction printing”). The extruder chamber 340 may correspond to any of the extruder chambers 140, 150, 160, 170 previously described herein. Referring to FIG. 6, the extruder chamber 340 can include a first door 343 disposed at one end of the extruder chamber 340, a second door 345 disposed at another end of the extruder chamber 340 opposite the one end of the extruder chamber 340, and a third, inner door 347 disposed in a middle region of the inner volume of the extruder chamber 340. In FIG. 6, the front door 343, the rear door 345, and the inner door 347 are illustrated in a closed position. As will be described later in more detail with respect to FIGS. 7A-7E, each of the doors 343, 345, 347 can be selectively configured in an open position or the closed position (e.g., by actuation of a motorized assembly to slide or pivot the doors 343, 345, 347 open or closed).

The interior volume of the extruder chamber 340 includes a first sub-volume 341A and a second sub-volume 341B that are disposed adjacent to each other in the forward direction F and the rearward direction R. The third door 347, when closed as shown in FIG. 6, separates the first sub-volume 341A and the second sub-volume 341B from each other. When the extruder is performing forward direction printing, the first door 343 is a front door, the second door 345 is a rear door, the first sub-volume 341A is a front sub-volume, and the second sub-volume 341B is a rear sub-volume. At least the rear sub-volume 341B includes a curing device 349 therein that conforms to a shape of the inner surface of the extruder chamber 340 and is configured to cure print material in the rear sub-volume 341B. The curing device 349 can be similar to the curing devices 149, 159 described above with respect to FIG. 2.

Still referring to FIG. 6, the rear sub-volume 341B can be a new layer print volume that is filled with a first flow of the print material. The curing device 349 can at least partially cure the print material in the rear sub-volume 341B to form a section of cured print material. The front sub-volume 341A can be a layer continuation print volume that is filled with a second flow of the print material. After the section of at least partially cured print material is formed or during curing of the print material in the rear sub-volume 341B, the front sub-volume 341A can be filled with the second flow of the print material to form a section of uncured print material adjacent to the section of cured material, which can be cured by the curing device 349 as the extruder chamber 340 moves forward and the rear sub-volume 341B passes over the section of uncured material. An example process of printing a layer in a forward-direction printing operation will be described below with respect to FIGS. 7A-7E.

FIGS. 7A-7E depict a process for actuation of the extruder chamber 340 during forward-direction printing, including first-layer printing, according to an embodiment. Referring to FIGS. 7A and 7B, when the printing apparatus (e.g., the 3D printing apparatus 100) begins printing a layer of a wall or other part of a structure, the extruder chamber 340 is configured such that all three doors 343, 345, 347 are in the closed position. First, the rear sub-volume 341B can be filled with a first flow of the print material, thereby printing a section of print material (e.g., forming a rectangular prism with a wall channel CH formed on the inside surface thereof). This section of print material can be at least partially cured by the curing device 349.

As shown in FIGS. 7C and 7D, once the section of print material is printed and at least partially cured, the inner door 347 can be moved to the open position and the front sub-volume 341A can be filled with uncured print material to print a section of uncured print material adjacent to and in front of the at least partially cured section of print material, and the rear door 345 can be moved to the open position, exposing a flat, finished rear face of the at least partially cured section of print material, and thus allowing the extruder chamber 340 to begin printing the rest of the layer. Thereafter, as shown in FIG. 7E, the extruder chamber 340 can continue printing the rest of the layer by moving in the forward direction F by a distance substantially equal to a length of the at least partially cured section of print material, such that rear sub-volume 341B at least partially cures the uncured print material previously printed in the front sub-volume 341A as the front sub-volume 341A is again filled with uncured print material to print a next section of uncured print material. The extruder chamber 340 can repeat this process to complete printing of the layer.

For printing a layer in a reverse printing process in which the extruder is to move in the rearward direction R, the configurations and actuations of the front sub-volume 341A and the rear sub-volume 341B can be swapped. Additionally, for a reverse printing process, the rear door 345 can operate according to the described operation of the front door 343 in the forward printing process. It is noted that, the operations of FIGS. 7A-7E described above apply when the extruder chamber 340 is configured as a front extruder chamber in the printing apparatus such as the printing apparatus 100 of FIGS. 1 to 5B, However, when the extruder chamber 340 is configured as a rear extruder chamber, both the front door 343 and the rear door 345 must be in the open position to permit movement of the extruder chamber 340 in the forward direction F or the rearward direction R.

Additionally, in some embodiments, the inner door 347 can be omitted from the extruder chamber 340 and the curing device can be disposed substantially throughout the inner volume of the extruder chamber 340. In such embodiments, the extruder chamber 340 can print a section of print material by filling the entire inner volume of the extruder chamber 340 with uncured print material and at least partially curing the printed section of print material, before moving forward or rearward by a distance substantially equal to a length of the at least partially cured section of print material. When the printing apparatus is moving in the forward direction, the rearward door is open, allowing disposed material to pass through, while the forward door is closed, creating a cavity within the chamber. This cavity is filled with uncured material that is then cured partially or fully as the printer continues to move forward. For rearward direction printing, the flow of the material is redirected towards the rear door, the forward door remains open, and the cavity is filled with uncured material as the printing apparatus moves in the rearward direction, where the uncured material is then partially or completely cured as the printer translates in the rearward direction.

Referring back to FIGS. 3-5B, the extruder 130/printing apparatus 100 includes a translational mechanism for supporting the extruder 130/printing apparatus 100 on the ground surface or previously printed layers of the walls W1, W2. As shown in FIGS. 3-5B, the translational mechanism can include a wheel articulator apparatus 200 including a plurality of wheel articulators 210 (e.g., legs) and a set of motorized wheels 220 attached to each wheel articulator 210. Each set of motorized wheels 220 can include one or more motorized wheels.

Referring to FIG. 3, when the extruder 130 is printing the first layers L0 (FIG. 1) of the walls W1, W2 of the structure S on the ground surface G, the wheel articulators 210 are configured such that the sets of wheels 220 support the extruder 130/printing apparatus 100 on the ground for translational (e.g., rolling) movement on the ground surface G along the printing path P. As will be described later in more detail, in some embodiments, the wheel articulators 210 can also be configured such that the sets of wheels 220 support the extruder 130/printing apparatus 100 on the ground surface G when the extruder 130 is printing the second layers L1 (FIG. 1) of the walls W1, W2.

Referring to FIGS. 4-5B, when the extruder 130 is printing layers (e.g., second or higher layers in some embodiments, or third or higher layers in some embodiments) of the walls W1, W2 on top of respective one or more previously printed layers, the wheel articulators 210 can be configured such that the sets of wheels 220 engage the wall channel CH of the one or more previously printed layers. Thus, the wheel articulators 210 and sets of wheels 220 support the extruder 130/printing apparatus 100 in the wall channel CH of one of the previously printed layers in each wall W1 and the sets of wheels 220 can roll in the respective wall channel CH to enable the extruder 130/printing apparatus 100 to roll along the printing path P.

Additionally, as shown in FIGS. 5A and 5B, the translational mechanism can include one or more armature devices or truss devices 250 configured to stabilize the extruder 130/printing apparatus 100 during the printing of a current layer. The armature devices or the truss devices 250 can be configured to follow profiles of respective printed portions of the walls W1, W2 and correct an orientation extruder 130/printing apparatus 100 based on signals from one or more on-board sensors.

While this disclosure provides specific examples of a translational mechanism including the wheel articulators 210 and the sets of wheels 220, the disclosure is not limited to these examples. In some implementations, a translational mechanism for the printing apparatus can include roller-driven rotating belts, instead of the sets of wheels 220, that are connected to articulating legs and configured to be inserted in the wall channels CH or engage the ground surface G. In some embodiments, instead of including the wheel articulators 210 and the sets of wheels 220, a translational mechanism can include a plurality of articulating legs having feet that are configured to be inserted in the wall channels CH or engage the ground surface G. In such embodiments, the articulating legs and the feet can be configured to move in walking motions to enable the printing apparatus to “walk” along the printing path P.

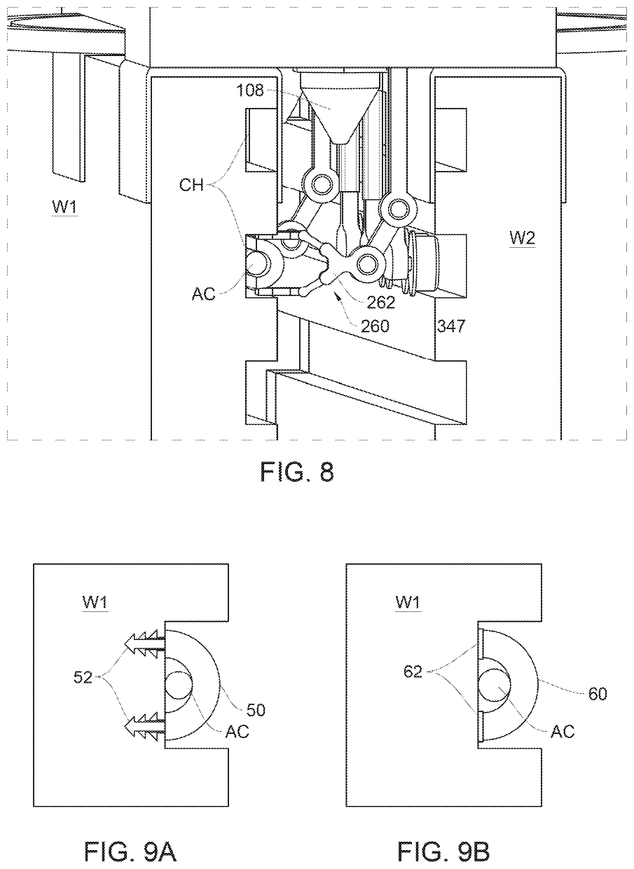

FIG. 8 depicts an accessory routing mechanism 260 including armatures 262 for routing accessory components AC within a wall channel CH, according to an embodiment. FIGS. 9A and 9B depict accessory component clamps 50 and 60 for clamping a routed accessory component AC in a wall channel CH, according to embodiments.

Referring to FIG. 8, the accessory routing mechanism 260 can be configured to receive the one or more routed accessory components AC that are fed into the housing 102 of the printing apparatus 100. The armatures 262 can be motorized and can be in the form of clamp arms. The armatures 262 can be configured to grip the routed accessory components and insert the routed accessory components AC into a wall channel CH in a wall W1 or W2. Thus, the wall channels CH can function to provide efficient and tidy installation of the routed accessory components AC in the structure S.

Referring to FIGS. 9A and 9B, the armature 262 can secure the routed accessory components AC in the wall channel CH by attaching a barbed clamp 50 or a an adhesively attachable clamp 60 to the wall W1/W2. The armature 262 can be operated to wrap the barbed clamp 50 around a portion of the routed accessory components AC and insert barbs 52 on the ends of the barbed clamp 50 into the wall W1/W2. Alternatively, the armature 262 can be operated to wrap the adhesively attachable clamp 60 around a portion of the routed accessory components AC and attach adhesive portions 62 on the ends of the adhesively attached clamp 60 to the wall W1/W2. Alternatively, the armature 262 can be operated to insert conduit directly into the uncured or partially cured substrate, which will then be cured via the printer or over time via natural processes related to the material being utilized, to hold the conduit in place. Alternative embodiments have armatures 262 outfitted with pressurized, either hydraulically or pneumatically, devices that either insert staples, clamps or the conduit itself directly into the uncured or partially cured disposed material.

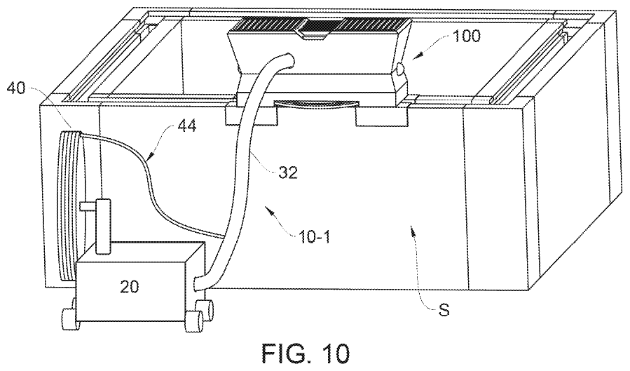

FIG. 10 depicts a printing system 10-1 including the printing apparatus 100, the material supply 20, a spool 40 holding one or more routed accessory components AC, and a main feed line 32 connecting the material supply 20 to the 3D printing apparatus 100 and configured to feed the one or more routed accessory components AC to the 3D printing apparatus 100. In the system of FIG. 10, the spool 40 can supply the accessory mounted components AC to the accessory routing mechanism 260 through a routed components feed line 44 that feeds the accessory mounted components AC through the main feed line 32.

In some embodiments, the printing apparatus 100 can be configured to install insulation material in the structure S. In some implementations, the printing apparatus 100 can include an insulation installation mechanism 108 configured to spray, pump, or mechanically insert an insulation material within a space formed between the inner wall W1 and the outer wall W2. The insulation material can include insulation foam or sheets of insulation fiber. For example, referring to FIGS. 5A, 5B, and 8, the insulation installation mechanism 108 can include at least one nozzle connected to a pressure source (e.g., a pump, a blower, or a pressurized vessel) and configured to spray or pump insulation foam within the space formed between the inner wall W1 and the outer wall W2. In other implementations, an insulation installation mechanism can include one or more armatures configured to carry insulation material and place the insulation material in the space between the inner wall W1 and the outer wall W2.

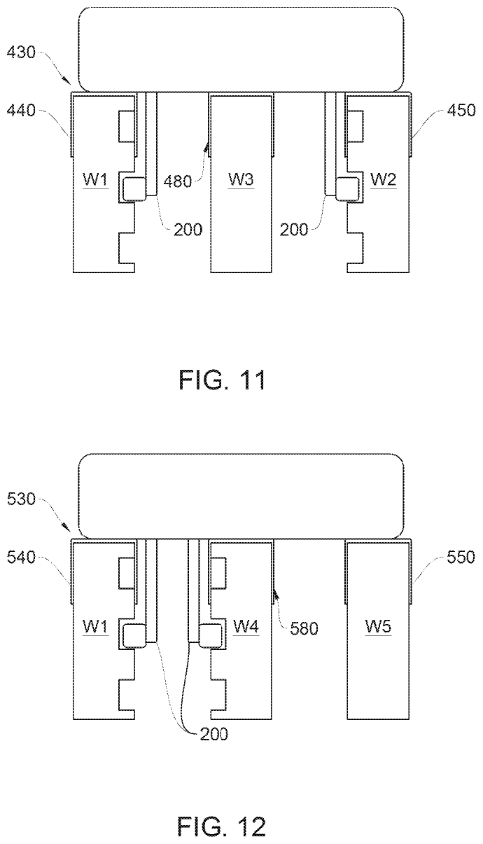

3D printing apparatuses according to the disclosure herein are not limited to an extruder including two extruder sections for printing two walls as in the embodiment of FIG. 1. Any number of extruder sections and extruder chambers are possible, and extruder chambers can be configured to print layers and walls configured differently than those previously described. FIGS. 11 and 12, described below, depict additional embodiments to provide only a few examples of additional extruder and wall configurations that are possible from the inventive concepts disclosed herein.

FIG. 11 depicts a profile view of a triple-section extruder 430, according to an embodiment. The extruder 430 includes one or more outer extruder chambers 440 and one or more inner extruder chambers 450 configured to print the outer wall W1 and the inner walls W2, respectively, including the wall channels CH for the wheel articulator apparatus 200. The extruder 430 further includes one or more middle extruder chambers 480 configured to print a middle wall W3, which is a structural reinforcement wall lacking the wall channels CH, between the outer wall W1 and the inner wall W2.

FIG. 12 depicts a profile view of a triple-section extruder 530, according to an embodiment. The extruder 530 includes one or more outer extruder chambers 540 configured to print the outer wall W1 including the wall channels CH for the wheel articulator apparatus, one or more middle extruder chambers 580 configured to print a middle wall W4 including the wall channels CH for the wheel articulator apparatus 200, and one or more inner extruder chambers 550 configured to print an inner wall W5, which is an aesthetic wall lacking the wall channels CH.

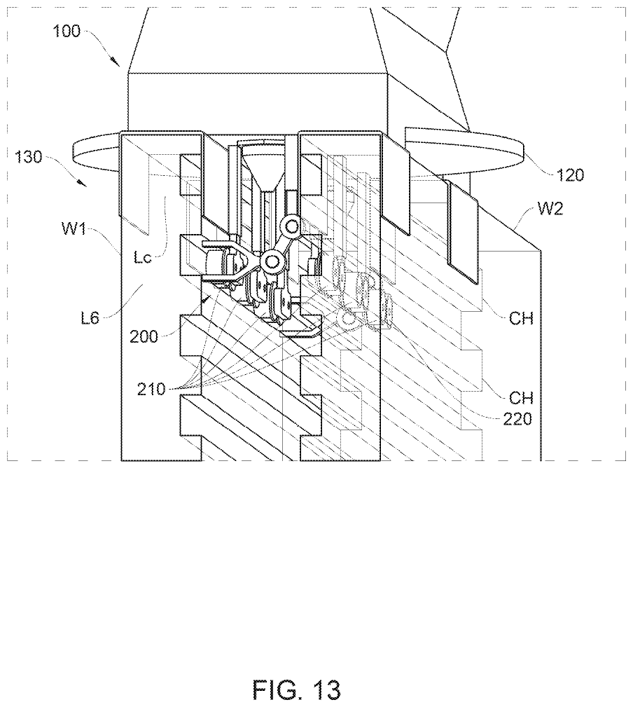

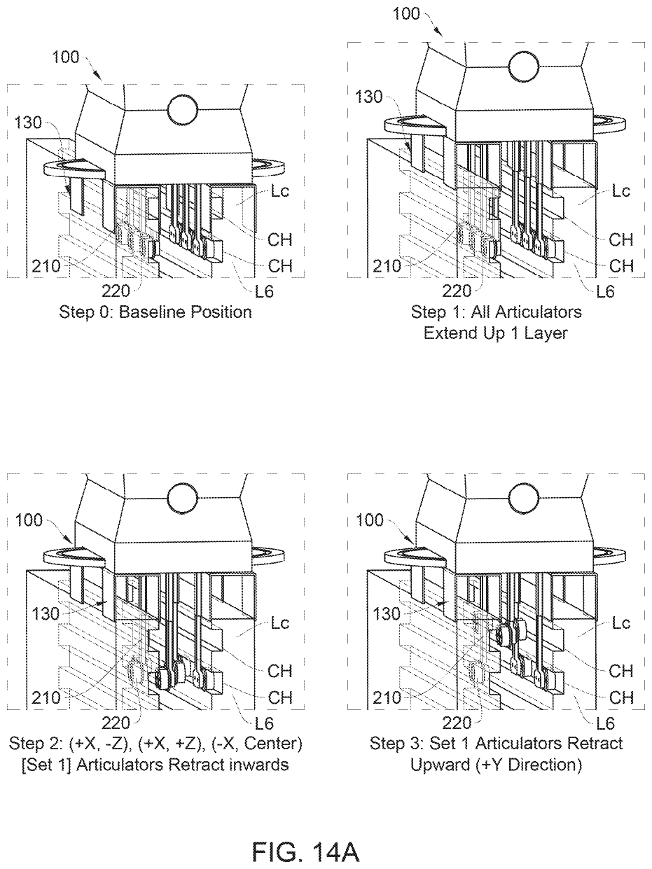

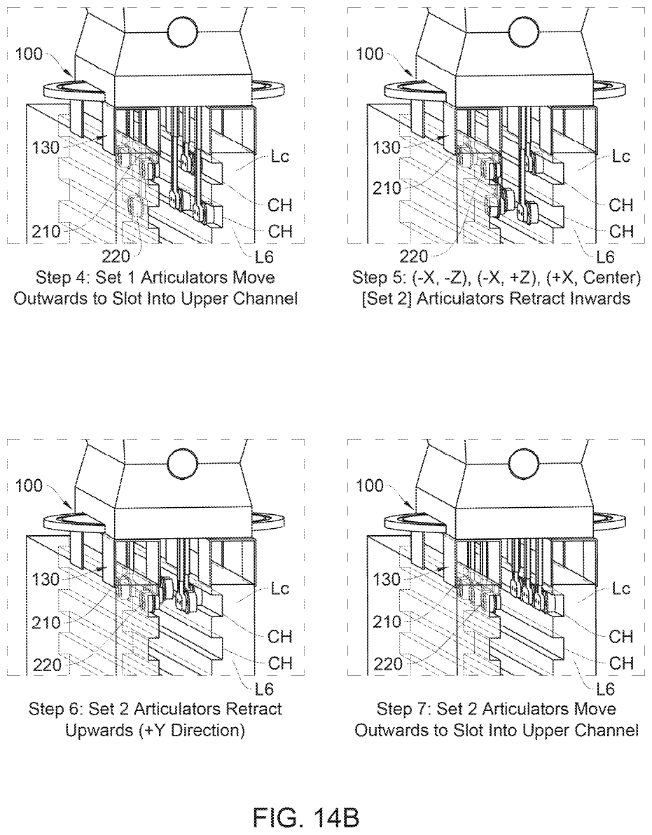

FIG. 13 depicts a configuration of the printing apparatus 100 in which the wheel articulator apparatus 200 includes six total wheel articulators 210 having respective sets of wheels 220 that are attached thereto and disposed in the wall channels of previously printed layers of the inner and outer walls W1, W2 to print current layers of the inner and outer walls W1, W2. FIGS. 14A and 14B depict a process for moving the printing apparatus 100 upward to print respective next layers on top of most recently printed layers of the inner and outer walls W1, W2 using the wheel articulator apparatus 200, according to an embodiment.

Referring to FIG. 13, when the printing apparatus 100 is printing current layers of the walls W1, W2, the printing apparatus 100 is configured to maintain the sets of wheels 220 of the wheel articulators 210 inserted in the wall channels CH of respective previously printed layers (“previously printed wall channels”) of the walls W1, W2, and move the sets of wheels 220 within these previously printed wall channels CH as previously described. When the current layers are first layers L0 (see FIG. 1) printed on the ground surface, the printing apparatus 100 is configured to maintain the sets of wheels 220 of the wheel articulators 210 engaged with the ground surface, and move the sets of wheels on the ground surface G. By way of example only, FIG. 13 illustrates an example in which the current layers are layers Lc and the sets of wheels 220 are inserted into the wall channels CH of previously printed layers L6, which are the most recently printed layers. The process described below with respect to FIGS. 14A and 14B can generally apply to other layers of the walls W1, W2.

When the printing apparatus 100 has completed printing the current layers Lc, the current layers Lc become previously printed layers, and more specifically, the most recently printed layers. The printing apparatus 100 can prepare to print next layers on top of the most recently printed layers Lc. An example process for preparing to print the next layers is depicted in FIGS. 14A and 14B, which are described below.

The wheel articulator apparatus 200 can include a lift mechanism configured to move the printing apparatus 100 as illustrated in FIGS. 14A and 14B to print the next layers. More specifically, the lift mechanism can include an assembly of motorized actuators configured to selectively move any one or more of the wheel articulators 210 vertically (e.g., up and down), laterally (e.g., inward and outward), and longitudinally (e.g., forward and backward). Additionally, although it is not necessary for movement of the printing apparatus 100 to print a next layer on top of a most recently printed layer, the lift mechanism can selectively rotate any one or more of the wheel articulators 210 about their longitudinal axes (e.g., parallel to a vertical axis). The wheel articulators 210 can be selectively moved in these directions individually, collectively in groups including only selected groups of the wheel articulators 210, and collectively all together. FIG. 48 illustrates an example of movement vectors for the wheel articulators 210.

Referring to FIG. 14A, when the printing apparatus 100 has finished printing the most recently printed layer Lc, the three wheel articulators 210 on a first side of the printing apparatus 100 are positioned such that all of the sets of wheels 220 attached to these wheel articulators 210 are positioned in the wall channel CH of the previously printed layer L6 of the first wall W1, and the three wheel articulators 210 on a second side of the printing apparatus 100 are positioned such that all of the sets of wheels 220 attached to these wheel articulators 210 are positioned in the wall channel CH of the previously printed layer L6 of the second wall W2. Next, in Step 1 of FIG. 14A, the lift mechanism can extend all of the wheel articulators 210 upward by a distance approximately equal to the height of one layer to move the extruder 130 upward to a proper height for printing a next layer of each wall W1, W2.

Next, in Step 2 of FIG. 14A, the lift mechanism can move a first set of the wheel articulators 210 laterally inward such that the sets of wheels 220 attached to the first set of the wheel articulators 210 are removed from the wall channel CH of the previously printed layer L6 of the first wall W1. In some embodiments, the first set of the wheel articulators 210 can include, for example, the left, front wheel articulator 210, the left, rear wheel articulator 210, and the right middle wheel articulator 210.

Then, in Step 3 of FIG. 14A, the lift mechanism can retract the first set of wheel articulators 210 upward. Referring to FIG. 14B, in Step 4, the lift mechanism can then move the first set of the wheel articulators 210 laterally outward such that the sets of wheels 220 attached to the first set of the wheel articulators 210 are inserted into the wall channel CH of the most recently printed layer Lc of the first wall W1.

Thereafter, in Step 5 of FIG. 14B, the lift mechanism can move a second set of wheel articulators 210 laterally inward such that the sets of wheels 220 attached to the second set of the wheel articulators 210 are removed from the wall channel CH of the previously printed layer L6 of the second wall W2. In some embodiments, the second set of the wheel articulators 210 can include, for example, the right, rear wheel articulator 210, the right, front wheel articulator 210, and the left middle wheel articulator 210.

Next, in Step 6 of FIG. 14B, the lift mechanism can retract the second set of wheel articulators 210 upward. Then, in step 7 of FIG. 14B, the lift mechanism can move the second set of the wheel articulators 210 laterally outward such that the sets of wheels 220 attached to the second set of the wheel articulators 210 are inserted into the wall channel CH of the most recently printed layer Lc of the second wall W2. After completing Step 7 of FIG. 14B, the printing apparatus is ready to print the next layers of the first and second walls W1, W2.

In some embodiments, the lift apparatus is capable of extending the wheel articulators to move the extruder 130 upward by a distance equal to or greater two or more times the height of a layer. Accordingly, in some embodiments, the extruder 130 can print two or more layers of each of the first and second walls W1, W2 by moving the extruder 130 upward to perform each of two or more consecutive layer printings for the first and second walls W1, W2, before needing to move the wheel articulators 210 as described above to move the sets of wheels 210 from the wall channels CH currently engaged by the sets of wheel to wall channels CH above the currently engaged wall channels CH. Thus, in some embodiments, the printing apparatus 100 can print the first two or more layers of the first and second walls W1, W2 on the ground surface G before needing to insert the sets of wheels 220 in the wall channels CH of a previously printed layer. Further due to the ability to extend the wheel articulators upward to move the extruder 130 upward by two or more layers, depending on the desired printing operation, the sets of wheels 220 can be inserted in the wall channels CH of a most recently printed layer or the wall channels CH of a previously printed layer that is two or more layers below the layer currently being printed.

Although the description of FIGS. 14A and 14B describes a particular process for preparing the printing apparatus to print next layers of the first and second walls W1, W2, the disclosure is not limited to the described process. For example, the first and second groups of wheel articulators 210 can be reversed. Additionally, a different combination and/or number of wheel articulators 210 can be included in the first set of wheel articulators 210 and the second set of wheel articulators 210. In some embodiments, the inner and outer form chambers can support the weight of the extruder utilizing previously disposed material during wheel articulation operations, allowing for many or all wheel articulators to be towards the central axis of the printing apparatus and not contacting disposed material during articulation operations.

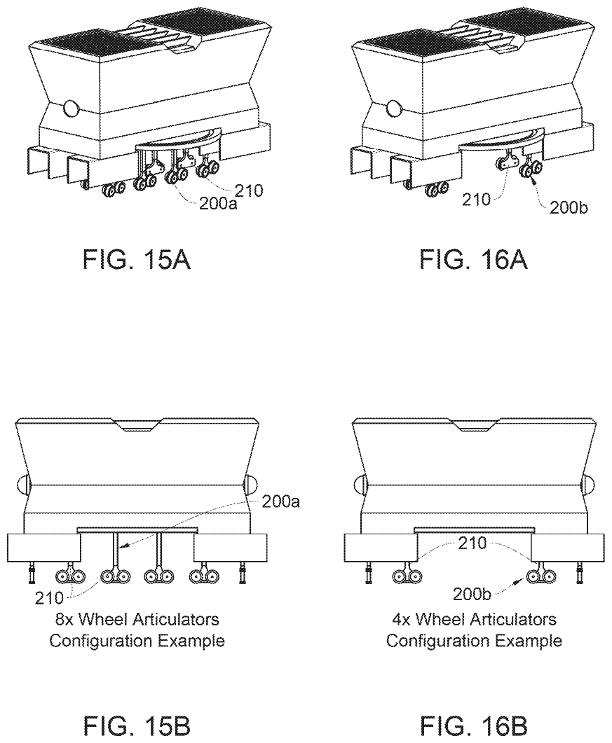

Additionally, the disclosed wheel articulator apparatus is not limited to including six wheel articulators 210, and any number of wheel articulator apparatuses is possible. For example, FIGS. 15A and 15B depict profile views of a wheel articulator apparatus 200a including eight wheel articulators 210, according to an embodiment. Additionally, FIGS. 16A and 16B depict profile views of a wheel articulator apparatus 200b including four wheel articulators 210, according to an embodiment.

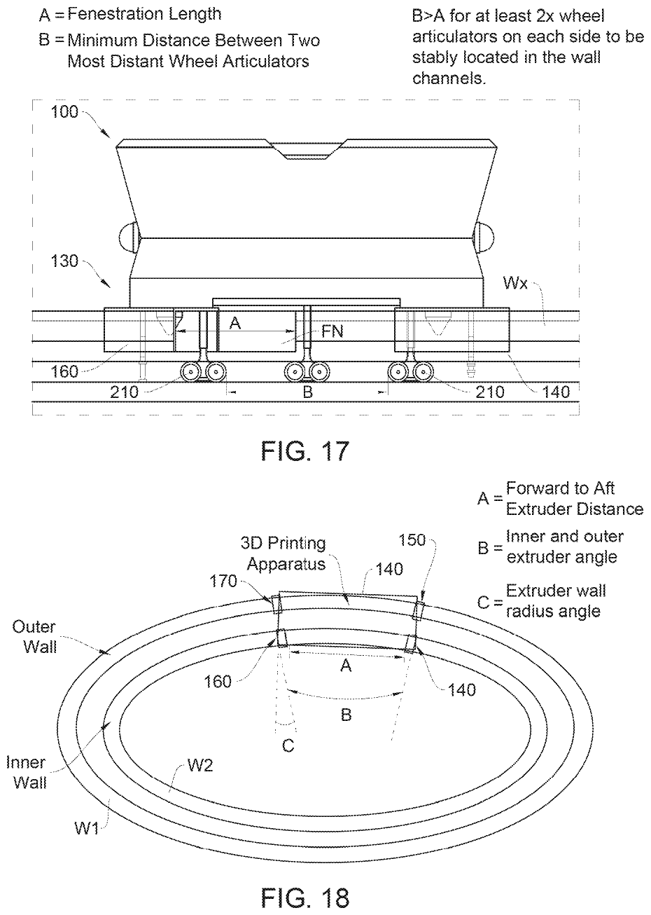

The printing apparatus 100 has the ability to print sections of wall with openings for fenestrations such as entryways, windows, and other fenestrations. This is possible given the number of wheel articulators 210 utilized coupled with the length of the extruder 130 (e.g., the extruder chambers 140, 150, 160, and 170). FIG. 17 depicts a profile view of a fenestration FN being printed, with limiting dimensional parameters of the 3D printer apparatus 100 labeled to show a relationship between these dimensional parameters and a length of a fenestration FN to be included in a printed wall Wx, according to an embodiment.

Referring to FIG. 17, the maximum fenestration length A is determined based on the requirement that at least two wheel articulators 210 on either side of the printing apparatus 100 be stably located within wall channels CH at any given time during the print of the fenestration FN. Thus, as shown in FIG. 17, the minimum distance B between the two most separated wheel articulators 210 on either side of the printing apparatus 100 sets the maximum fenestration opening print capability, with the parameters A and B being adjustable depending on the size of the print and the fenestration requirements.

The printing apparatus 100 is also capable of printing curved walls and walls of other shapes that have curved wall sections. FIG. 18 depicts example outer and inner curved walls WC1 and WC2, along with limiting extruder chamber parameters to illustrate the relationship between the extruder chamber parameters and a radius of wall sections, according to an embodiment. In some embodiments, the extruder chambers 140, 150, 160, and 170 can be rotatably mounted in the printing apparatus 100. Thus, as illustrated in FIG. 18, the extruder chambers 140, 150, 160, and 170 can be rotated about their vertical axes either manually or by a motorized assembly to change their angles of orientation with respect to the vertical axes, thereby enabling printing of the outer and inner curved walls WC1 and WC2, and various other curved walls as well as curved wall sections in partially curved walls.

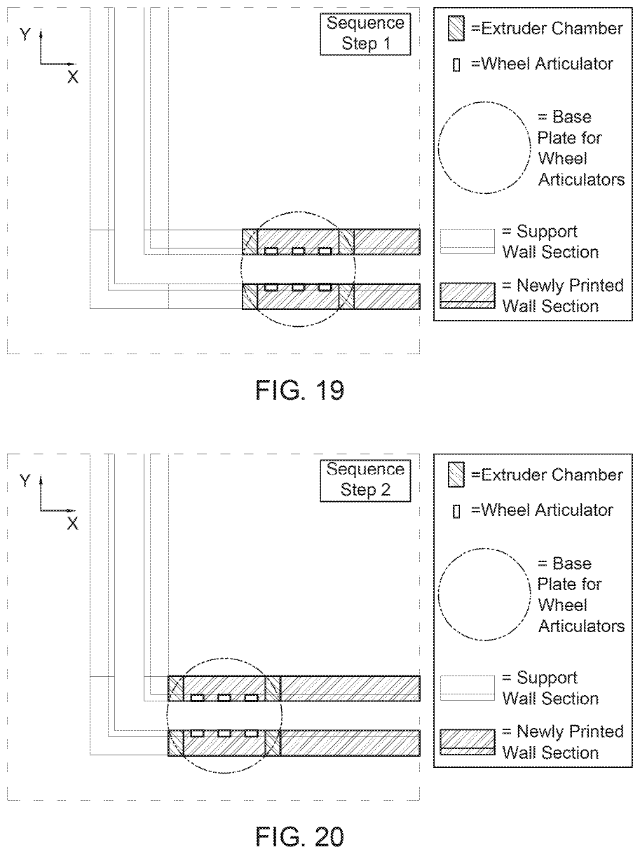

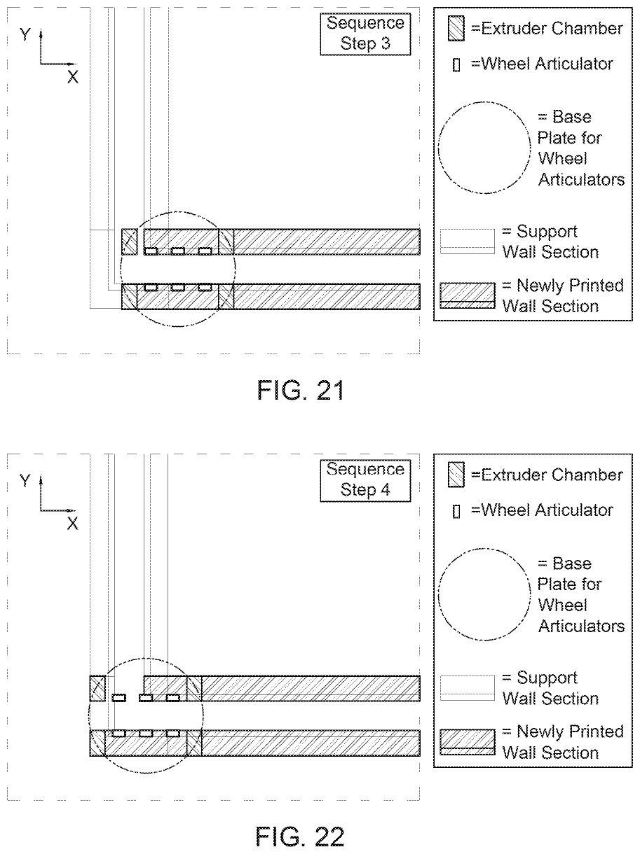

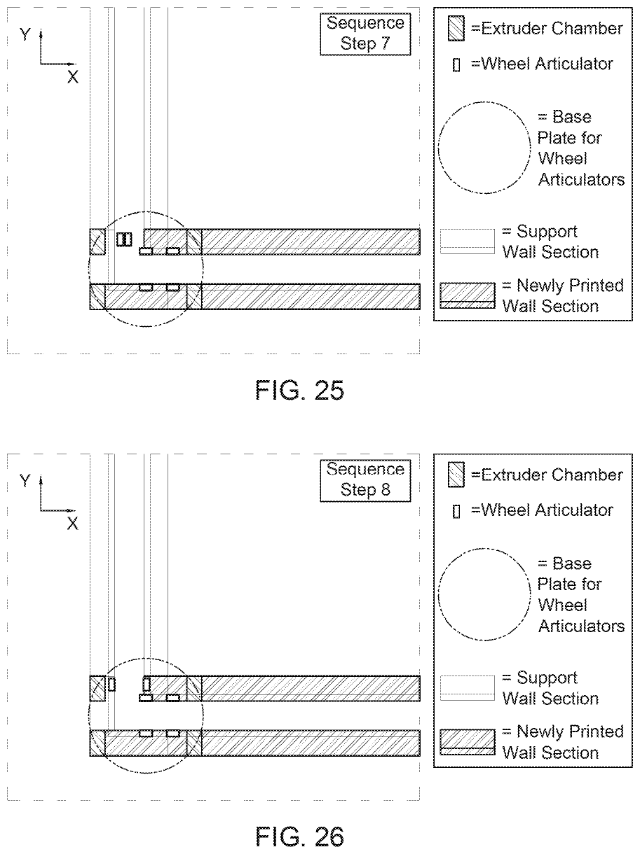

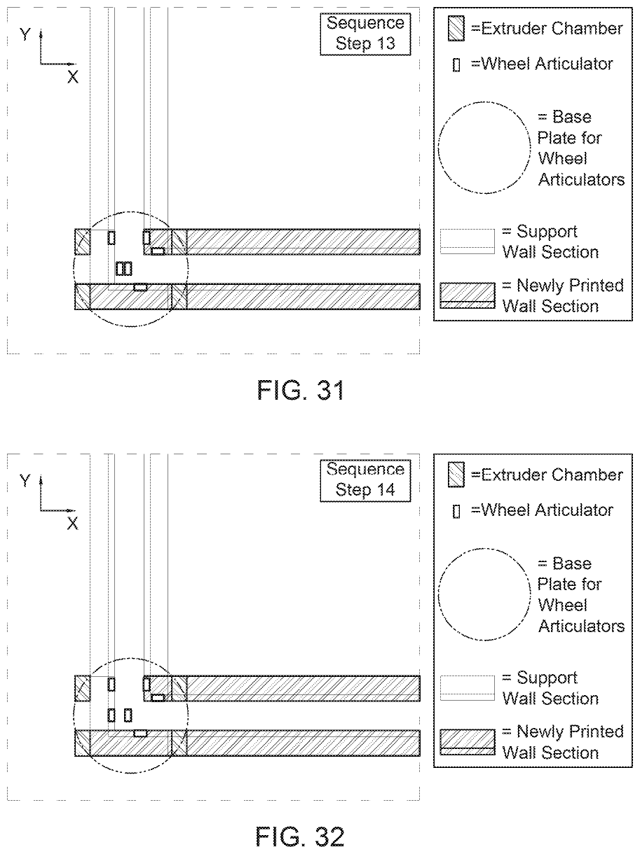

FIGS. 19-47 depict a process of printing corners of first and second walls, according to an embodiment. FIG. 48 depicts the base plate 120 and the wheel articulators 210, and movement vectors for the base plate 120 and the wheel articulators 210, according to an embodiment. The wheel articulators 210 can be moved (e.g., translated, and rotated) as shown in FIG. 48 by a motorized actuator assembly, as previously described herein, and the printing apparatus 100 is thereby able to easily print corner sections of wall layers.

As shown in FIGS. 19-21, a printing apparatus (e.g., the printing apparatus 100) is configured to print sections of a new wall layer of the outer wall from an outer front extruder chamber (e.g., the outer front extruder chamber 140) and to print sections of a new wall layer of the inner wall from an inner front extruder chamber (e.g., the inner front extruder chamber 150), while moving forward in the X direction, until the new wall layer of the inner wall reaches a corner line of the inner wall in the X direction. During this printing phase, the extruder chambers (e.g., the extruder chambers 140, 150, 160, and 170) are maintained in a first orientation and the wheel articulators (e.g. the wheel articulators 210) are configured to maintain the sets of wheels (e.g., the sets of wheels 220) in wall channels (e.g., the wall channels CH) of inner and outer support wall layers (e.g., previously printed layers) of the inner and outer walls.

Next, as illustrated in FIG. 22, the printing apparatus stops printing sections of the inner wall from the inner front extruder chamber and continues printing sections of the new wall layer of the outer wall from the outer front extruder chamber until the new wall layer of the outer wall reaches a corner point of the outer wall. When the new wall layer of the outer wall reaches a corner line of the outer support wall in the X direction, the sets of wheels attached to the outer front wheel articulator and the inner front wheel articulator are positioned past the corner line of the inner support wall in the X direction, and the sets of wheels attached to the inner front wheel articulator are therefore not inserted in the wall channel CH of the inner support wall.

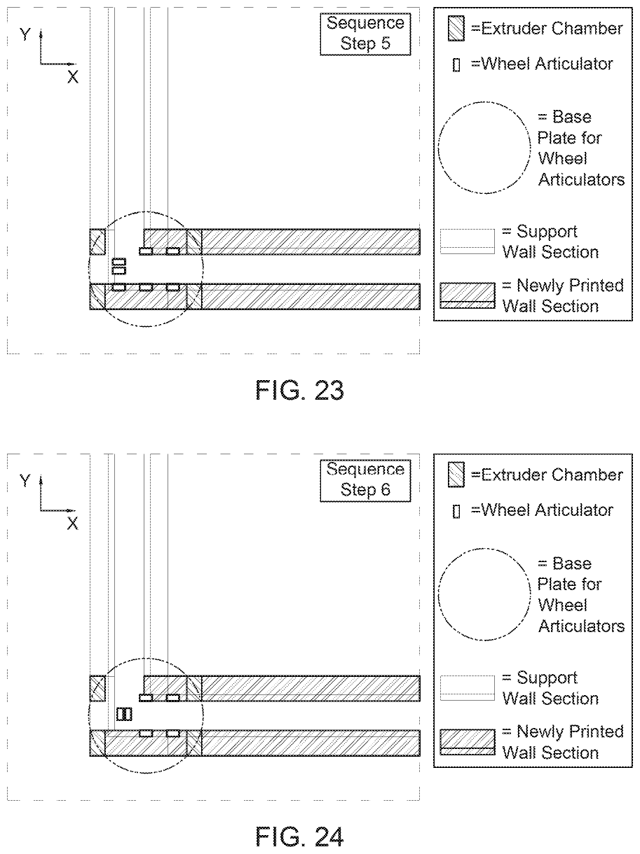

Next, as shown in FIGS. 23-26, the outer front wheel articulator and the inner front wheel articulator are: 1) moved laterally inward so that the sets of wheels attached to the outer front wheel articulator are removed from the wall channel of the outer support wall; 2) rotated approximately 90 degrees clockwise; 3) moved forward in the Y direction until the wheels attached to the outer front wheel articulator and the wheels attached to the inner front wheel articulator are positioned at a location past the corner line of the inner support wall in the Y direction; and 4) moved laterally outward so that the sets of wheels attached to the outer front wheel articulator are inserted in the wall channel of the outer support wall at the location past the corner line of the inner support wall in the Y direction, and the sets of wheels attached to the inner front wheel articulator are inserted in the wall channel of the inner support wall at the location past the corner line of the inner support wall in the Y direction.

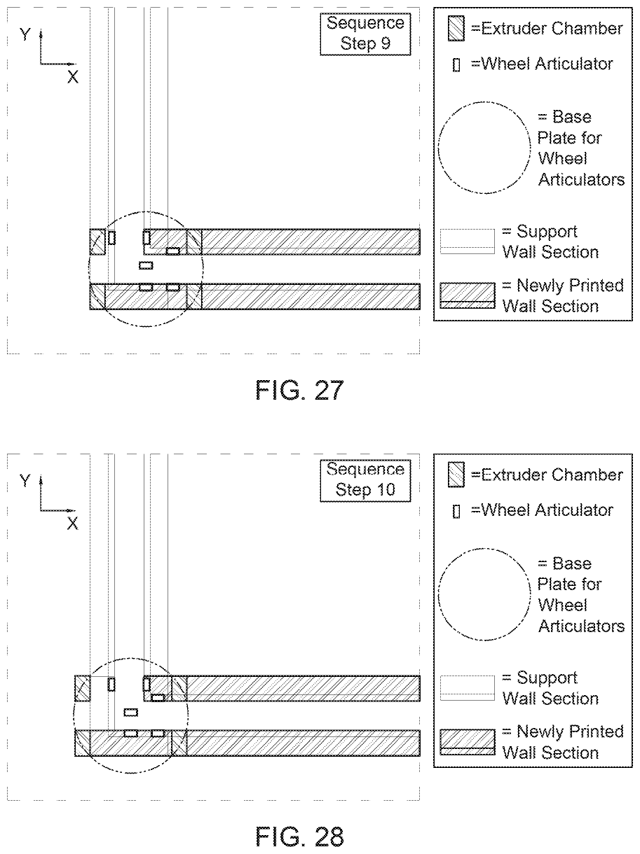

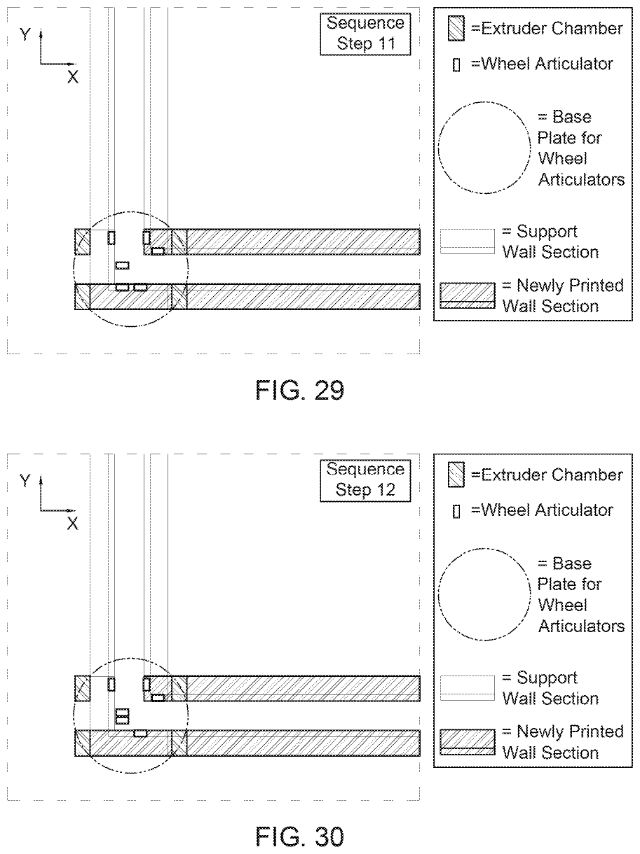

Next, as shown in FIG. 27, the inner middle wheel articulator, which is positioned at a location approximately at the corner line of the inner support wall in the X direction, is moved laterally inward such that the sets of wheels attached to the inner middle wheel articulator are removed from the wall channel of the inner support wall. Then, as shown in FIG. 28, the outer middle wheel articulator, the inner middle wheel articulator, the outer rear wheel articulator, and the inner rear wheel articulator are moved forward in the X direction. Then, as shown in FIG. 29, the outer middle wheel articulator, the inner middle wheel articulator, and the outer rear wheel articulator are moved forward in the X direction while the inner rear wheel articulator is kept stationary. In the configuration of FIG. 29, the outer middle wheel articulator, the inner middle wheel articulator, and the outer rear wheel articulator are located at positions past the corner line of the inner support wall in the X direction, and the inner rear wheel articulator is positioned approximately at the corner line of the inner support wall in the X direction.

Then, as shown in FIGS. 30-32, the outer middle wheel articulator is moved laterally inward such that the sets of wheels attached thereto are removed from the wall channel of the outer support wall, the outer middle wheel articulator and the inner middle wheel articulator are rotated approximately 90 degrees clockwise, and the outer middle wheel articulator is moved laterally outward such that the sets of wheels attached thereto are inserted in the wall channel of the outer support wall at a location past a corner line of the outer support wall in the Y direction.

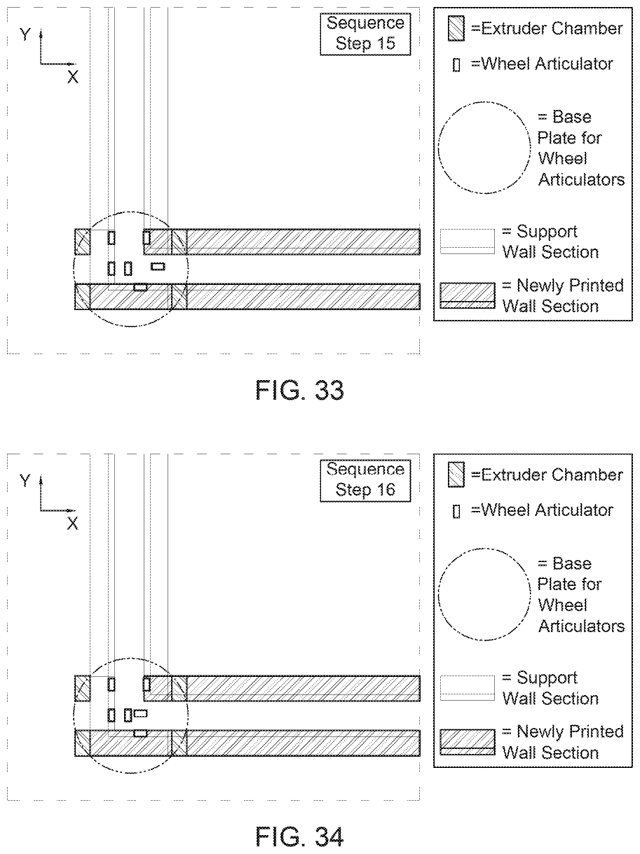

Then, as shown in FIGS. 33-34, the inner rear wheel articulator is moved laterally inward such that the sets of wheels attached thereto are removed from the wall channel of the inner support wall, and the inner rear wheel articulator is then moved forward to the location past the corner line of the inner support wall in the X direction where the outer rear wheel articulator is located.

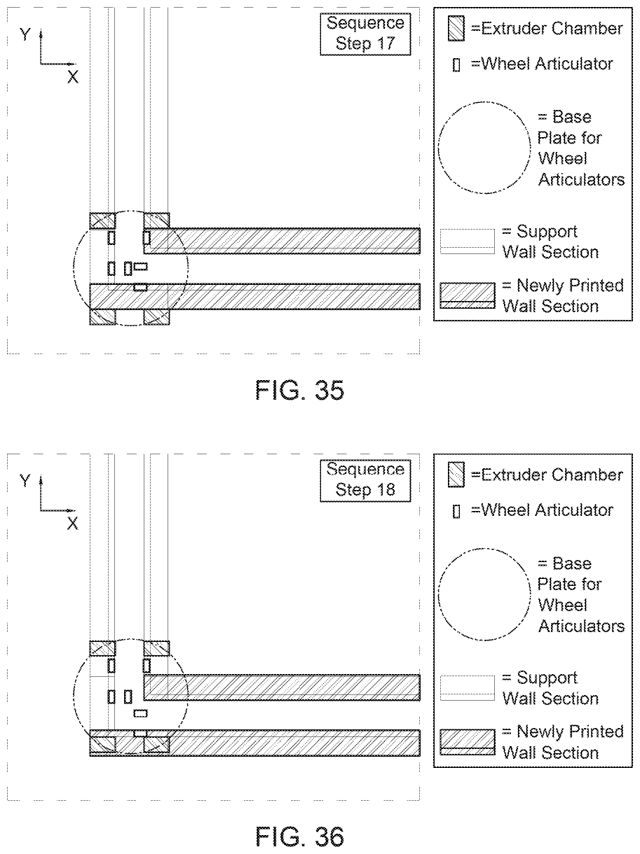

Next, as shown in FIG. 35, the entire extruder/all of the extruder chambers are rotated together approximately 90 degrees clockwise about a vertical axis of the printing apparatus.

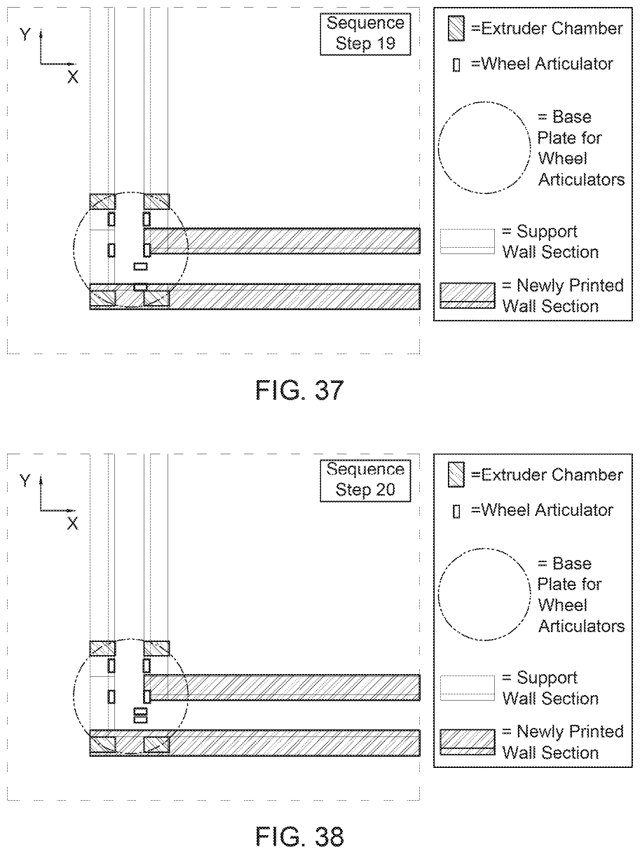

Thereafter, as shown in FIGS. 36 and 37, the outer middle wheel articulator and the inner middle wheel articulator are moved forward to a location approximately at the corner line of the inner support wall in the Y direction, and the inner middle wheel articulator is moved laterally outward such that the sets of wheels attached thereto are inserted into the wall channel of the inner support wall at the location approximately equal to the corner line of the inner support wall in the Y direction.

Next, as shown in FIGS. 38 to 40, the outer rear wheel articulator is moved laterally inward such that the sets of wheels attached thereto are removed from the wall channel of the outer support wall, then the outer rear wheel articulator and the inner rear wheel articulator are moved further forward in the X direction, and then the outer rear wheel articulator and the inner rear wheel articulator are rotated together approximately 90 degrees clockwise.

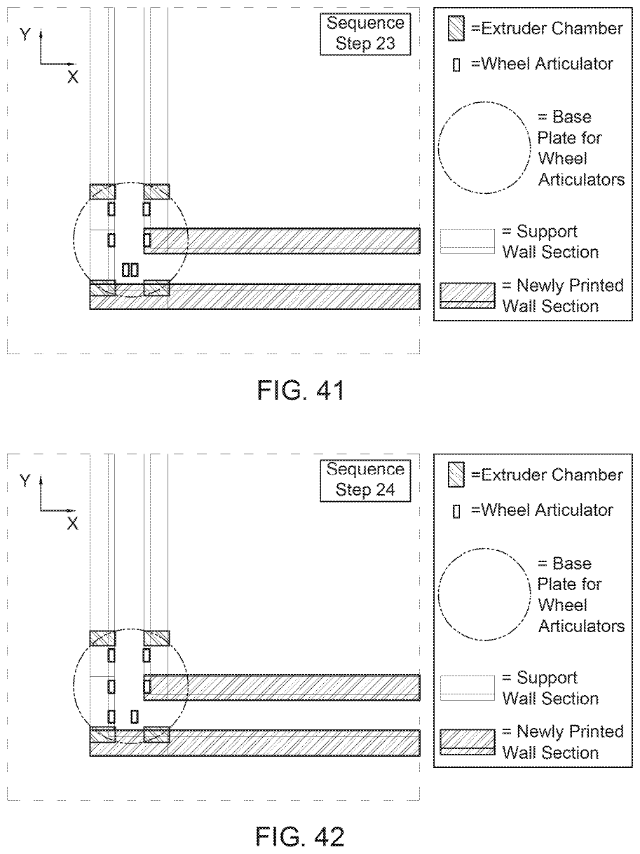

Then, as illustrated in FIG. 41, the outer front wheel articulator, the inner front wheel articulator, the outer middle wheel articulator, and the inner middle wheel articulator are moved forward in the Y direction. Thereafter, the outer rear wheel articulator is moved laterally outward such that the sets of wheels attached thereto are inserted in the wall channel of the outer support wall.

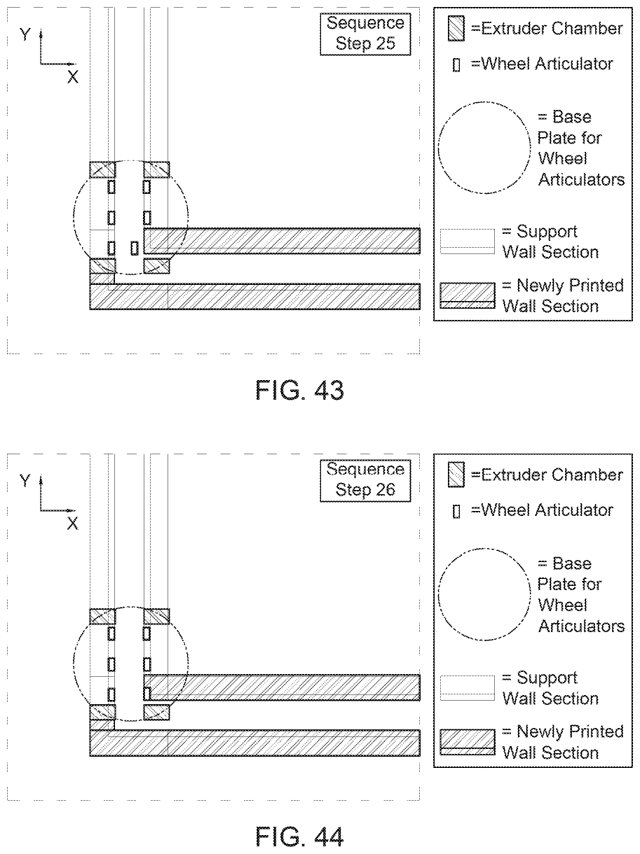

Next, as shown in FIG. 43, the printing apparatus moves forward in the Y direction while printing a section of the new wall layer of the outer wall from the outer rear extruder chamber, such that all of the wheel articulators are moved forward in the Y direction until the outer rear wheel articulator and the inner rear wheel articulator are positioned at a location approximately at the corner line of the inner support wall in the Y direction. Then, as shown in FIG. 44, the inner rear wheel articulator is moved laterally outward so that the sets of wheels attached thereto are inserted in the wall channel of the inner support wall at the location approximately at the corner line of the inner support wall in the Y direction.

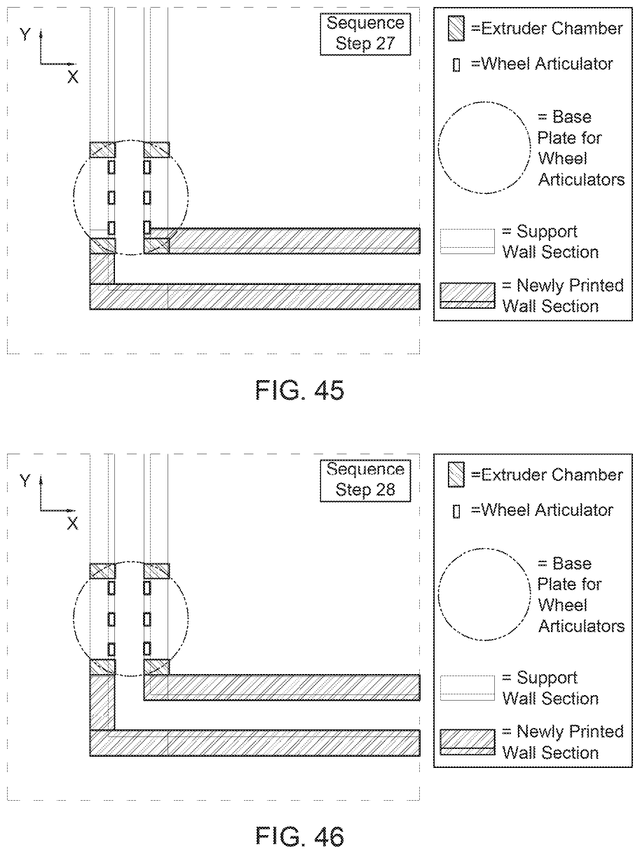

Next, as shown in FIG. 45, the printing apparatus continues moving forward in the Y direction while printing the new wall layer of the outer wall from the outer rear extruder chamber. At this point, the outer rear extruder chamber and the inner rear extruder chamber have reached a location approximately at the corner line of the inner support wall.

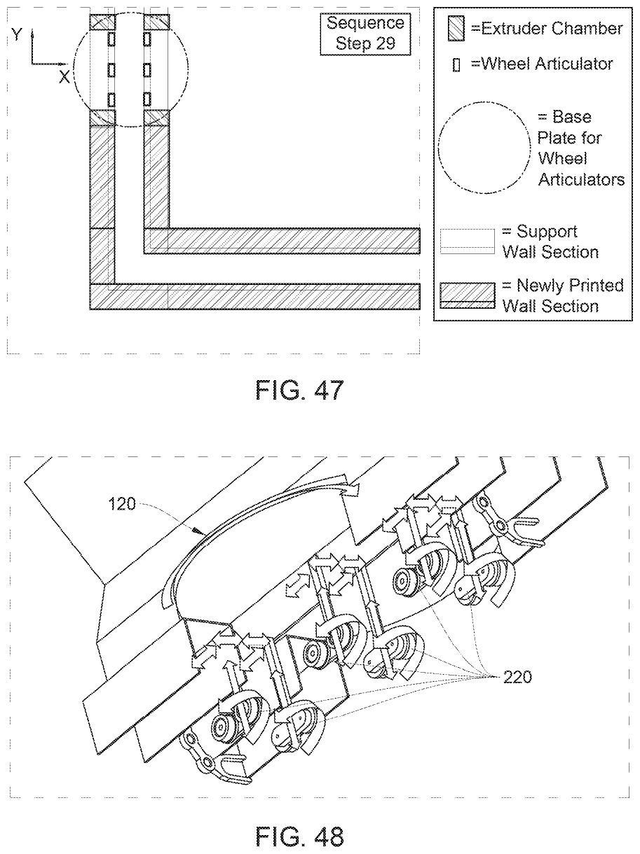

Next, as illustrated in FIG. 46, the printing apparatus continues moving forward in the Y direction while printing the new wall layer of the outer wall from the outer rear extruder chamber, until the outer rear extruder chamber and the inner rear extruder chamber are positioned at a location past the corner line of the inner support wall in the Y direction. Thereafter, as shown in FIG. 47, the printing apparatus continues moving forward in the Y direction while printing the new wall layer of the outer wall from the outer rear extruder chamber and printing the new wall layer of the inner wall from the inner rear extruder chamber.

FIGS. 19-47 and the associated description herein provide only one example of how a printing apparatus according to the disclosure can print wall corners. Accordingly, the example of FIGS. 19-47 is not limiting, but is provided only to illustrate how the printing apparatus can be operated to print various wall corners and shapes.

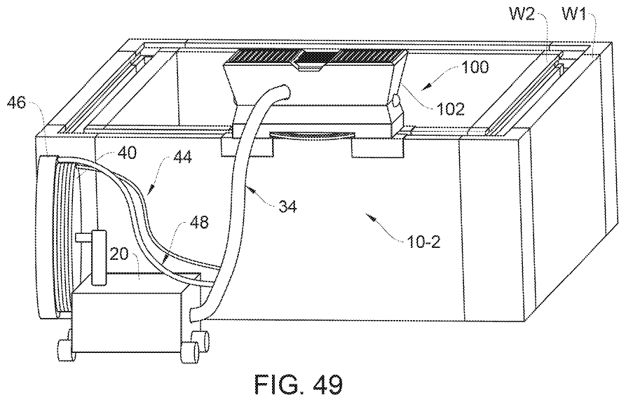

In some embodiments, a printing system can be configured to form flexible vertical tension rods in a printed structure to reinforce the printed structure. Example embodiments in which a printing system is configured to form flexible vertical tension rods into a structure are illustrated in FIGS. 49-51, which are described below.

FIG. 49 depicts an example profile view of a 3D printing system (“printing system”) 10-2 configured to form flexible vertical tension rods in a structure being printed. The printing system 10-2 can include the printing apparatus 100, the material supply 20, a main feed line 34, the spool 40 holding one or more routed accessory components AC, the routed components feed line 44 configured to feed the routed accessory components AC from the spool 40 to the main feed line 34, a spool 46 holding a flexible rod material, and a tension rod feed line 48 configured to feed the flexible rod material from the spool 46 to the main feed line 34. The main feed line 34 can include internal sub-feed lines configured to feed the print material from the material supply to the printing apparatus 100, feed the one or more routed accessory components AC from the routed components feed line 44 to the 3D printing apparatus 100, and feed the flexible rod material from tension rod feed line 48 to the printing apparatus 100. The flexible rod material can be, for example a variety of fiber-reinforced polymers, such as glass fiber reinforced polymer, carbon fiber reinforced polymer, basalt fiber reinforced polymer, as well as alternative versions of these materials with polymer substitutes and other materials such as wire meshes and bamboo.

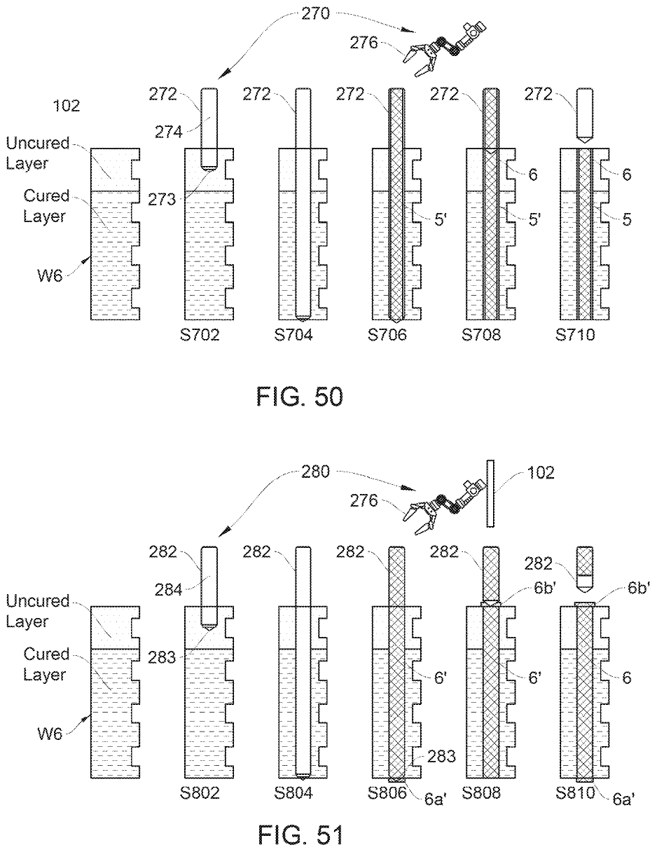

The printing apparatus 100 can process the flexible rod material to insert flexible vertical tension rod members in a wall of a structure to reinforce the structure, as described below with respect to FIGS. 50 and 51.

FIG. 50 depicts an example process flow for a method of inserting a flexible vertical tension rod 5 into a wall W6 of a printed structure, according to an embodiment. As shown in FIG. 50, the printing apparatus 100 can include a tension rod installation mechanism 270 for inserting the flexible vertical tension rod 5 into the wall W6. The tension rod installation mechanism 270 can include, for example, a drill mechanism 272, an armature mechanism 276, and a substrate filling mechanism 278 that are mounted to the housing 102 of the printing apparatus 100. The drill mechanism 272 can include an elongate member having a drill tip 273 configured to drill a hole, and a hollow interior 274 that is configured to receive a segment of tension rod material 5′ therein.

As shown in FIG. 50, in step S702, the drill mechanism 272 can start drilling a vertically extending hole that extends through an uncured top layer and cured/partially cured lower layers of the wall W6. In step S704, the drill mechanism can complete drilling the vertically extending hole. Next, in step S706, the armature mechanism 276 can feed the segment of tension rod material 5′ into the hollow interior 273. Then, in step S708, the drill mechanism 272 can be removed from the wall W6, and the substrate filling mechanism 278 can fill substrate filler material 6 in an interstitial volume between the segment of tension rod material 5′ and the wall W6. In some embodiments, the substrate filling mechanism 278 can include a nozzle in communication with a reservoir containing the substrate filler material 6. In some embodiments, the substrate filler material 6 can be the same material as the print material. However, the substrate filler material 6 can be another material, such as hemp plant materials, soil and earth-based materials, steel and iron dust deposit waste materials, mycelium mushroom materials, epoxy resin materials, wax materials, and clay materials including natural clays, oil-based clays, epoxy clays, and polymer clays.

Finally, in step S710, a portion of the segment of tension rod material 5′ extending above the hole in the wall W6 can be cut, thereby forming the flexible vertical tension rod 5 in the wall W6.

In some embodiments, multiple flexible vertical tension rods 5 can be formed in the wall W6 by the method described above.

FIG. 51 depicts an example process flow for a method of inserting a flexible vertical tension rod 6 that does not require insertion of a substrate into a drilled interstitial volume, according to an embodiment. As shown in FIG. 51, the printing apparatus can include a tension rod installation mechanism 280 for inserting the flexible vertical tension rod 6 into the wall W6. The tension rod installation mechanism 280 can include, for example, a drill mechanism 282 and the armature mechanism 276 that are mounted to the housing 102 of the printing apparatus 100. The drill mechanism 282 can include an elongate threaded insertion member driven by a gear assembly and having a hollow drill tip 283 configured to drill a hole, and a hollow interior 284 and configured to receive a segment of tension rod material 6′ therein.

As shown in FIG. 51, in step S802, the drill mechanism 282 can start drilling a vertically extending hole that extends through an uncured top layer and cured/partially cured lower layers of the wall W6. In step S804, the drill mechanism can complete drilling the vertically extending hole. At the conclusion of step S804, the hollow drill tip 283 can extend slightly past a bottom edge of the wall W6. Next, in step S806, the armature mechanism 276 can feed the segment of tension rod material 7′ into the hollow interior 284 until a bottom end of the segment of tension rod material 7′ protrudes from the hollow drill tip 283 and expands to form a lower flange portion 7a′ having a diameter larger than a diameter of the drilled hole. Then, in step S808, the drill mechanism 282 can be removed from the wall W6, causing an upper end of the segment of tension rod material 6′ to expand and form an upper flange portion 7b′ having a diameter larger than the diameter of the drilled hole. Finally, in step S810, a portion of the segment of tension rod material 7′ extending above the upper flange portion 7b′ can be cut, thereby forming the flexible vertical tension rod 7 in the wall W6. The lower flange portion 7a′ and the upper flange portion 7b′ prevent flexible vertical tension rod 7 from being removed from the wall W6.

In some embodiments, multiple flexible vertical tension rods 6 can be formed in the wall W6 by the method described above.

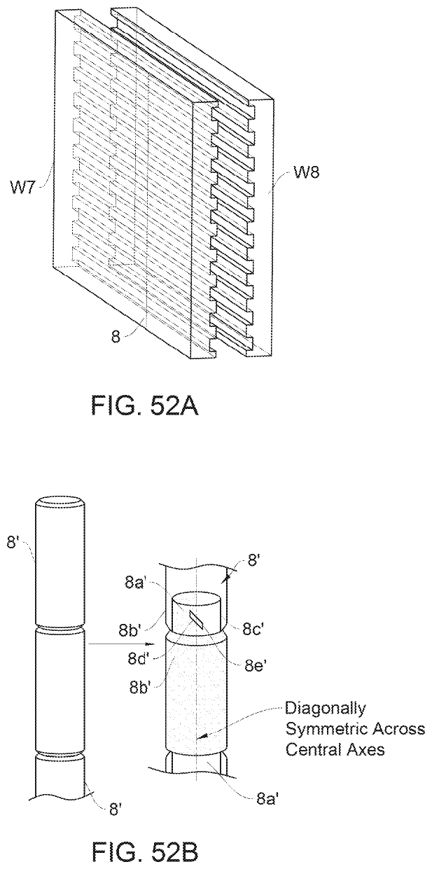

FIGS. 52A and 52B depict a rigid vertical tension rod 8 formed of rigid vertical tension rod segment 8′, each of which is interlocked with another rigid vertical tension rod segment 8′ connected by interlocking elements, according to an embodiment. Referring to FIG. 52A, the printing apparatus can form the rigid vertical tension rod 8 extending through multiple layers of an outer wall W7 in a structure including the outer wall W7 and an inner wall W8. For example, the rigid vertical extension rod segments 8′/rigid vertical tension rod 8 can be formed of steel or metal. However, other suitable materials can be used for the rigid vertical tension rod 8 segments 8′/rigid vertical tension rod 8.

As shown in FIG. 52B, the rigid vertical tension rod 8 can be formed by inserting each rigid vertical tension rod segment 8′ in an uncured layer of the outer wall W7 and, if another rigid vertical tension rod segment 8′ has been inserted below the rigid vertical tension rod segment 8′ in a most recently completed layer of the outer wall W7, interlocking the rigid vertical tension rod segment 8′ in the uncured layer with the other rigid vertical tension rod segment 8′ below.

As shown in FIG. 52B, each rigid vertical tension rod segment 8′ can include an upper portion 8a′, and a lower portion 8b′ having a hollowed-out lower end 8c′. The hollowed-out lower end 8c′ can have an internal diameter that is slightly greater than a diameter of the upper portion 8a′. A first locking element 8d′ can be disposed on an external surface of the upper portion 8a′ and a second locking element 8e′ can be disposed on an internal surface of the hollowed-out lower end 8c′. For example, the first locking element 8d′ can be a protrusion, and the second locking element 8e′ can be a slot shaped to receive the first locking element 8d′ of another rigid vertical tension rod segment 8′ and lock with the first locking element 8d′ of the other rigid vertical tension rod segment 8′. However, the first locking element 8d′ and the second locking element 8e′ are not limited to the described structures.

The hollowed-out lower end 8c′ of one vertical tension rod segment 8′ can receive the upper portion 8a′ of another vertical tension rod segment 8′ disposed below the one vertical tension rod segment 8′, such that the first locking element 8d′ of the other vertical tension rod segment 8′ is received in the second locking element 8e′ of the one vertical tension rod segment 8′. The one rigid vertical tension rod segment 8′ and the other rigid vertical tension rod segment 8′ can be interlocked by twisting the one rigid vertical tension rod segment 8′ with respect to the other vertical tension rod segment 8′, or vice-versa, such that the second locking element 8e′ of the one rigid vertical tension rod segment 8′ and the first locking element 8d′ of the other rigid vertical tension rod segment 8′ lock with each other.

The printing apparatus 100 can further include one or more tension rod segment sensors (e.g., vibroacoustic, magnetic, ultrasonic, or infrared sensors) configured to sense the presence of a rigid vertical tension rod segment 8′, in combination with location tracking mapping, to determine the location of a rigid vertical tension rod segment 8′ in a previously printed layer beneath the layer of the wall W7 that is currently being printed. Based on the determined location of the rigid vertical tension rod segment 8′ in the previously printed layer, the printing apparatus 100 can determine a location at which to insert a rigid vertical tension rod segment 8′ in the layer of the wall W7 that is currently being printed.

Although the embodiment of FIGS. 52A and 52B describe a rigid vertical tension rod 8 inserted in the outer wall W7, it is to be understood that the rigid vertical tension rod 8 can also be installed in the inner wall W8.

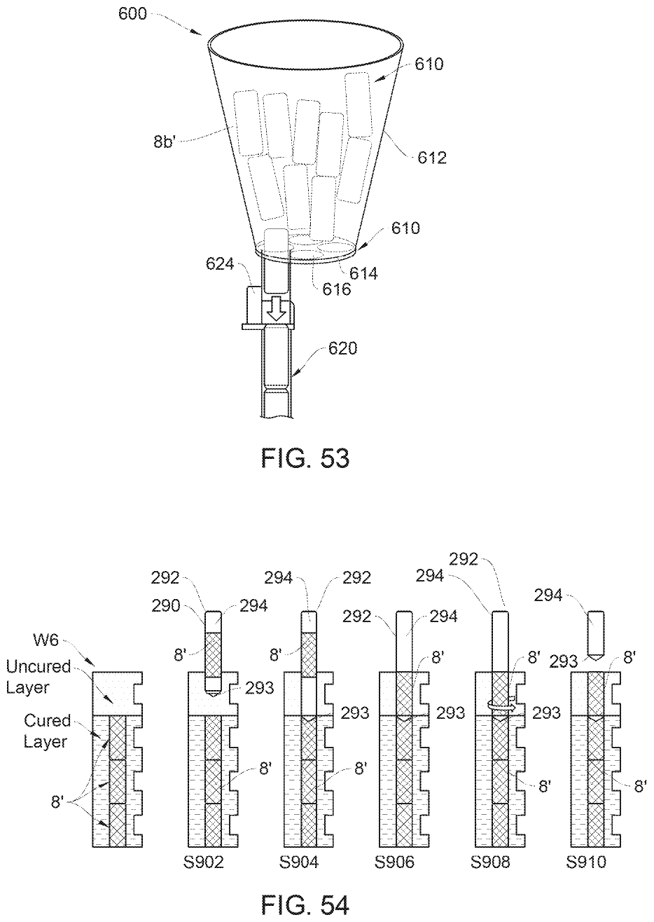

FIG. 53 depicts a tension rod segment feeding mechanism 600, according to an embodiment. As shown in FIG. 53, the tension rod segment feeding mechanism 600 can include a funnel-shaped reservoir 610 configured to hold a plurality of rigid vertical tension rod segments 8′ therein, and a tension rod feed tube 620 configured to receive the rigid vertical tension rod segments 8′ from the funnel-shaped reservoir 610. The funnel-shaped reservoir 610 can be disposed above the tension rod feed tube 620, and can be configured to deliver the tension rod segments 8′ to the tension rod feed tube 620 by a gravity-feed.

The funnel-shaped reservoir 610 can include a sorting and funneling mechanism 612 including a rotatable plate 614 having openings 616 therein. The openings 616 can be configured such that each opening 616 receives a rigid vertical tension rod segment 8′ and feeds the received rigid vertical tension rod segment 8′ into the feed tension rod feed tube 620 when the rotatable plate 614 rotates to position the opening 616 into alignment with the feed tube 620. The tension rod segment feeding mechanism 600 can also include a twisting mechanism (e.g., an armature mechanism) 624, mounted on the tension rod feed tube 620 and configured to twist adjacent rigid vertical tension rod segments 8′ into locking engagement with each other inside the tension rod feed tube 620 to form the rigid vertical tension rod segment 8. The tension rod feed tube 620 can be inserted into one or more uncured layers of a wall to insert the rigid vertical tension rod segments 8′ into the wall to form the rigid vertical tension rod segment 8 therein.

FIG. 54 depicts a cross-section view of a method for inserting a rigid vertical tension rod segment 8′ into an uncured layer of a wall W9 and interlocking the inserted rigid vertical tension rod segment 8′ with another rigid vertical tension rod segment 8′ below, according to an embodiment. As shown in FIG. 54, the printing apparatus 100 can include a tension rod installation mechanism 290 for inserting the rigid vertical tension rod segments 8′ into a wall W9. The tension rod installation mechanism 290 can include, for example, a drill mechanism 292 including an elongate member having a hollow drill tip 293 configured to drill a hole, and a hollow interior 294 that is configured to receive a rigid vertical tension rod segment 8′ therein.

As shown in FIG. 54, in step S902, the drill mechanism 292, which includes a rigid vertical tension rod segment 8′ disposed in the hollow interior 294 thereof, can start drilling a vertically extending hole in the uncured layer of the wall W9. In step S904, the drill mechanism can complete drilling the vertically extending hole such that the vertically extending hole extends through substantially the entire uncured layer of the wall W9. Next, in step S906, the rigid vertical tension rod segment 8′ can be moved toward the hollow drill tip 293 and into engagement with the rigid vertical tension rod segment 8′ formed below in a cured layer of the wall W9. Then, in Step S908, the drill mechanism 282 can twist the rigid vertical tension rod segment 8′ in the uncured layer of the wall W9 to interlock the rigid vertical tension rod segment 8′ in the uncured layer of the wall W9 with the rigid vertical tension rod segment 8′ formed below. Finally, in step S910, the drill mechanism 292 can be removed from the rigid vertical tension rod segment 8′ in the uncured layer of the wall W9.

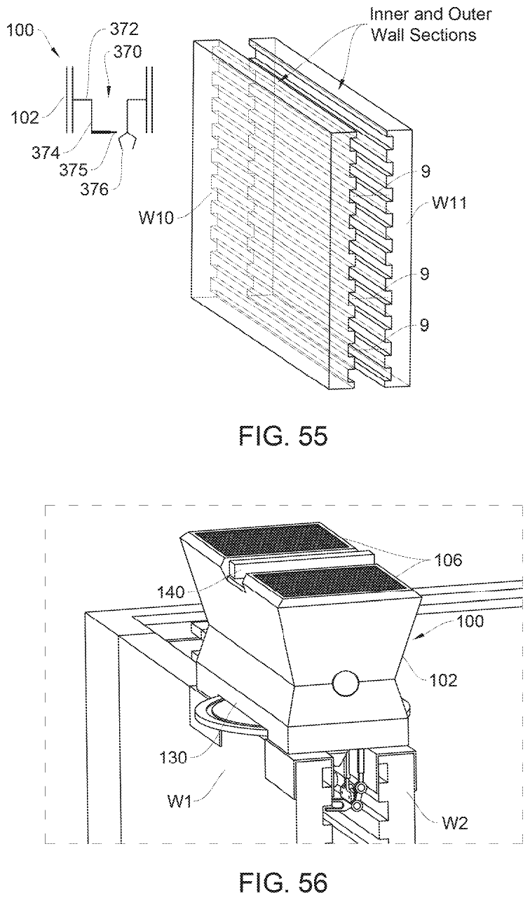

FIG. 55 depicts a method for inserting rigid horizontal tension rods 9 into an outer wall W10 and an inner wall W11 of a structure, according to an embodiment. The rigid horizontal tension rods can be made of steel, metal, or another rigid material.

As shown in FIG. 55, the printing apparatus 100 can include a tension rod installation mechanism 370 mounted to the housing for inserting the rigid horizontal tension rods into a wall W9. The tension rod installation mechanism 370 can include, for example, a drill mechanism 372 including an arm linkage 374 that is extendable, retractable, and pivotable, and a drill member 375 attached to the arm linkage 374 and configured to drill holes in the outer wall W10 and the inner wall W11. The tension rod installation mechanism 370 can further include, for example, an armature mechanism 376.

The drill member 375 can drill respective holes in either cured layers of the outer wall W10 and the inner wall W11 or uncured layers of the outer wall W10 and the inner wall W11. After drilling the holes, the armature mechanism 376 can insert one end of the rigid horizontal tension rods 9 into a layer of the outer wall W10 and can insert another end of the rigid horizontal tension rods 9 into a layer of the inner wall W11 to reinforce the outer wall W10 and the inner wall W11. In some embodiments, the armature mechanism 376 can insert one end of a rigid horizontal tension rod 9 in an uncured portion of the print material formed by the outer front extruder chamber 140 or the outer rear extruder chamber 160, and can insert another end of the rigid horizontal tension rod 9 in an uncured portion of the print material formed by the inner front extruder chamber 150 or the inner rear extruder chamber 170, respectively. Armature mechanism 376 can insert one end of a horizontal tension rod member 9 in a partially cured section of a layer of the outer wall W10, and can insert another end of the horizontal tension rod member 9 in a partially cured section of a layer of the inner wall W11, while the extruder 130 is moving along a path to print a next section of the layer of the outer wall W10 and a next section of the layer of the inner wall W11.

FIG. 56 depicts a profile view of a 3D printing apparatus 100-1 including a power supply 104, according to an embodiment. Referring to FIG. 56, the 3D printing apparatus (“printing apparatus”) 100-1 is similar to the printing apparatus 100 of FIG. 1, except that the printing apparatus 100-1 includes the power supply 104 and photovoltaic cells 106 disposed on the housing 102.

The power supply 104 can be mounted to the printing apparatus 100-1 to supply power to the printing apparatus 100-1 for performing the operations disclosed herein. For example, the power supply 104 can be powered by or recharged by connection to either one or both of an AC current supply and the photovoltaic cells 106. Thus, the power supply 104 can be charged to last for the duration of a print and can be recharged for multiple uses and larger prints.

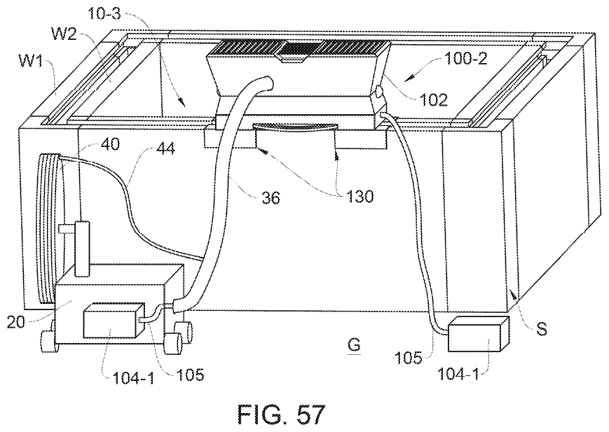

FIG. 57 depicts a profile view of a printing system 10-3 including two alternative locations for a power supply 104-1 for a 3D printing apparatus (“printing apparatus”) 100-2, according to embodiments. The printing system 10-3 is similar to the printing system 10-1 of FIG. 49, except that the printing system 10-3 includes a separate power supply 104-1 supplying power to the printing apparatus 100-2 via a power cable 105.

In FIG. 57 two alternative configurations of the power supply 104-1 and power cable 105 are illustrated. In a first configuration, the power supply 104-1 is mounted on the material supply 20 and the power cable 105 is routed to the printing apparatus 100-2 through a main feed line 36. In a second configuration, the power supply 104-1 is disposed on the ground G and the power cable 105 is routed to the printing apparatus 100-2 separately from the main feed line 36.

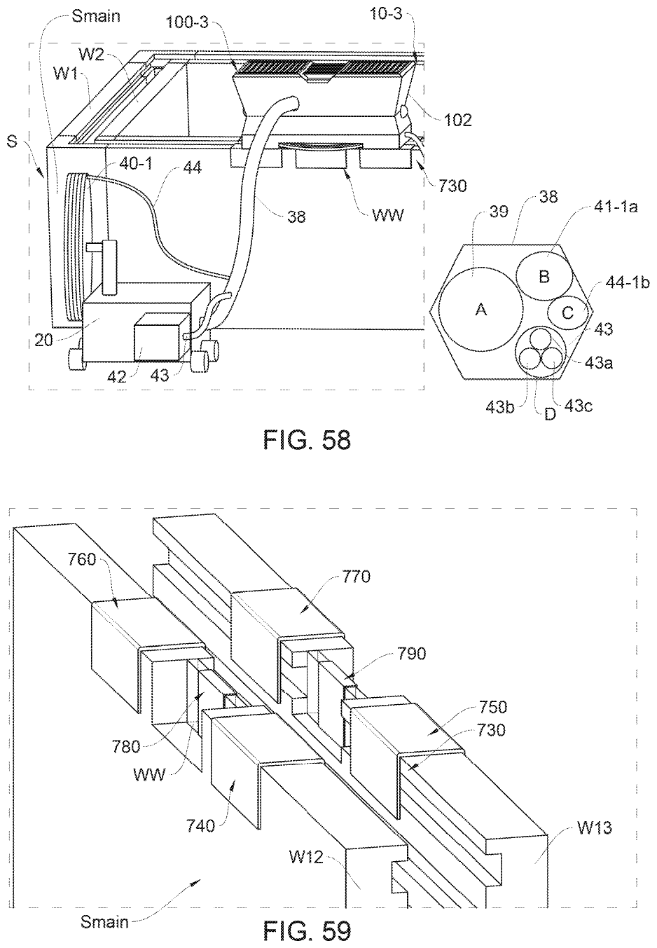

FIG. 58 depicts a printing system 10-4 including a 3D printing apparatus (“printing apparatus”) 100-3 configured to print windows WW in addition to a main structural body Smain of a structure S-1, a window material mixing chamber 42, and a window material feed line 49, according to an embodiment. FIG. 59 depicts a partial view of a printing assembly of the printing apparatus 100-3, illustrating filament extruder chambers 740, 750, 760, 770 and dedicated window extruder chambers 780, 790, according to an embodiment.

In the example shown in FIG. 58, the printing apparatus 100-3 has printed a structure S-1 including the main structural body Smain composed of an outer wall W12 and an inner wall W13. The printing apparatus 100-3 has also printed a window WW in each of the inner and outer walls W12, W13. The printing system 10-4 can include the print material supply 20 for supplying the print material (e.g., structural filament) to the printing apparatus 100-3 via a print material sub-feed line 39, a spool 40-1 holding the routed accessory components AC and configured to supply the routed accessory components AC to the printing apparatus 103 via a routed accessory components feed line 44-1, and a window material supply 42 for supplying the window material to the printing apparatus 103 via the window material feed line 43. For example, in some embodiments, the window material can include multiple window material components, such as cellulose pellets, PVA, and resin. However, the window material can include other components.

As shown in FIG. 58, in some embodiments, the window material feed line of the routed accessory components feed line 44-1 can include a first routed accessory component sub-feed line 44-1a including flexible plumbing, and a second routed accessory component feed line 44-1b including electrical harnessing. The printing system 10-4 can further include a main feed line 38 encasing the print material sub-feed line 39, the first and second routed component sub-feed lines 44-1a and 44-1b, and the window material feed line 43.

In the embodiment illustrated in FIG. 58, the window material supply 42 includes a mixer configured to mix the window material components to form the window material. Thus, the mixed window material can be supplied to the printing apparatus 100-3 via the window material feed line. However, in other embodiments, as shown in FIG. 58, a window material mixer can be disposed on the printing apparatus 100-3 and can receive unmixed window material components from the window material supply through a first window material sub-feed line 43a, a second window material sub-feed line 43b, and a third window material sub-feed line 43c. For example, the first window material sub-feed line 43a can supply cellulose pellets from the window material supply 42 to the mixer on the printing apparatus 100-3, the second window material sub-feed line 43b can supply PVA pellets from the window material supply 42 to the mixer on the printing apparatus 100-3, and the third window material sub-feed line 43c can supply resin pellets from the window material supply 42 to the mixer on the printing apparatus 100-3.

Referring to FIGS. 58 and 59, the printing apparatus 100-3 includes an extruder 730 configured to print the main structural body Smain and the windows WW. More specifically, as shown in FIG. 59, the extruder 730 can include an outer front extruder chamber 740, an inner front extruder chamber 750, an outer rear extruder chamber 760, an inner rear extruder chamber 770, an outer middle extruder chamber 780, and an inner middle extruder chamber 790. The outer front extruder chamber 740 and the outer rear extruder chamber 760 can be configured to receive the print material (e.g., structural filament) from the print material supply 20 and print the outer wall W12 with the print material. The inner front extruder chamber 750 and the inner rear extruder chamber 770 can be configured to receive the print material (e.g., structural filament) from the print material supply 20 and print the inner wall W13 with the print material. The outer middle extruder chamber 780 can be configured to receive the window material from the window material supply 42 and print the window WW in the outer wall W12 using the window material. The inner middle extruder chamber 790 can be configured to receive the window material from the window material supply 42 and print the window WW in the inner wall W13 using the window material.

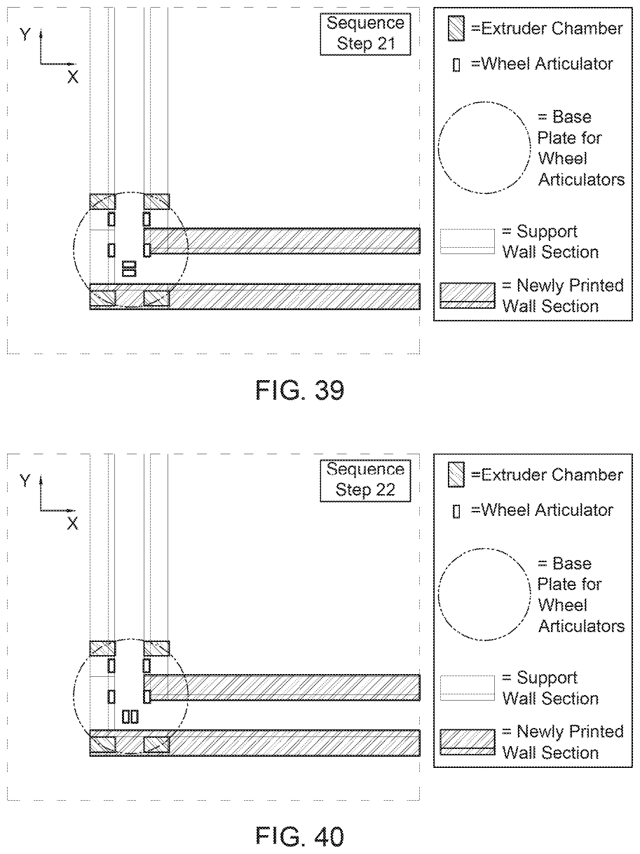

As shown in FIG. 39, the outer middle extruder chamber 780 and the inner middle extruder chamber 790 can have a print thickness that is smaller than the print thickness of the outer front extruder chamber 740, the inner front extruder chamber 750, the outer rear extruder chamber 760, and the inner rear extruder chamber 770. Although the outer middle extruder chamber 780 and the inner middle extruder chamber 790 are shown and described as being configured to print windows, in some implementations the outer middle extruder chamber 780 and the inner middle extruder chamber 790 can be configured to print other fenestrations.

In some embodiments, fenestrations for windows, doors, access ports for conduit, and other openings can be printed by controlling the flow (cessation and initiation) of material to the printing chambers as the printer translates. These fenestrations, once the upper limit is reached and material needs to be deposited above the fenestration, can have lintels or other support structures installed either manually or via the printer through the undercarriage armatures 262 or similar armatures that are positioned in a different spot on the printing apparatus to facilitate installation of lintels.

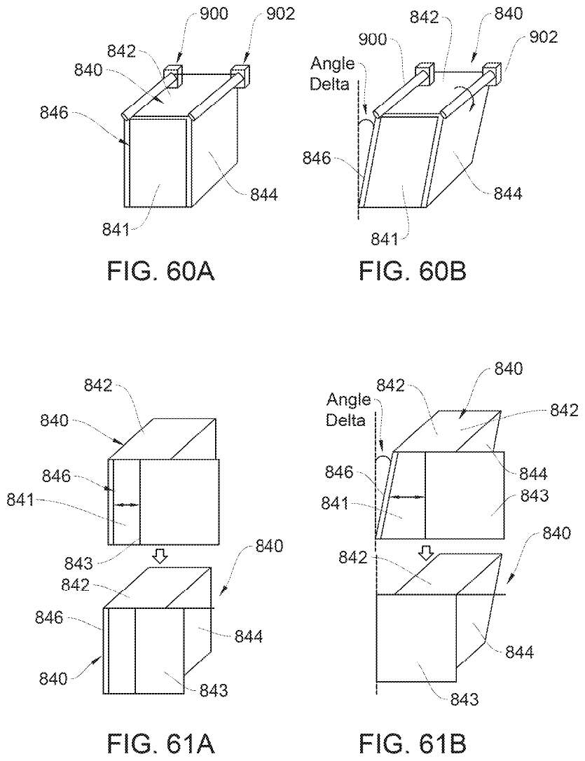

FIGS. 60A and 60B depict an extruder chamber 840 and an angle adjustment mechanism 900 configured to adjust an angle of incline of sidewalls of the extruder chamber 840 with respect to a vertical direction, according to an embodiment. FIG. 61A depicts a profile view of a door of the extruder chamber 840 in open and closed position, when the sidewalls of the extruder chamber are substantially vertical. FIG. 61B depicts a profile view of the door of the extruder chamber 840 in open position and in a closed position, when the sidewalls of the extruder chamber are inclined with respect to the vertical direction.

Referring to FIGS. 60A and 60B, the extruder chamber 840 can include a top wall 842, an inner sidewall 844, an outer side wall 846, and an inner volume 841. The extruder chamber 840 can further include an angle adjustment mechanism including a first pivot arm 900 connected to the top wall 842 and the outer side wall 846, and a second pivot arm 902 connected to the top wall 842 and the inner side wall 844. The first pivot arm 900 can be rotated by a motorized actuator assembly to change the angle of incline (angle delta) of the outer side wall 846 with respect to a perpendicular axis. The second pivot arm 902 can be rotated by a motorized actuator assembly to change the angle of incline (angle delta) delta of the inner side wall 844 with respect to a perpendicular axis. Accordingly, the shape of one or more layers of a printed structure can be varied by changing the angle of incline of the outer side wall 846 and the inner side wall 844.

Referring to FIGS. 61A and 61B, the extruder chamber 840 can include a front door 843 that can be selectively opened and closed to perform various printing operations. The front door 843 can generally correspond to the front door 343 illustrated in FIGS. 7A to 7E. As illustrated in FIGS. 61A and 61B, it can be appreciated that the front door 843 can effectively seal the inner volume 841 regardless of the angle of incline of the outer side wall 846 and the inner side wall 844.

Although not shown, the extruder chamber 840 can also include a rear door and a middle door similar to the rear door 345 and the middle door 347 illustrated in FIGS. 7A to 7E.

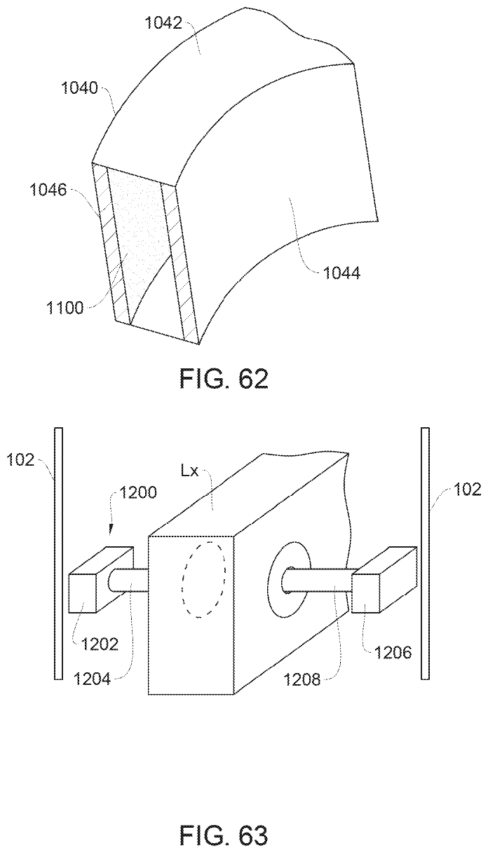

FIG. 62 depicts a profile view of an extruder chamber 1040 having flexible sidewalls 1044, 1046 formed of a shape-memory material, and a chamber shaping device 1100 configured to shape the flexible sidewalls 1044, 1046.

As shown in FIG. 62, the extruder chamber 1040 can have a top wall 1042, a flexible inner sidewall 1044 and a flexible outer sidewall 1046, and an inner volume 1041. The chamber shaping device 1100 can have a sheet-like structure, which can be disposed on an inner surface of the inner sidewall 1044 and an inner surface of the outer sidewall 1046 to conform to the shapes of the flexible inner sidewall 1044 and the flexible outer sidewall 1046.

The chamber shaping device 1100 can include any one or more of a heating device configured to heat the flexible inner sidewall 1044 and the flexible outer sidewall 1046, a cooling device configured to cool the flexible inner sidewall 1044 and the flexible outer sidewall 1046, and an electromagnetic device configured to apply an electromagnetic field to the flexible inner sidewall 1044 and the flexible outer sidewall 1046. When the chamber shaping device is actuated to apply heat, cooling, or the electromagnetic field to the flexible inner sidewall 1044 and the flexible outer sidewall 1046, the shapes of the flexible inner sidewall 1044 and the flexible outer sidewall 1046 change. Thus, the chamber shaping device 1100 can be actuated to control the shapes of the flexible inner sidewall 1044 and the flexible outer sidewall 1046 and thereby determine the shape of a section of a layer of print material printed by the extruder chamber 1040.

FIG. 63 depicts a view of wall bending or shaping device 1200 for bending or shaping a layer Lx of a print structure, according to an embodiment. As shown in FIG. 63, the wall bending or shaping device 1200 can be mounted to the housing 102 of a printing apparatus, and can include a first actuator 1202, a second actuator 1206, a first shaping arm member 1204, and a second shaping arm member 1208. The first and second actuators 1202, 1206 can be configured to selectively move the first and second shaping arm members 1204, 1208, respectively, in any one or more of the X, Y, and Z directions and thereby compress an uncured or partially cured section of the layer Lx between the first and second shaping arm members 1204, 1208 to form the uncured or partially cured section of the layer Lx in a desired shape.

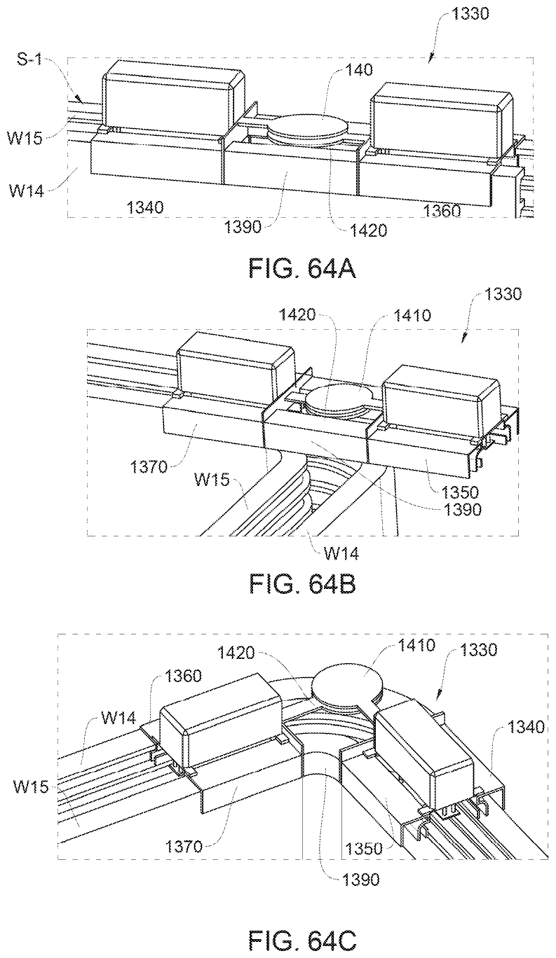

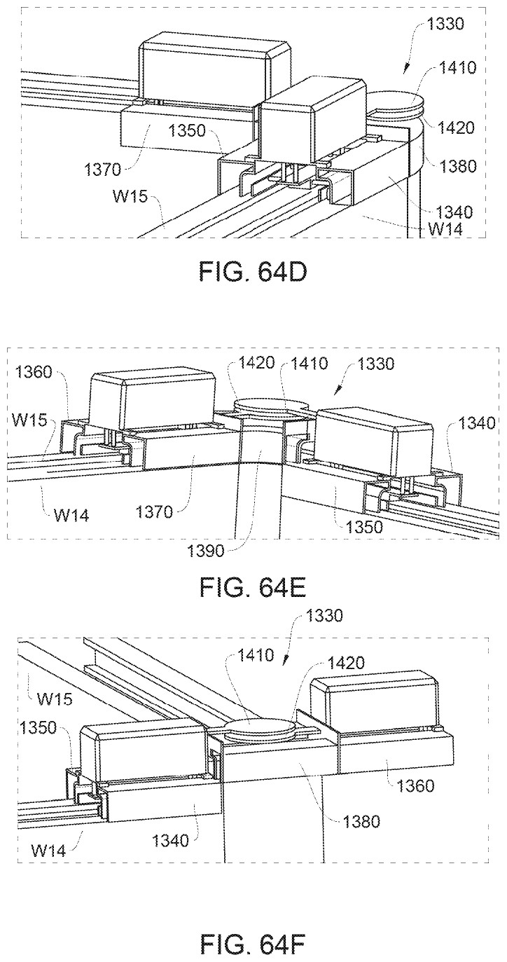

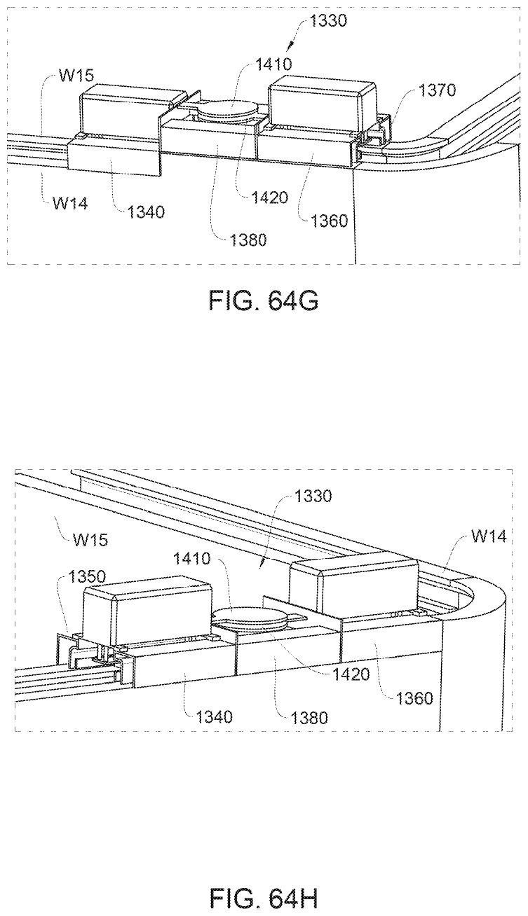

FIGS. 64A to 64H depict a printing assembly of a 3D printing apparatus (“printing apparatus”) printing a corner portion of a structure S-1, according to an embodiment.

Referring to FIGS. 64A to 64H, the printing assembly can include an extruder 1330. The extruder 1330 can include an outer front extruder chamber 1340, an inner front extruder chamber 1350, an outer rear extruder chamber 1360, an inner rear extruder chamber 1370, a flexible outer middle extruder chamber 1380, and a flexible inner middle extruder chamber 1390. The outer front extruder chamber 1340, the outer rear extruder chamber 1360, and the flexible outer middle extruder chamber 1380 are configured to print layers of an outer wall W14 of the structure S-1. The inner front extruder chamber 1340, the inner rear extruder chamber 1360, and the flexible inner middle extruder chamber 1390 are configured to print layers of an inner wall W15 of the structure S-1.

The print assembly can include a first base plate 1410 and a second base plate 1420. The outer front extruder chamber 1340 and the inner front extruder chamber 1350 can be fixed to the first base plate 1410, and the outer rear extruder chamber 1360 and the inner rear extruder chamber 1370 can be fixed to the second base plate 1420. A first end of the flexible outer middle extruder chamber 1380 can be fixed to the outer front extruder chamber 1340, and a second end of the flexible outer middle extruder chamber 1380 can be fixed to the outer rear extruder chamber 1360. A first end of the inner middle extruder chamber 1390 can be fixed to the inner front extruder chamber 1350, and a second end of the inner middle extruder chamber 1390 can be fixed to the inner rear extruder chamber 1370. The outer front extruder chamber 1340 and the outer rear extruder chamber 1360 can be separated from the flexible outer middle extruder chamber 1380 by sliding doors that can be selectively opened and closed to control material flow and maintain chamber integrity. The inner front extruder chamber 1350 and the inner rear extruder chamber 1370 can be separated from the flexible inner middle extruder chamber 1390 by sliding doors that can be selectively opened and closed to control material flow and maintain chamber integrity.

The first base plate 1410 and the second base plate 1420 are rotatably connected to each other, such that the first and second base plates 1410, 1420 can rotate with respect to each other about the vertical axis of the extruder 1330. Rotation of the first base plate 1410 causes the front extruder chamber 1340 and the inner front extruder chamber 1350 to rotate with the first base plate 1410, and rotation of the second base plate 1420 causes the outer rear extruder chamber 1360 and the inner rear extruder chamber 1370 to rotate with the second base plate 1420.

The flexible outer extruder chamber 1380 and the flexible inner middle extruder chamber 1390 are made of a flexible material. For example, flexible outer middle extruder chamber 1380 and the flexible inner middle extruder chamber 1390 can be made of a polymer or a rubber. Rotation of the first base plate 1410 and/or the second base plate 1420 causes the flexible outer middle extruder chamber 1380 and the flexible inner middle extruder chamber 1390 to bend or deform into curved and sharply-bent shapes, thereby enabling the flexible outer middle extruder chamber 1380 and the flexible inner middle extruder chamber 1390 to print the print material in curved or sharply-bent shapes, and particularly to print corner portions of respective walls. In some embodiments, the outer middle extruder chamber 1380 and the flexible inner middle extruder chamber 1390 can have accordion-shaped walls, allowing the outer middle extruder chamber 1380 and the flexible inner middle extruder chamber 1390 to also extend and contract in length.

As shown in FIG. 64A, during straight-wall printing, the outer front extruder chamber 1340, the outer rear extruder chamber 1360, and the flexible outer middle extruder chamber 1380 remain aligned in a substantially straight line to form a continuous extrusion path, and the inner front extruder chamber 1340, the inner rear extruder chamber 1360, and the flexible inner middle extruder chamber 1390 remain aligned in a substantially straight line to form a continuous extrusion path.

As shown in FIG. 64B, to initiate corner printing, the printing apparatus can shift its center of mass toward a rear of the apparatus and advance forward until the front of the outer rear extruder chamber 1360 and the front of the inner rear extruder chamber 1370 reach the ends of the last printed portions of the outer wall W14 and the inner wall W15, respectively. Alternatively, the printing apparatus can hold the outer rear extruder chamber 1360 and the inner rear extruder chamber 1370 fixed in position and allow the outer front extruder chamber 1340 and the inner front extruder chamber 1350 to rotate together about the vertical axis of the extruder 1330, independently with respect to the outer rear extruder chamber 1360 and the inner rear extruder chamber 1370.

Next, as shown in FIG. 64C, at the corners of the inner and outer walls W14 and W15, the outer front extruder chamber 1340 and the inner front extruder chamber 1350 can rotate together about the vertical axis of the extruder 1330 by an angle corresponding to the desired corner geometry, thereby causing the flexible outer middle extruder chamber 1380 and the flexible inner middle extruder chamber 1390 to deform and reposition accordingly. The transitions between the front extruder chambers 1340, 1350 and the flexible middle extruder chambers 1380, 1390, the transitions between the rear extruder chambers 1360, 1370 and the flexible middle extruder chambers 1380, 1390, and the transitions within the flexible middle extruder chambers 1380, 1390 may form a smooth, curved path or a sharply angled path, depending on the corner type and desired structural outcome.

Next, as shown in FIG. 64D, once the extruder 1330 is positioned as described above, the flexible outer middle extruder chamber 1380 and the flexible inner middle extruder chamber 1390 print the corner portion of the outer wall W14 and the corner portion of the inner wall W15, respectively. Additionally, the outer front extruder chamber 1340 and the inner front extruder chamber 1350 initiate printing of the next straight segment of the outer wall W14 and the inner wall W15, respectively.

Thereafter, as shown in FIGS. 64E and 64F, upon completing the corner portions, the flexible outer middle extruder chamber 1380, the flexible inner middle extruder chamber 1390, the outer rear extruder chamber 1360, and the inner rear extruder chamber 1370 can lift above the top surfaces of the outer and inner walls W14, W15, and can rotate about the vertical axis of the extruder 1330 to realign with the outer front extruder chamber 1340 and the inner front extruder chamber 1350 and match the next printing direction.

Next, as shown in FIGS. 64G and 64H, the printing apparatus can then resume forward motion for continued straight-wall printing, scaling the extruder 1330 down to the current layer height of the outer and inner walls W14, W15, once the outer rear extruder chamber 1360 and the inner rear extruder chamber 1370 have cleared the corners of the outer and inner walls W14, W15.

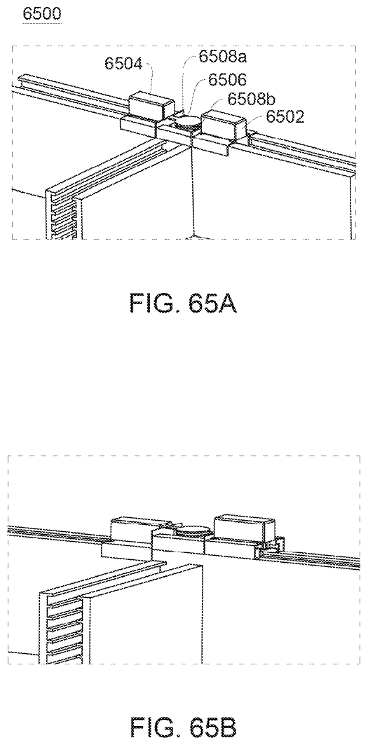

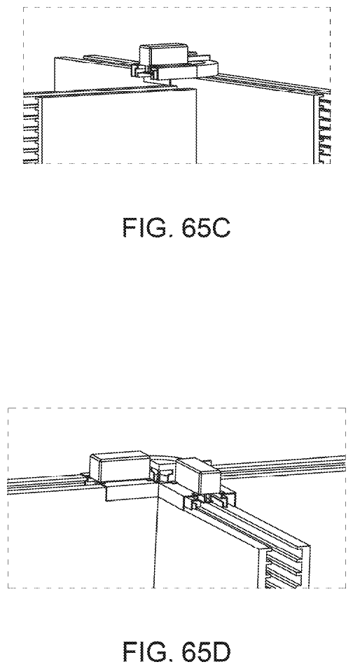

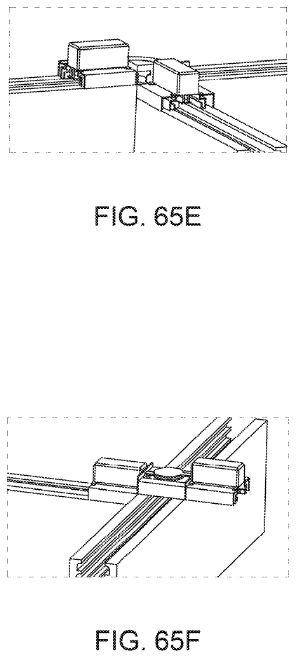

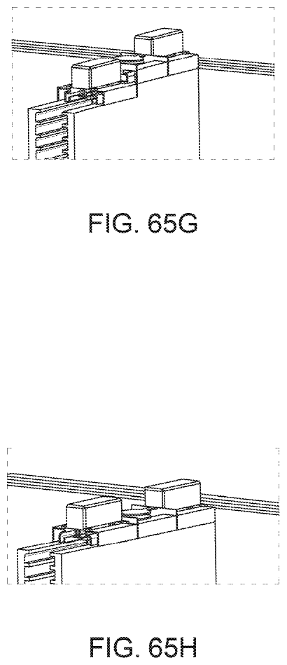

As shown in FIG. 65A, in some embodiments, an apparatus 6500 according to the present teachings can include a front rigid chamber 6502, a rear rigid chamber 6504, and an intermediate section 6506 connecting the two. The intermediate section 6506 may comprise either a flexible segment capable of smooth or angular deformation, or a non-permanent, accordion-style connection permitting controlled extension and directional adjustment between the front and rear chambers. Each chamber is separated from the intermediate section by a sliding door 6508a/6508b, which is configured to control print material flow during operation. To initiate internal wall printing, the apparatus first completes the perimeter of the external wall, facilitated by deposition of material in the inner and outer chambers via routine printing operations, then navigates to the designated starting point of the internal wall path. The apparatus then advances forward until the front edge of the rear chamber aligns with the internal wall starting location.

As shown in FIG. 65B, at this stage, the apparatus lifts both the inner and outer front chambers and the intermediate section vertically, thereby disengaging them from the current layer of the structure.

As shown in FIG. 65C, the middle section then rotates, adjusting the orientation of the front chambers to align with the intended direction of the internal wall path.

As shown in FIG. 65D, the front chambers are subsequently lowered to the appropriate height to initiate printing of the current layer of the internal wall.

As shown in FIG. 65E, following the initial deposition by the front chambers, the rear inner and outer chambers are elevated to align vertically with the middle section, preparing the apparatus for coordinated material extrusion along the internal wall path.

As shown in FIG. 65F, the middle section then rotates once more, bringing the front, middle, and rear chambers into alignment along the axis of the internal wall.

As shown in FIG. 65G, with the chambers aligned, the system advances forward while extruding, continuing to print the internal wall until the rear edge of the rear chamber reaches the terminal point of the internal path.

As shown in FIG. 65H, the middle and rear chambers are lowered to the active printing layer, and the apparatus resumes standard wall extrusion to complete the internal wall segment.

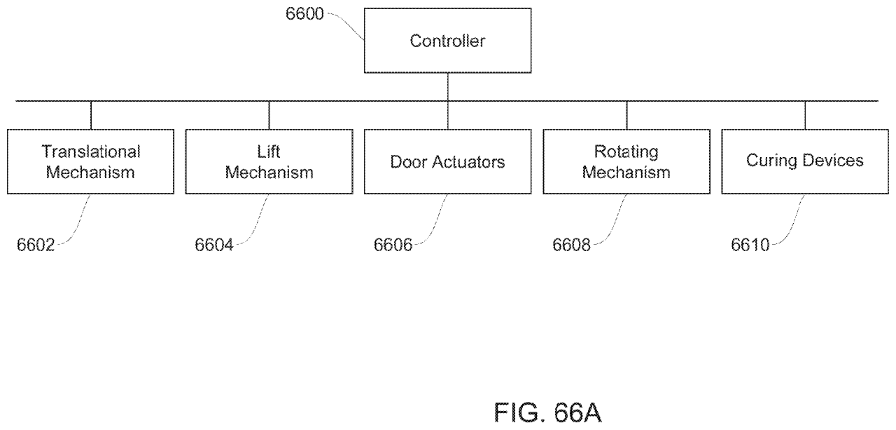

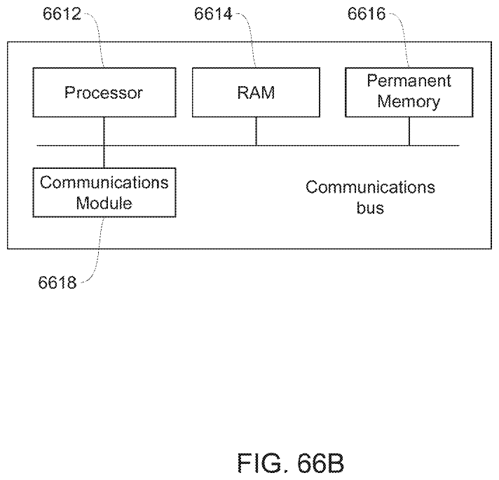

FIG. 66A is a schematic diagram illustrating a controller 6600 that is in communication with a translational mechanism 6602, a lift mechanism 6604, one or more door actuators 6606, a rotating mechanism 6608, and one or more curing devices 6610 for controlling operations thereof. More specifically, the controller 6600 can be programmed to effectuate deposition of the printing material in accordance with a desired pattern. For example, to do so, the controller 6600 can be configured to generate and send appropriate control signals to the components depicted in FIG. 66A to cause their activation/deactivation. For example, the controller 6600 can send control signals to the translational mechanism 6602 to cause the translation of the printing apparatus and also send control signals to one or more of the door actuators 6604 to open the doors so as to allow deposition of a layer of the printing material as the printing apparatus is translated. By way of example, in some implementations, the controller can cause the opening of the requisite extruder doors prior to causing the translation of the printing instrument while in other embodiments, the controller can cause the opening of the requisite extruder doors and the translation of the printing apparatus substantially concurrently. The controller can also send control signals to the one or more curing devices 6610 to activate those devices for curing the printing material, e.g., in a manner discussed above. By way of example, when the curing device includes UV light sources, the controller can send control signals to the UV light sources to cause their activation.

After a predefined length of the translation of the printing apparatus, the controller 6600 can send control signals to stop the translation of the printing apparatus and close the previously opened extruder doors. In some cases, the controller 6600 can then send control signals to cause the translation of the printing apparatus in a reverse direction as well as opening the opposed doors of the extruders to allow the deposition of the printing material as the printing apparatus moves in a reverse direction. Again, after a predefined length of translation in the reverse direction combined with the deposition of the printing material, the controller can send control signals to the translation mechanism to stop its movement and further send control signals to the door actuators to cause closing of the open extruder doors.

After completion of the deposition of printing material in one layer, the controller 6600 can send control signals to the lift mechanism 6604 to cause lifting of the printing apparatus to configure the printing apparatus for deposition of the printing material over a previously printed layer. By way of example, the lift mechanism 6604 can be implemented in a manner discussed above.

As noted above, in various embodiments, a printing device according to the present teachings can include a mechanism for rotating the extruder(s) so as to allow the deposition of the printing material around corners. In such embodiments, the controller 6600 can be also in communication with the rotating mechanism 6608 to trigger the mechanism to rotate the extruder(s) by a predefined angle to allow the deposition of the printing material around corners.

In various embodiments, the controller 6600 can be implemented in hardware, firmware and/or software using known techniques as informed by the present teachings. FIG. 66B illustrates an example of an implementation of the controller 6600, which includes a digital processor 6612 for executing instructions stored in a permanent memory 6616 for deposition of the printing material according to a predefined pattern. In this example, the controller 6600 further includes a random access memory (RAM) 6614, a communications module 6618 for communicating, e.g., for transmitting control signals, with various components of the printing apparatus, and a communications bus that allow the processor to communicate with other components of the communications module 6618.

In use, instructions for printing a desired structure can be stored in the permanent memory 6616. By way of example, such instructions can provide a pattern of deposition of a printing material so as to form the desired structure. In some embodiments, the controller can generate control signals based on the deposition pattern and transmit the control signals to the printing instrument.

Another disclosed implementation is a translational slipform 3D printing device capable of constructing walls of various configurations. This implementation operates through a controlled coordination of fixed and movable formwork structures, precise material flow, and multi-axis locomotion.

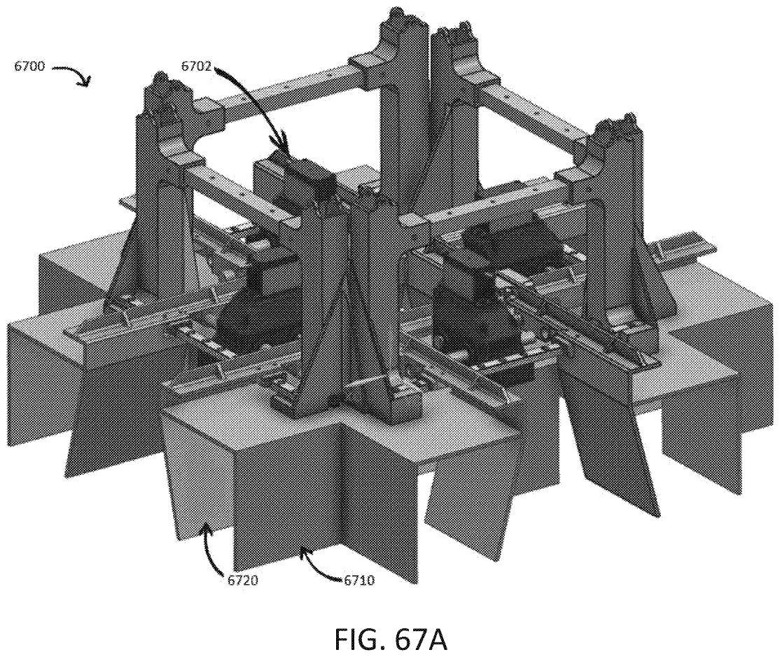

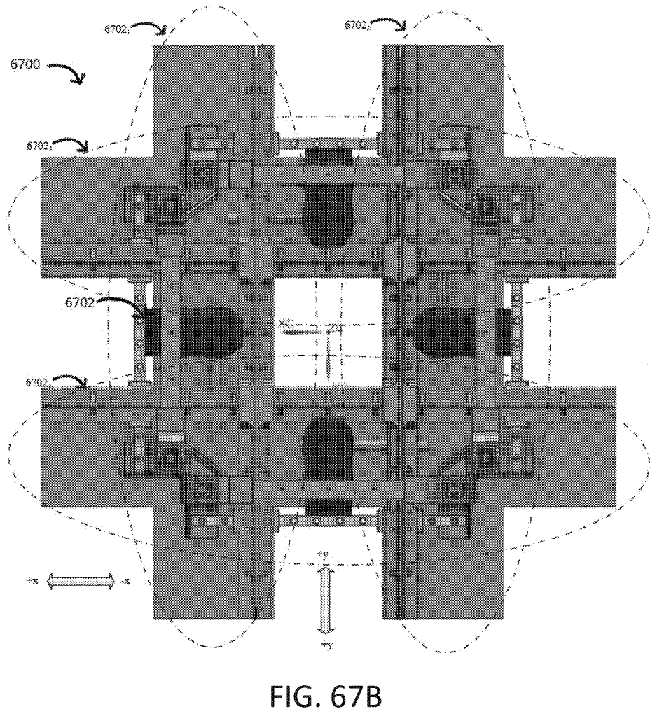

As illustrated in FIG. 67A and FIG. 67B, the printing device 6700 is configured to receive one or more types print material from one or more material supply mechanisms and form a structure from the print material(s). Printing device 6700 includes a formwork system comprising four forms (6702₁, 6702₂, 6702₃ and 6702₄ shown in FIG. 67B) for defining walls (also referred to as “wythes” herein). In masonry construction, a “wythe” refers to a continuous vertical section of masonry, such as a wall, that is one unit thick. Multiple wythes can be built side by side to form a thicker, multi-wythe structure, such as a wall.

Each form is indicated in the drawing by a dotted line in FIG. 67B. Note that the forms overlap one another and are configured and used for printing in pairs as described in detail below. The disclosed implementation illustrated in FIGS. 67A and 67B selectively leverage the four forms (6702₁, 6702₂, 6702₃ and 6702₄) for defining walls that include 2 wythes (W1 and W2) as shown in FIG. 1. Forms 6702₁ and 6702₂ are generally used in tandem to form a wythe when the printer 6700 is moving in the +y or −y direction (indicated by arrows in FIG. 67B and forms 6702₃ and 6702₄ are generally used in tandem to form a wythe when the printer 6700 is moving in the +x or −x direction (indicated by arrows in FIG. 67B).

Each form 6702₁, 6702₂, 6702₃ and 6702₄ includes outer formwork structures 6710 that define the external surface of the wythe being printed, and dynamic inner formwork structure 6720 that define the inner surface of a wythe being printed. The inner formwork structures are movable with respect to the outer formwork structures to transition between an “engaged/proximal state” for shaping the desired wythe and an “disengaged/remote state” in which they retract to create crucial clearance, as described in detail below.

The disengaged/remote state allows the printer 6700 device to reconfigure itself during corner printing operations, ensuring that the inner formwork avoids contact with the freshly printed inner wythes, as described in greater detail below. The position of the inner formwork structures are each independently caused by movement mechanisms 6702 individually coupled to the inner formwork structures. The movement mechanisms can include servos, motors, or other driving mechanisms. These mechanisms facilitate both horizontal movement between the engaged and disengaged states and vertical movement, allowing the inner formwork to ascend to a “clearance level” above the printed layer or return to a “base level” for active printing, also described in greater detail below. Specialized clearance grooves within the X-direction inner formwork enable the Y-direction inner formwork to move and rise without interference. Alternatively, or in combination the movement described above, the inner formwork structures can each be rotated about the top edge thereof to reduce the angle of the inner formwork structures with respect to the outer formwork structures to allow for clearance when the device scales up a layer.

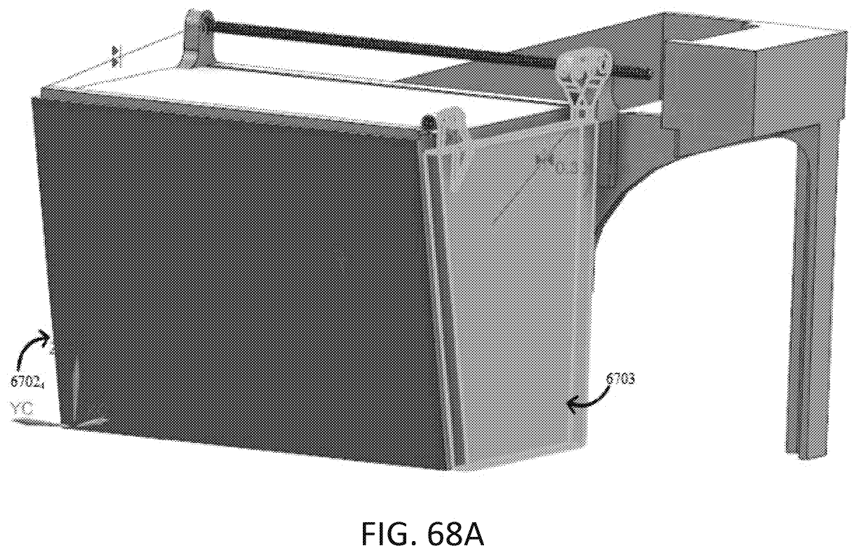

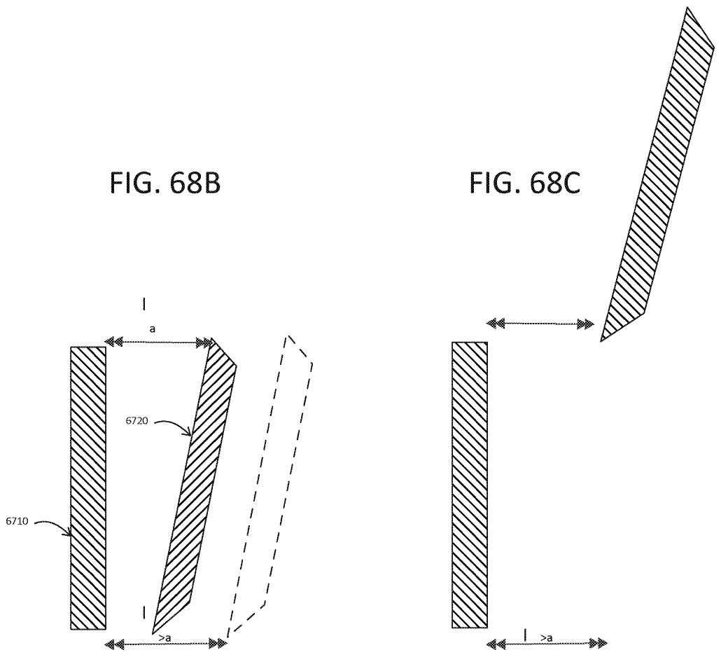

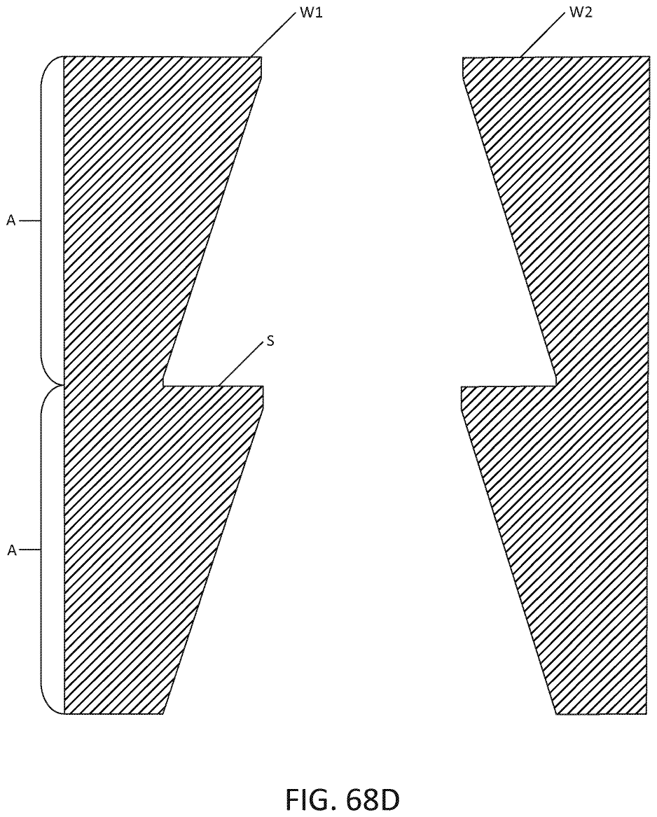

Integrated within chambers defined by the forms are a series of internal doors for directing the flow of printing material. These doors, which can operate via various mechanisms such as swinging hinges, tambour systems, sliding tracks, or motorized pathways, precisely control which sections of the wall receive material. Their “closed” position allows them to redirect material flow at the formwork level, while an “open” position allows material to flow substantially in a substantially unobstructed manner. Effective sealing, using gaskets, compression seals, or magnetic seals, can be provided to prevent any material leakage when these doors are closed, ensuring clean and accurate wall formation. FIG. 68A shows a portion of a chamber defined by a form with a door 6703 mounted on a hinge to be moved between the open and closed position. In FIG. 68A, the door 6703 is shown in a closed position whereby the door obstructs the flow of material through the form.

As shown best in FIGS. 68A and 68B, the cross of each form is trapezoidal in shape (i.e., it defines a four-sided geometric figure (a quadrilateral) that has exactly one pair of parallel sides (the top and bottom in FIG. 68B). This configuration permits wheels or other support elements of the printer 6700 to rest on a top portion of a lower level when printing. Specifically, as shown in FIG. 68D, which shows the cross section of an outer wythe W1 and an inner wythe W2 printed by the printer, with levels of printing, Level A and Level B. It can be seen that the cross sectional shape of the forms results in a substantially horizontal surface/step S being formed on the internal side of each wythe for supporting wheels or other guide mechanisms of the printer 6700. Alternatively, instead of a trapezoidal shape, internal lips can be created via a lip section added onto a rectangular cross-section. Various cross-sectional shapes can be formed on or in the wythes to create an inner lip, ledge, and/or track for the device to ride along. In another implementation, an internal lip/track on the wall is not required. Instead, the printer can grip the wall to locomote, with the wall exerting an inward pressure on the wheels or other guides.

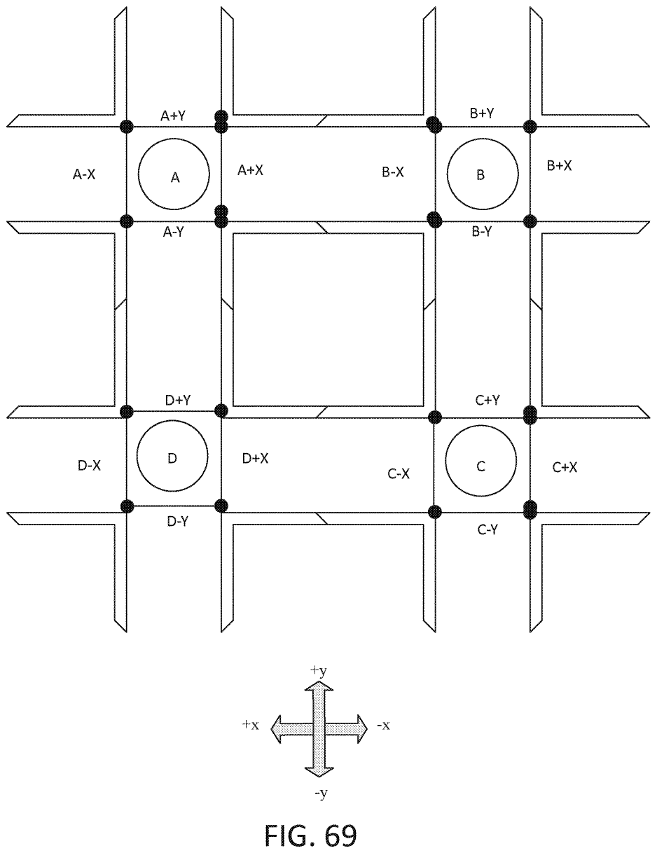

As noted above, in this implementation, the doors are internal to the chambers, which are themselves created by the interplay of the outer formwork structures and the inner formwork structures. As shown in FIG. 69, there are four primary material feed locations, labeled ‘A’, ‘B’, ‘C’, and ‘D’. Surrounding each of these material feed locations are directional doors. For instance, at location ‘A’, there are doors designated ‘A+X’, ‘A−X’, ‘A+Y’, and ‘A−Y’, which control material flow in the corresponding positive/negative X and Y directions relative to that feed point. This arrangement creates a grid-like network of controllable barriers within the formwork. Each of the doors is capable of transitioning between a “closed/engaged” position and an “open/disengaged” position. When closed, a door is positioned at the formwork level, effectively acting as a barrier or guide to redirect material flow. In one example, these doors slide from the Z-direction into place. When open, a door is moved to allow material to flow freely past it without substantially obstructing the flow of material. The movement of the doors can be achieved through various mechanisms, including:
Hinge Style: Doors may swing on hinges to their desired locations.
Tambour Mechanism: Doors can roll out into place.
Sliding Track: Doors can follow a sliding track
Mechanistic Path: More complex movements can be achieved via motors, servos, linear actuators, or hydraulics.

The selective activation (engagement and disengagement) of these doors, in conjunction with the dynamic inner formwork, allows for the precise definition of the forms, or channels, through which print material flows to create wythes.

For example, during printing of a wall while moving in the-X direction printing doors are engaged and disengaged such that an enclosed set of parallel forms in the X-direction 6702₃ and 6702₄ (See FIG. 67B) are created to create the first section of one layer of a wall, having two distinct wythes, in the X-direction. By selectively engaging certain doors to act as internal dividers and disengaging others to allow material flow, in combination with selective control of material flow through the material ports, the device can create multiple, distinct channels or voids within a single printed layer. This capability is fundamental to constructing walls with specific cross-sections, such as those with air gaps for insulation, internal conduits, or multi-layered structural elements, which are effectively different wythes. The precise control over material flow paths, achieved through the selective activation of these internal doors, ensures that the desired formwork geometry for each wythe is maintained as material is deposited.

An example of the operational precision provided by this implementation is a corner printing sequence, which involves a dynamic orchestration of material flow and formwork movement. In such a sequence, initially, material flows from all four locations to establish the first wall layer (constating of two wythes in this example. As the device prints in a specific direction (e.g., −X), some material feeds cease, and doors adjust to allow continuous travel while material sets. Upon reaching the corner, specific material feeds activate, and doors configure to deposit a sharp 90-degree corner layer. Following this, a complex sequence of inner formwork disengagement, inward movement, and vertical repositioning occurs in both X and Y directions, creating necessary clearances. The device then translates, and the formwork returns to its printing height, culminating in the inner formwork re-engaging to prepare for the next printing direction (e.g., +Y). This multi-step process allows the device to seamlessly transition between straight and corner printing.

A specific example of a corner printing process in accordance with disclosed implementations will now be described in detail. Note that, in the following FIGURES, active material ports are designated by a circle. Lack of a circle indicates that the material port is not active. An active material port is a material port through which material is being fed. The active and non-active status of the material ports can be controlled by doors, valves, pump control, or any other mechanism for selectively allowing material to flow through the ports. Also, note that, at the bottom of each FIGURE, a top view representation of the printed wall is provided to demonstrate the result of each step of printing.

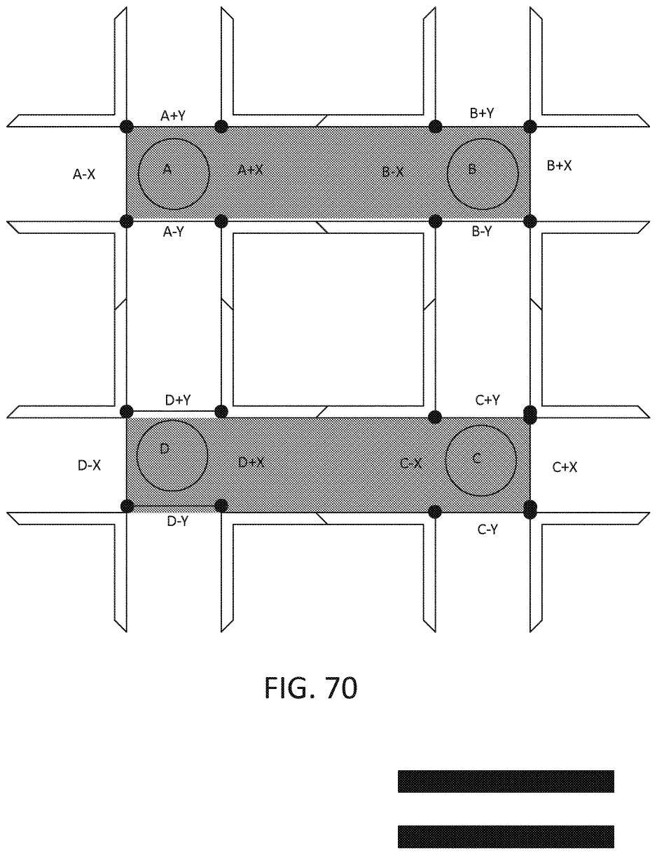

At Step 1, the printer 6700 is configured as shown in FIG. 70 and described below: Print Commencement for-X direction printing
Location A
   Material Feed at A: Active
   Door A+X: Disengaged
   Door A−X: Engaged
   Door A+Y: Engaged
   Door A−Y: Engaged
Location B
   Material Feed at B: Active
   Door B+X: Engaged
   Door B−X: Disengaged
   Door B+Y: Engaged
   Door B−Y: Engaged
Location C
   Material Feed at C: Active
   Door C+X: Engaged
   Door C−X: Disengaged
   Door C+Y: Engaged
   Door C−Y: Engaged
Location D
   Material Feed at D: Active
   Door D+X: Disengaged
   Door D−X: Engaged
   Door D+Y: Engaged
   Door D−Y: Engaged
   Inner form X: Engaged
Inner form X, Vertical Level: Base level
Inner form Y: Engaged
Outer form+Inner form Y, Vertical Level: Base level
Locomotion: Not active

During Step 1, material is flowing into the chambers from all four material feed locations while the printer is in a stationary position. Doors are engaged and disengaged such that an enclosed set of parallel forms in the X-direction (indicated by shading in FIG. 70 are created to create the first section of one layer of the wall in the X-direction (as indicated by a tope view of the wall at the bottom of FIG. 70.

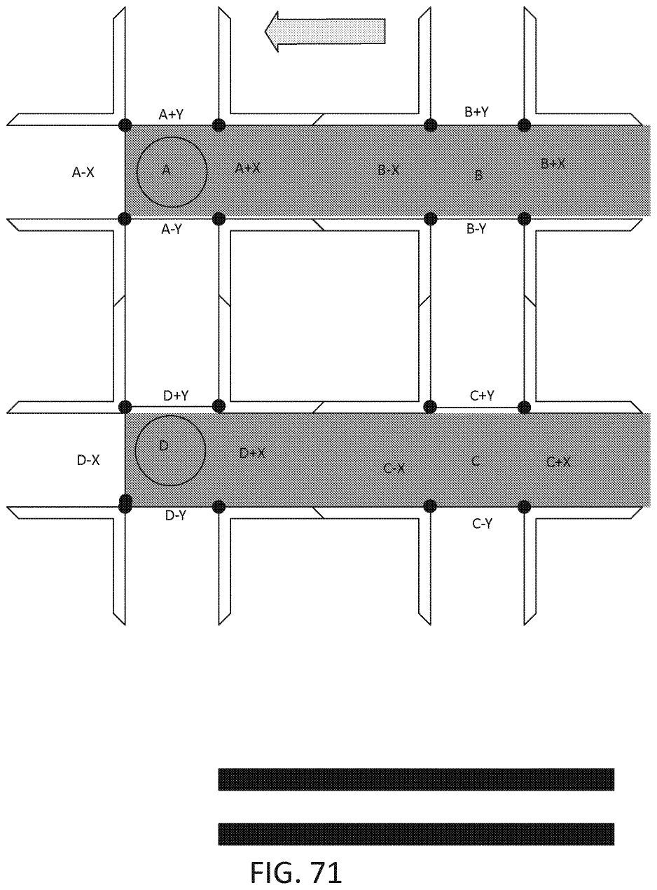

At Step 2, the printer 6700 is configured as shown in FIG. 71 and described below: Step 2: Printing in the −X direction
Location A
   Material Feed at A: Active
   Door A+X: Disengaged
   Door A−X: Engaged
   Door A+Y: Engaged
   Door A−Y: Engaged
Location B
   Material Feed at B: Not active
   Door B+X: Disengaged
   Door B−X: Disengaged
   Door B+Y: Engaged
   Door B−Y: Engaged
Location C
   Material Feed at C: Not active
   Door C+X: Disengaged
   Door C−X: Disengaged
   Door C+Y: Engaged
   Door C−Y: Engaged
Location D
   Material Feed at D: Active
   Door D+X: Disengaged
   Door D−X: Engaged
   Door D+Y: Engaged
   Door D−Y: Engaged
Inner form X: Engaged
Inner form X, Vertical Level: Base level
Inner form Y: Engaged
Outer form +Inner form Y, Vertical Level: Base level
Locomotion: Active,-X direction of travel

During Step 2, material flows into the chambers from the A and D material feed locations and the B+X and C+X doors have opened to allow for the device to travel in the −X direction. As the device travels in the −X direction, the deposited material that is left behind acts as a blockage for material filling the cavities being created in the A and D region, allowing material to continuously fill and set within the chambers.

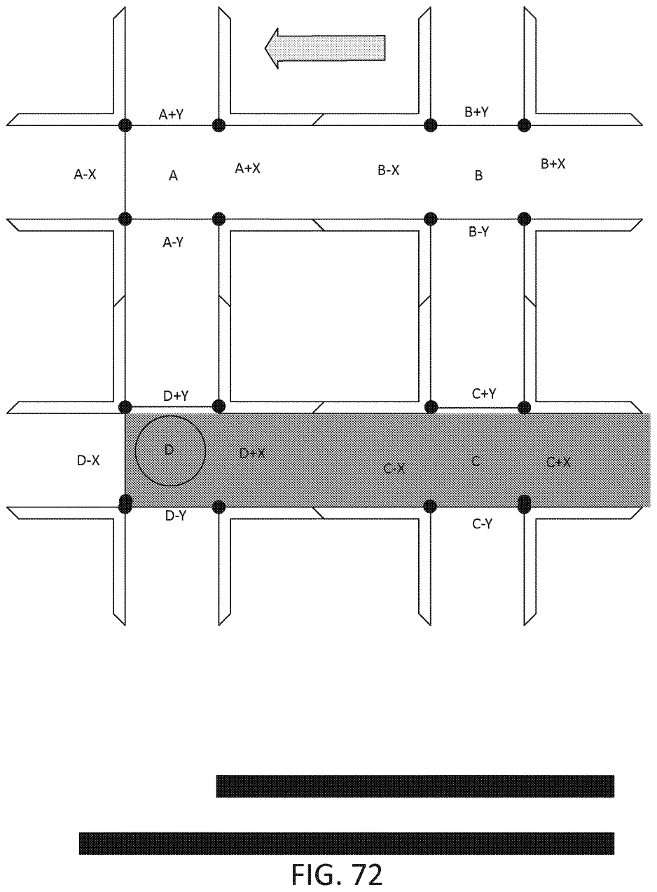

At Step 3, the printer 6700 is configured as shown in FIG. 72 and described below: Step 3: Flow stops in +Y chamber while printing continues.
Location A
   Material Feed at A: Not active
   Door A+X: Disengaged
   Door A−X: Engaged
   Door A+Y: Engaged
   Door A−Y: Engaged
Location B
   Material Feed at B: Not active
   Door B+X: Disengaged
   Door B−X: Disengaged
   Door B+Y: Engaged
   Door B−Y: Engaged
Location C
   Material Feed at C: Not active
   Door C+X: Disengaged
   Door C−X: Disengaged
   Door C+Y: Engaged
   Door C−Y: Engaged
Location D
   Material Feed at D: Active
   Door D+X: Disengaged
   Door D−X: Engaged
   Door D+Y: Engaged
   Door D−Y: Engaged
Inner form X: Engaged
Inner form X, Vertical Level: Base level
Inner form Y: Engaged
Outer form+Inner form Y, Vertical Level: Base level
Locomotion: Active, −X direction of travel

During Step 3, material flow stops at Location A while it continues at location D, allowing the bottom part of the corner to continue to be printed. The device continues to travel and deposits material until the edge of the deposited material on the A−C upper formwork section reaches the B−X door, as shown at the bottom of FIG. 72.

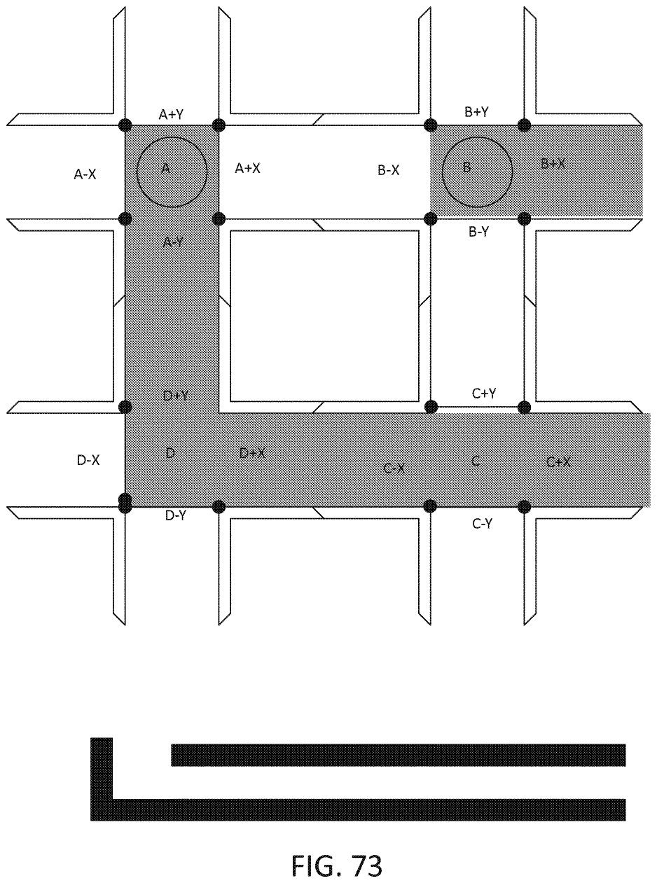

At step 4, the printer 6700 is configured as shown in FIG. 73.

### Step 4: Corner Reached, and Corner Printing Commences

Location A
   Material Feed at A: Active
   Door A+X: Engaged
   Door A−X: Engaged
   Door A+Y: Engaged
   Door A−Y: Disengaged
Location B
   Material Feed at B: Active
   Door B+X: Disengaged
   Door B−X: Engaged
   Door B+Y: Engaged
   Door B−Y: Engaged
Location C
   Material Feed at C: Not active
   Door C+X: Disengaged
   Door C−X: Disengaged
   Door C+Y: Engaged
   Door C−Y: Engaged
Location D
   Material Feed at D: Not active
   Door D+X: Disengaged
   Door D−X: Engaged
   Door D+Y: Disengaged
   Door D−Y: Engaged
Inner form X: Engaged
Inner form X, Vertical Level: Base level
Inner form Y: Engaged
Outer form+Inner form Y, Vertical Level:: Base level
Locomotion: Not active

During Step 4, material flows into Locations A and B, with appropriate doors engaged and disengaged to ensure that a sharp 90-degree corner layer is deposited.

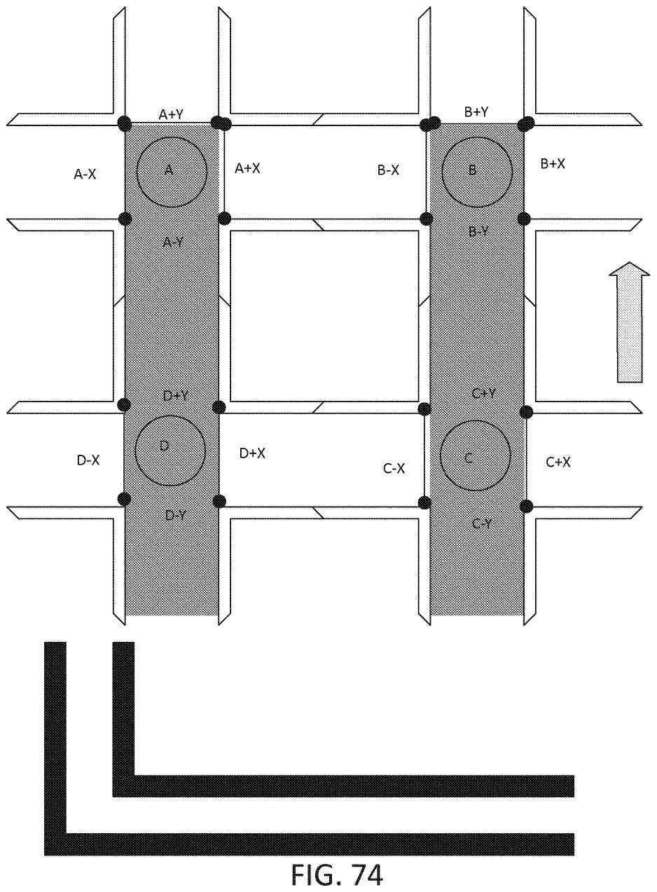

At Step 5, the printer is configured as shown in FIG. 74.
Location A
   Material Feed at A: Not active
   Door A+X: Disengaged
   Door A−X: Disengaged
   Door A+Y: Disengaged
   Door A−Y: Disengaged
Location B
   Material Feed at B: Not active
   Door B+X: Disengaged
   Door B−X: Disengaged
   Door B+Y: Disengaged
   Door B−Y: Disengaged
Location C
   Material Feed at C: Not active
   Door C+X: Disengaged
   Door C−X: Disengaged
   Door C+Y: Disengaged
   Door C−Y: Disengaged
Location D
   Material Feed at D: Not active
   Door D+X: Disengaged
   Door D−X: Disengaged
   Door D+Y: Disengaged
   Door D−Y: Disengaged
Inner form X: Disengaged
Inner form X, Vertical Level: Base level
Inner form Y: Engaged
Outer form+Inner form Y, Vertical Level: Base level
Locomotion: Not active

In this step, material flow is stopped (i.e. all material ports are not active) and a direction transition sequence begins. First the X direction inner form structures move inward to disengage from the printed material, creating clearance. As shown in FIG. 68B, the inner form structures 6720 of the X direction forms move inward from the position shown in black to the positions shown by the dotted line. Note that the inner form structures move to create a distance between the lower edge of the inner form structures 6720 and the printed material and is at least large enough to permit the Inner form structures to be moved upward without interference by the printed material. Next, the X direction inner form structures are moved upward (in the Z direction) to a position that places the entirety of the inner form structures above the top of the printed material, as shown in FIG. 68C.

At Step 6, the inner form structures in the Y-direction forms move inwards. During this step the Y direction inner form structures move inward to disengage from the printed material, creating clearance. As shown in FIG. 68B, the inner form structures 6720 of the Y direction forms move inward from the position shown in black to the positions shown by the dotted line. Note that the inner form structures move to create a distance between the lower edge of the inner form structures 6720 and the printed material that is as least large enough to permit the inner form structures to be moved upward without interference by the printed material. Next, the Y direction inner form structures are moved upward (in the Z direction) to a position that places the entirety of the inner form structures above the top of the printed material, as shown in FIG. 68C.

At Step 7, all of the inner form structures and the rigid outer formwork move up to Level 2 while the inner form X vertical distance to the outer formwork is kept constant, so this forms effectively moves to Level 3. In step 8, the entire printing device 6700 translates in the +Y direction as shown by the arrow in FIG. 73

During this step, the device translates in the +Y direction given there is now sufficient clearance between the formwork and the previously deposited layer. The device translates to the point where the D−Y door is at the end of the material that was making contact with the A+Y door.

At Step 8 the framework structures return to the printing height. The inner form Y and the outer formwork return to the base level while the inner form X returns to level 2. Subsequently, the Y inner form structure engages to create sufficient clearance for the inner form X to come back to base level. Next, the X inner form structure returns to the base level. Finally, the X inner form structure engages, i.e. moves to the position in which the X Form is defined. All formwork structures now in the appropriate orientation to commence with printing in the +Y direction once appropriate doors engage.

At Step 9 the doors are configured and material flow is directed to allow for +Y printing.
Location A
   Material Feed at A: Active
   Door A+X: Engaged
   Door A−X: Engaged
   Door A+Y: Engaged
   Door A−Y: Disengaged
Location B
   Material Feed at B: Active
   Door B+X: Engaged
   Door B−X: Engaged
   Door B+Y: Engaged
   Door B−Y: Disengaged
Location C
   Material Feed at C: Active
   Door C+X: Engaged
   Door C−X: Engaged
   Door C+Y: Disengaged
   Door C−Y: Disengaged
Location D
   Material Feed at D: Active
   Door D+X: Engaged
   Door D−X: Engaged
   Door D+Y: Disengaged
   Door D−Y: Disengaged
Inner form X: Engaged
Inner form X, Vertical Level: Base level
Inner form Y: Engaged
Inner form Y, Vertical Level: Base level
Locomotion: Not active

During this step, the appropriate doors engage and material flows through all four material input locations to deposit material in the formwork to start the +Y direction printing layer, as shown in FIG. 74.

Now that a corner has been formed, as shown in FIG. 74, printing can continue in the +Y direction with the device configured as shown in FIG. 74.

Separate onboard reservoirs can contain the same or different materials, which can be selectively delivered through ports A, B, C, and D. This selection can be achieved through mechanisms such as a selector nozzle, a turret set of nozzles allowing for material toggling, or coaxial/concentric nozzles that enable layered deposition of distinct materials. Dedicated material transmission lines can be controlled by, for example, motorized ball valves. To prevent cross-contamination, a sophisticated purging system can flush the lines with a purge material, which can be automated and sensor-triggered. Material delivery can be precisely managed by positive displacement pumps and monitored by an array of sensors, including flow meters, pressure transducers, and temperature controls, all governed by, for example, PID control algorithms.

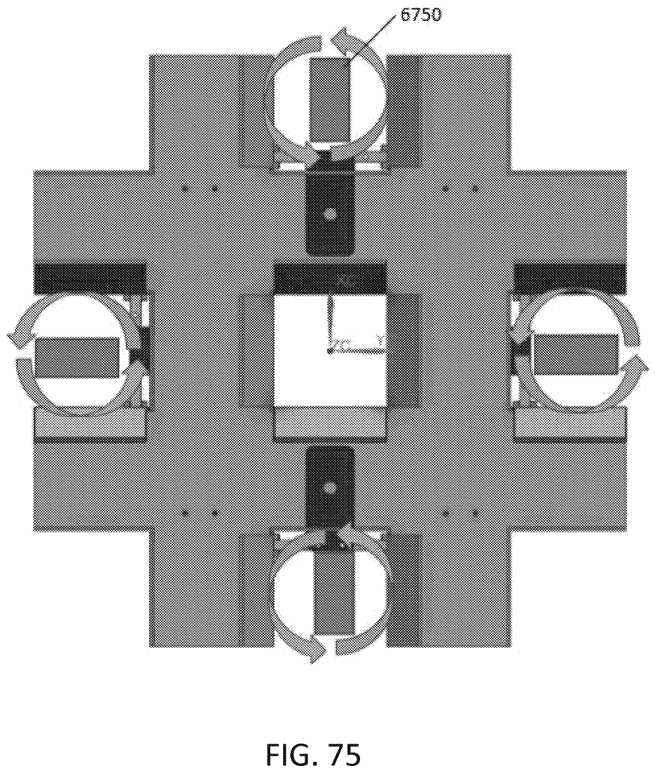

The locomotion system of printer 6700 enables translational movement across the X−Y plane and vertical movement along the Z-axis for layer-by-layer construction (in a manner similar to that described above with respect to other implementations. This movement is achieved through various wheel types (e.g., omnidirectional, mechanism, swerve drive) or track modules, driven by motors with diverse coupling methods. For example, four individually controlled wheels 6760 capable of rotating along their central axis for X−Y plane translation can be provided as shown in FIG. 75 Control of the locomotion system can leverage advanced algorithms, from open-loop to closed-loop feedback systems utilizing a suite of sensors (encoders, IMU, GPS, LiDAR, cameras) and can incorporate machine learning policies for autonomous operation. Additional wheels can be used to make the device more stable. Various wheels, drive mechanisms and support structures can be applied for stable locomotion. Further, stabilization wheels/support structures could also be disposed on the outside of the forms and/or clamped against the outside of the wythes or otherwise attached to the wythes.

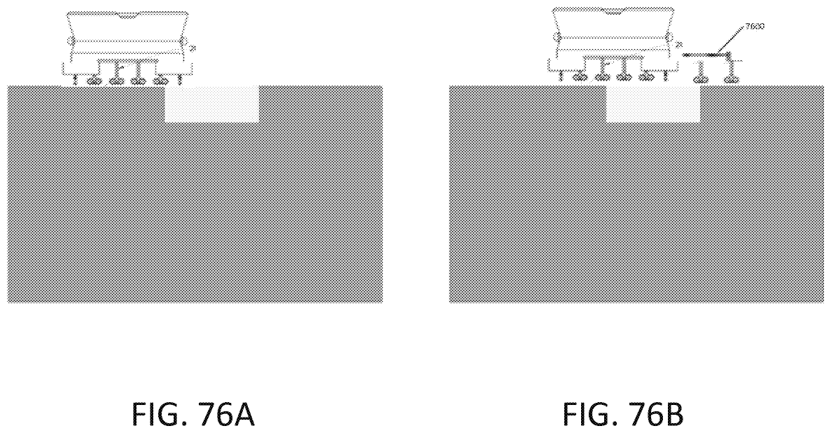

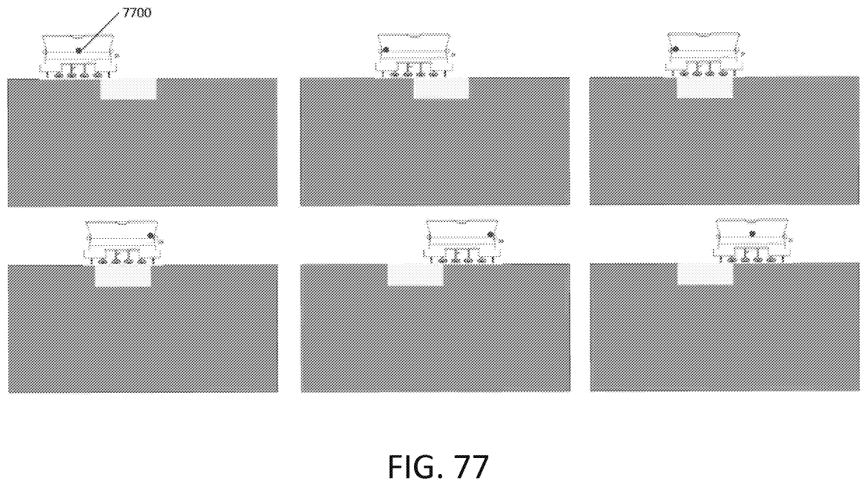

This disclosed implementations also provide sophisticated fenestration printing capabilities, allowing for the creation of openings within walls for windows, doors, vents, and the like. In one example, a track extension mechanism can be provided in printing device 6700. As shown in FIGS. 76A and 76B, the track extension mechanism can include a cantilever support 7600 that is extended from the printer before or during a pass of the printer over a fenestration. Of course, the fenestration can be defined by an area in one more lower levels in which printing was stopped as the printer passed over the area. The track extension mechanism allows the printer to bridge gaps, as shown in FIGS. 76A AND 76B, ensuring continuous support while material flow is paused. Alternatively, a sufficiently long printing device can maintain its center of gravity over printed material even while spanning an opening, optionally with a movable mass 7700 to adjust the center of gravity as shown in FIG. 77. Further, various mechanisms for gyroscopic stabilization can be used to balance the printer.

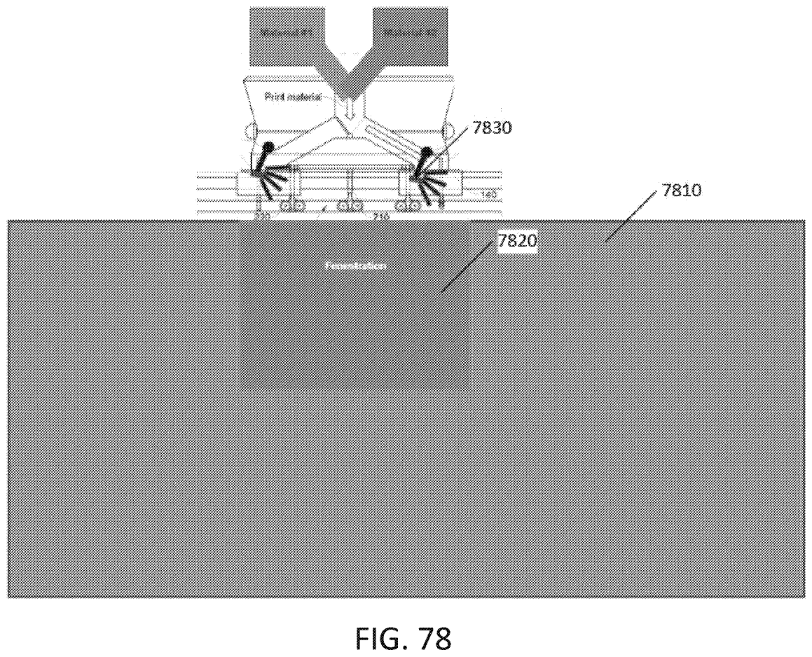

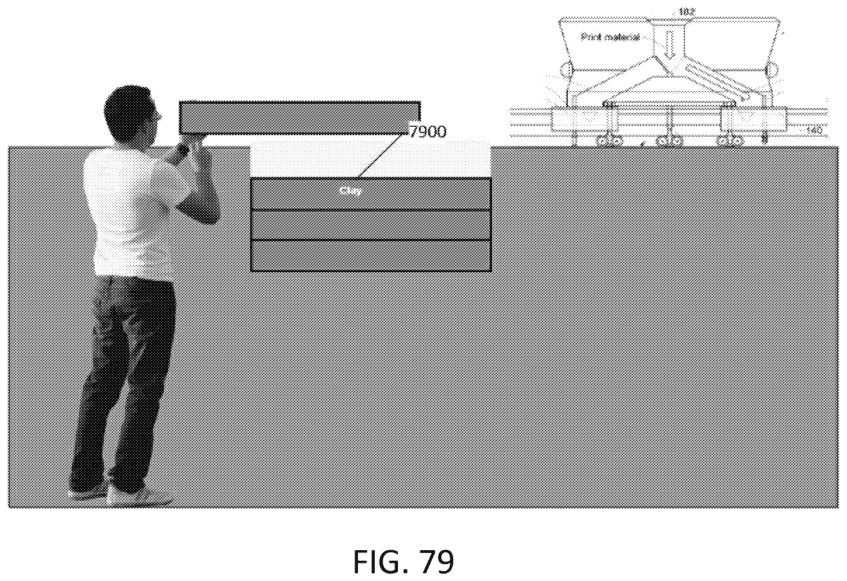

As illustrated in FIG. 78, another example of a method for printing fenestration can include toggling between primary wall material 7810 and a specialized filler material 7820 (e.g., spray polyurethane foam, gypsum) during a printing operation. The filler material 7820 can be used for printing in a selective manner to temporarily fill the fenestration gap, providing structural support until the load-bearing wall material cures. A material purge system, including brushes 7830 or the like, can be provided for use before and after the material transition. Alternatively, manual insertion of modular blocks 7900 or filler material, connected by various mechanical means, can also provide support for printing around fenestrations, as shown in FIG. 79. Another implementation includes a manual or automated jack system that has a lintel on top of it that provides the “track” for the device to move over, raising up to the next layer when the device comes back around to the fenestration at the next layer height. These methods ensure that the device can successfully print over openings, with specific mechanisms for bridging gaps and forming the top layer of the fenestration.

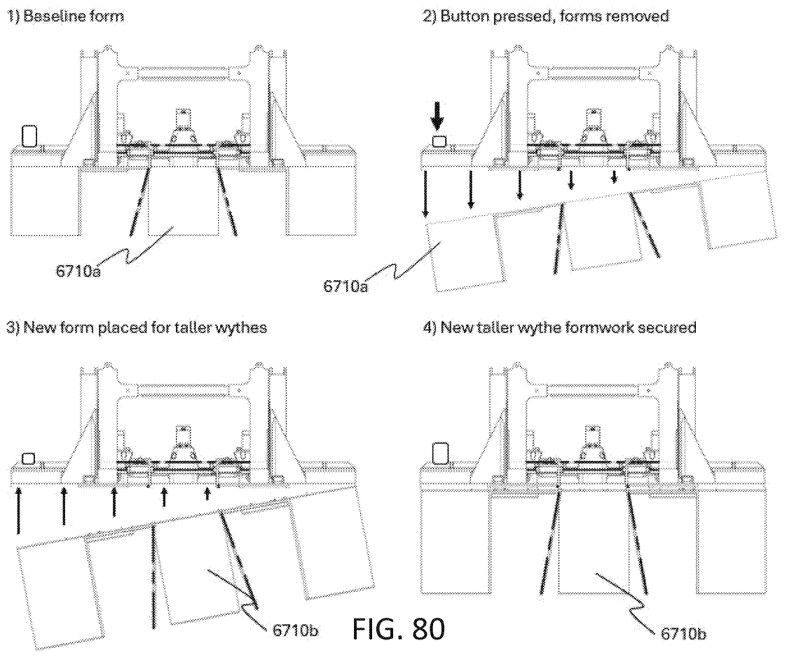

In disclosed implementations, the formwork can be modular. Modular formwork structures can be swapped in via quick-release latches, magnetic couplings, or rail systems, enabling the construction of diverse geometries, including various corner angles and curved wall sections, with specific spline capabilities. For example, as shown in FIG. 80 the formwork structures can be swapped out if the desired wall cross-section changes. For example. A button is clicked that unlatches the forms, allowing an operator to swap a 6″ form height formwork structure 6710a (for an 8″ form height formwork structure 6710b. This can be accomplished manually automatically by a mechanism that swaps formwork structures in and out. These modules can also integrate electrical and data coupling for vibrators, sensors, or other mechanisms. This modularity not only simplifies maintenance but also greatly enhances the design flexibility of the structures. In some cases, these modular pieces can be manually swapped.

Modular formwork pieces can be utilized to achieve desired corner angles, straight wall sections, and varying curves wall sections, with specific and adjustable wall splines possible. In some implementations, the formwork can include mechanisms incorporated therein for vibration, sensing, wall smoothing, material flow, or other actions. Electrical and data coupling may be incorporated into the modules via pogo pins and contact pads, magnetically aligned electrical connectors, docking plates, multi-pin blocks, inductive coupling, optical/infrared links, or via Bluetooth/wireless modules. These formwork modules may be swapped into and out of the device manually via human intervention, swapped via a separate robotic device, or swapped via internal mechanisms and storage systems that hold rigid formwork pieces or assemble modular pieces of formwork within the device.

The printer locomotion described above can be achieved based on an inner set of mechanisms that are coupled to a vertically extending system, enabled through linear actuators, hydraulics, or other means for vertical motion. The locomotion devices can be track systems, wheels, mecanum wheels (a type of omnidirectional wheel that feature angled rollers attached around the circumference), or other devices, with these allowing for translation in the X and Y plane.

One implementation consists of at least 2 wheels that may be any combination of straight wheels, caster wheels, differential drive wheels, ackerman steering wheels, skid-steer wheels, omnidirectional wheels, mecanum wheels, swerve drive wheels, rubber tread wheels, foam wheels, spiked wheels, inflatable wheels, or hybrid wheels with suspension spokes. Other implementations may have continuous track modules driven by a belt or chain, spherical wheels, ball caters, or universal ball drives, or any combination of these locomotion types. These wheels and locomotion methods may be driven by direct drive (motor-to-wheel) control via hub motors that are brushed or brushless, motor shaft coupling via brushed or brushless motor, gear reduction driven via a spur gear drive or planetary gearbox, timing belt driven, roller chain and sprocket driven, shaft and axle driven, differential gear drive driven, or controlled via independent wheel modules via swerve drive modules or independent brushed or brushless motors. Other implementations may have advanced drives via a friction drive, where a roller wheel presses against the driven wheel, a cable or pulley drive, hydraulic or pneumatic driven wheels, or linear actuator driven wheels where the linear motion of the actuator is converted into rotary motion.

Track specific drives may also be implemented via sprocket driven tracks, dual motor track drives, or a central motor and shaft drive. Any combination of wheels and driving methods may be utilized for a particular embodiment of the robotic device described. These drive methods can be controlled via any singular or combination of control methods implemented in the on-board control logic of the robot, which includes open-loop control, where voltage is applied to the drive system with no feedback, closed-loop control where feedback is utilized from sensors to respond to environmental and robotic conditions, with sensors used for this control method including but not limited to encoders (optical or magnetic), current sensors, inertial measurement unit sensors (IMU), gyroscopic sensors, global positioning system (GPS) sensors, Light detection and ranging (LiDAR) sensors, or camera systems. Proportional-integral-derivative (PID) control loops may be implemented in any embodiment to regulate speed and position of the locomotion system, with P, I, and D tuning performed to optimize the controller for any particular embodiment.

Other advanced control methods may be implemented in any particular embodiment as well, with model predictive control and machine learning polices being implemented for autonomous robot control. Model predictive control may be implemented via any appropriate model, which may include a differential-drive kinematics model, which can then be implemented linearly, non-linearly, or via a sample-based approach to control the movement of the device via a real-time loop. Tuning may be performed in real time based on expected and actual movement of the device. Model-free reinforcement learning (RL), imitation learning (IL), or model-based RL may be implemented for the machine learning policy utilized by the robotic device for locomotion applications, or any hybrid approach (machine policy control with reinforcement learning, reinforcement learning with a safety shield for hazard avoidance, a machine policy control implementation with guided reinforcement learning). Communication and command of these drive systems may be implemented in any particular embodiment via direct microcontroller control (i.e., Arduino, STM32), which relies on pulse width modulation (PWM) or universal asynchronous receiver/transmitter (UART) signals sent to drivers. Single Board Computers (i.e., Raspberry Pi, Jetson, etc.) may be utilized for these control applications, with more processing power for machine learning and higher-level navigation embodiments. Controller area network (CAN) bus or RS-485 may be utilized for device communication with multi-mechanism/sensor systems. Any embodiment may also employ a dedicated operating system to coordinate the drivers, sensors, and autonomous functions implemented in the embodiment.

The described locomotion system can be implemented in such a way to enable translation in the X and Y plane (the translational print directions) along with movement of the entire device in the Z direction to enable scaling of the device between layers. X and Y translational operations may be employed at the same time to allow for curved wall printing and movement along a non-straight path in the X and Y plane. Further, disclosed implementations can include further integration with specialized robotic devices for tasks like window and door installation. These ancillary robots can leverage the same principles of locomotion and control as the primary printer device, allowing for a cohesive and automated construction process. After extrusion, material can be compacted by a compaction mechanism which can include any set of doors, a compaction armature on the outside of the device, and/or a vibration compaction device.

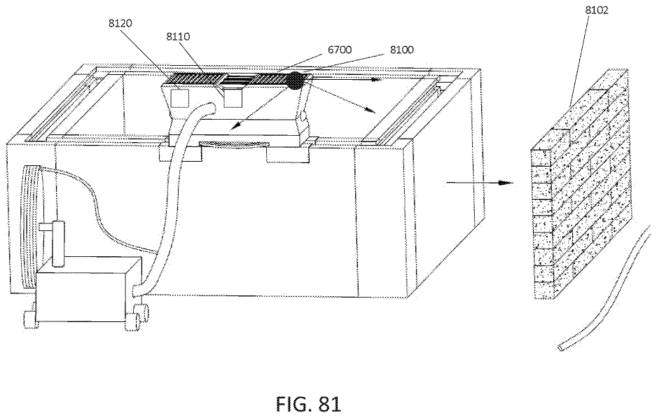

To ensure the highest degree of accuracy, quality, and autonomy, the translational slipform device 6700 can be equipped with an advanced, integrated inspection system. With reference to FIG. 81, This system can function as the sensory core of the device, enabling real-time data acquisition, processing, and closed-loop feedback to dynamically guide and correct the construction process.

In some implementations, the inspection system is fundamentally comprised of three interconnected subsystems: a multi-modal sensor suite (including sensor 8100 for example), a data processing and control unit 8110, and a communication and feedback loop interface 8120. The data processing control unit 8110 and the communication and feedback loop interface 8120 can be disposed on the device 6700 or on a separate device that is in communication with the device 6700 through a wired or wireless connection. The sensor suite can be a collection of diverse and complementary sensing technologies mounted on the device, each chosen to capture specific types of data about the printed structure and the surrounding environment. Geometric and environmental mapping sensors can capture the three-dimensional geometry of the workspace and the structure as it is built. For example, the inspection system can create a high resolution digital model 8102 of the structure as it is being built and compare the model with the intended design, thereby identifying and mitigating potential deviations, defects, or environmental hazards.

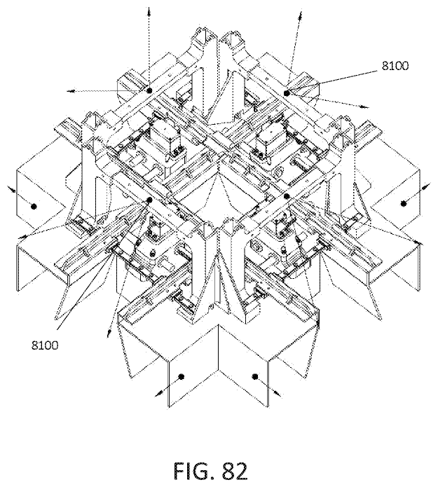

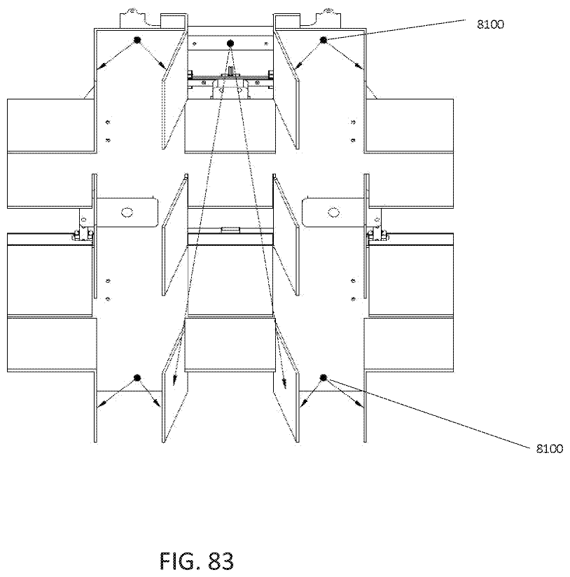

The dots in FIGS. 82 and 83 illustrate possible locations of various sensors 8100 on the device 6700, only some of which are labeled. The arrows in FIGS. 82 and 83 indicate possible sensing directions of the sensors. The system includes one or more Light Detection and Ranging (LiDAR) units. These may be spinning LiDAR sensors that provide a 360-degree field of view, or solid-state LiDAR sensors that offer a more focused and durable scanning solution. The LiDAR units emit laser pulses and measure the time-of-flight to generate a precise three-dimensional point cloud of the printed walls, the ground surface, and any potential obstacles in the device's path. The suite may also include a system of multiple high-resolution digital cameras arranged in a stereo or multi-view configuration. By capturing synchronized images from different perspectives, the data processing unit can perform photogrammetric reconstruction to create a dense, textured 3D mesh model of the structure. This is particularly useful for visual defect detection and surface texture analysis. A structured light scanner used for high-precision surface profiling can project a known pattern of light (e.g., lines, grids, or dots) onto the wall surface and use a camera to capture the deformation of the pattern. This allows for sub-millimeter accurate measurement of surface flatness, smoothness, and the detection of fine cracks or slumps. Placing a camera on the vertical surface of the inner forms would allow traversal path mapping for the device and allow for detection of abnormalities and artifacts before the device moves each step. A mirrored placement towards the back of the device (the side of the device that is opposite the direction of travel) would allow for the device to inspect the placed concrete by considering the immediate slump, and geometrical profile of the wall layer. Embodiments exist where the device can change directions, and thus camera placement is in all directions of travel and opposite all directions of travel to enable this capability in all directions.

To contextualize the captured data, the system can include positions sensors such as an Inertial Measurement Unit (IMU) for tracking the device's orientation (pitch, roll, yaw), and a high-precision Global Navigation Satellite System (GNSS) receiver, preferably with Real-Time Kinematic (RTK) correction, for determining the device's absolute global position to within centimeters. Wheel encoders can be associated with the wheels of the device to provide precise odometry data for tracking translational movement. Optical Navigation Sensors or LaserStream technology-based sensors can be mounted on the underside of the device to allow precision and adjustable-gain measurement of the traversal path with sub-millimeter precision.

Sub-surface and material property sensors can be used to inspect features of the structure being printed and/or the surrounding elements that are not visible on the surface, including embedded utilities and the internal state of the print material. Embedding concrete stabilizers with moisture detection will allow recording of concrete moisture levels and evaporation rate.

Ultra-Wideband (UWB) or Millimeter-Wave (mmWave) radar sensors can be applied to locate embedded items in a don-destructive manner. For example, the system may employ a compact radar module that emits radio waves that can penetrate the print material. Reflections from objects with different dielectric properties, such as PVC or PEX plumbing pipes, electrical conduits, or even voids, can be detected. Advanced processing techniques like Synthetic Aperture Radar (SAR) can be used to generate a 2D or 3D map of these sub-surface features. In some implementations, UWB tags or BLE (Bluetooth Low Energy) beacons are pre-attached to wiring and plumbing to provide a strong, unambiguous signal for precise localization.

A thermal camera, such as Infrared (IR) thermography camera can be included in the suite to monitor the surface temperature of the printed layers. As many print materials like concrete cure via an exothermic reaction, the thermal data provides a direct, real-time indication of the material's cure state. This information is critical for determining when a layer has achieved sufficient strength to support the next layer, thereby optimizing the printing speed. The thermal camera can also detect anomalies that may indicate improper material mixing or environmental issues. Uneven heating due to environmental constraints can lead to excess moisture patches leaving the mixture ‘wet’ and can be detected by this method. An array of ultrasonic transducers may be used in a pulse-echo mode to measure the thickness of the printed walls and to detect internal defects such as voids, delamination, or honeycombing.

The data processing and control unit, which may be a ruggedized, onboard industrial computer or a powerful single-board computer, serves as the brain of the inspection system. It receives the high-bandwidth data streams from the entire sensor suite. The data processing and control unit can intelligently combine the data from multiple sensors to build a comprehensive, multi-layered digital model of the as-built structure-often referred to as a “digital twin.” For example, it can overlay the thermal data from the IR camera onto the 3D geometric mesh generated by the photogrammetry system, or map the sub-surface locations of pipes from the UWB radar into the LiDAR point cloud. Once the real-time as-built model is generated, the processing unit can perform a comparative analysis in which it algorithmically compares the created model against the original “as-designed” digital model (e.g., from a CAD or BIM file) and can generate corrective commands to the device based on the comparison. This analysis can be used automatically identifies discrepancies, including:
Geometric Deviations: The wall is leaning, is not at the correct height, or is deviating from the intended printing path.
Surface Defects: The presence of cracks, bulges, slumps, or excessive roughness.
Positional Errors: An embedded conduit is not at the specified location/ orientation.
Obstacles: An unexpected object is detected in the upcoming printing path.
   A similar “digital twin” can be constructed for the device to work alongside the as-built model to enable real-time tracking of the model. Data collected during the process will allow future analysis and iterations to improve upon flaws, and or irregularities form the ‘expected’ as-designed model.

The corrective commands can be transmitted from the inspection system's processing unit to the main device controller via an internal, high-speed communication bus, such as a Controller Area Network (CAN) bus, RS485/232 or industrial Ethernet. This closes the feedback loop, allowing for immediate and autonomous adjustments to the printing process.

For example, if a geometric path deviation is detected, a command is sent to the locomotion system to adjust the speeds of individual wheels to steer the device back onto the correct path. If a surface slump is detected, a command may be sent to the extruder to slightly decrease the material flow rate. If the thermal camera indicates that a section is curing too slowly, the controller may pause the printing of the next layer in that area. If a critical obstacle is detected, the system will command a complete halt of all movement until the obstacle is cleared.

As noted above, the sensors of the suite may be mounted in various locations on the translational slipform device to optimize their function. LiDAR and environmental cameras are typically mounted high on the chassis for a clear, unobstructed view. Surface scanners and thermal cameras may be mounted on articulated arms that position them at an optimal angle and distance from the wall surface. Sub-surface sensors may be located near the base of the device to scan the most recently completed layers. To ensure durability in a harsh construction environment, all sensors can be enclosed in rugged, IP-rated (Ingress Protection) housings to protect against dust and moisture. These mounts may incorporate vibration-dampening elements, such as elastomeric bushings or floating gimbals, and may be designed as modular, quick-change units (e.g., using magnetic or snap-fit interfaces) to allow for rapid field replacement and servicing.

The entire inspection system, or a portion thereof, can be housed on the printing device or on a separate, ancillary robotic device (“inspection rover”). The inspection rover can be a smaller, highly mobile robot that is wirelessly connected to the main printing device 6700. The inspection rover can be programmed to follow the main device along the printing path, performing detailed scans of the layers that have just been printed and have had some time to set. This decoupling offers several advantages. For example, it removes the weight and computational load of the full sensor suite from the main printer, it allows for scanning without interfering with the active extrusion process, and it enables the use of contact-based sensors that would not be feasible on the main device. The main printer device 6700 and the inspection rover can continuously share their precise location data to coordinate their movements and to ensure that all sensor data is integrated into a single, unified digital model of the structure.

The printing devices described above can be equipped with the visualization system to accurately assess the following aspects of the printing process:
Printing path and associated deviations from the programmed printing path
Obstacles that may be in the print path or present as future obstructions to the print path
Assessment of material characteristics for the material being printed, including but not limited to cure time, setting rate, off gassing, emissivity and absorptivity, etc.
Assessment of position of routed electrical harnessing
Assessment of position of routed plumbing (PEX-A, PEX-B, PEX-C), CPVC, Flexible copper tubing,

More specific examples of Imaging and vision techniques that can be utilized to achieve detection of the items above include:
UWB (ultra-wideband) radar (hundreds of MHz to a few GHz signal frequency) or mmWave imaging (60-77 GHz) detection devices, with SAR processing or multi-static array implementation to refine imaging
UWB tags can be placed on electrical wire and plumbing to assist with accurate mapping. BLE (Bluetooth low energy) beacons can also be placed on the electrical wiring and plumbing to this effect.
LiDAR (light detection and ranging) devices to map out a point cloud of what's been printed, wiring and plumbing that's routed, and any obstacles that may be detected
Photogrammetry to take multiple photos from different angles via a high-resolution camera system (or multiple cameras mounted to the undercarriage of the device), with the data then being post-processed to create a point cloud.
Light scanners that triangulate depth based on reflections for printed walls, obstructions, plumbing, wiring, etc.
SLAM (Simultaneous Localization and Mapping) coupled with depth cameras to reconstruct wire and plumbing paths as the device prints.
Vision and AR devices that can trace edges for printed walls, obstructions, wiring, plumbing, etc. and record polylines in the environment to create a 3D file

In some implementations, sensors can be installed on the translational slipform device and/or a separate, follow-on robotic device with its own dedicated power supply, locomotion system, and sensors to perform mapping while articulating and moving within or on the wall layer that's actively being printed or already printed/deposited layers. As noted above, a separate, dedicated visualization robotic device can be used for detection. Such an implementation can include a sensing device following behind the primary printing device (wherein the primary device does not require sensors). Separate devices that perform the various separate imaging or visualization techniques noted above may be used in conjunction with each other and integrated into the specified main printing device, a dedicated separate follow-on robotic device, or a different separate robotic device that has another dedicated task (e.g., inserting insulation into the wall cavities). These devices can all have capability of communicating with each other to know their respective positions in space and ensure that tasks are optimized and performed efficiently, and that there are no potential conflicts in locomotion path that can result in damage to the devices. These devices may be tethered via a wired connection (ethernet, serial, USB, SPI, I²C) to achieve this communication, or communicate wirelessly via Wi-fi, Bluetooth, Z-wave, Custom radio frequency (RF) modules, or via 4G/5 g/LTE modules. Infrared links, visible light communication, or QR code/visual markers may also be used to communicate data.

Communication and control wiring may be implemented using industrial-grade cables capable of reliable operation in environments characterized by abrasive particulate matter, moisture exposure, vibration, and electromagnetic interference generated by motors and high-current switching devices. Such cables may include ruggedized jackets formed from materials such as polyurethane (PUR), thermoplastic elastomer (TPE), or heavy-duty polyvinyl chloride (PVC), and may further incorporate shielding and twisted conductor pairs to maintain signal integrity. Communication between subsystems may utilize Category-rated Ethernet cables (e.g., CAT-5e, CAT-6, or CAT-6A) for Ethernet-based protocols such as Ethernet/IP or PROFINET, shielded twisted-pair RS-485 communication cables suitable for serial protocols including Modbus-RTU, ISO-11898 compliant CAN bus cables for Controller Area Network (CAN), PROFIBUS-DP Type-A shielded cables for fieldbus communication, and industrial sensor/actuator cables with M8 or M12 connectors for device-level networking protocols such as IO-Link. In addition to communication wiring, electrical power for actuators, pumps, sensors, and control electronics may be delivered through industrial power cables, including but not limited to multi-conductor control cables, tray-rated (TC or TC-ER) power cables, and armored power cables such as MC (Metal Clad) or TECK-type cables, which provide mechanical protection and environmental resistance. These power and communication cables may be routed in proximity to concrete delivery equipment while maintaining reliable electrical performance using abrasion-resistant outer jackets, shielding, and construction suitable for industrial automation environments.

As noted above, the translational slipform device can be equipped with an integrated and automated system for installing reinforcing members within the printed walls of a structure. This feature improves the capability of the slipform device to construct load-bearing structural elements that meet or exceed conventional building standards. In the implementations described below, the slipform device includes a reinforcement element installation mechanism and a pre-tensioning mechanism, which can work in a coordinated manner.

The reinforcement installation mechanism is responsible for the precise placement of reinforcing members, also referred to as tension members, within the layers of print material during the construction process. Its function is to create an embedded (internal and/or external) structural skeleton that can subsequently be placed under tension or otherwise strengthen the structure.

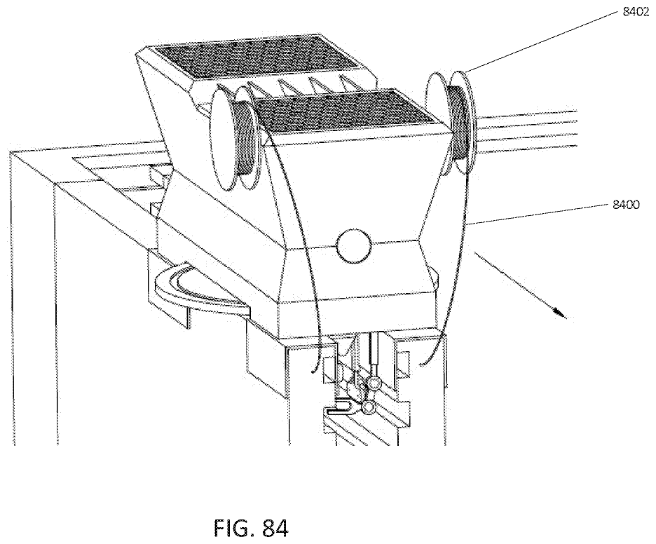

In one implementation, the mechanism is configured to install a continuous reinforcing material, such as a high-tensile strength carbon fiber tow, a basalt fiber tape, a polymer composite cable, or a braided steel wire. As shown in FIG. 84, this continuous material 8400 can be stored on one or more motorized, computer-controlled spool assemblies 8402 mounted either on the main chassis of the translational slipform device or on an associated separate material supply cart. For example, the material supply cart on a separate chassis that is tethered to the main chassis. The spool assembly can include a tension-controlled drive to prevent slack and ensure a consistent feed rate and/or tension. From the spool, the material can pass through a series of low-friction ceramic or polished metal guides (note shown) to an insertion head (also not shown). The insertion head, which may be a vibratory tool designed to locally fluidize, or otherwise soften, the print material for easier penetration, can be positioned to guide the reinforcing member to a precise depth and lateral position within the uncured, or partially cured, print material as the print material fills a formwork chamber of the extruder. The reinforcing member can be introduced into the form prior to, during, or after the print material in introduced into the form.

Alternatively, the installation mechanism can be configured to install discrete, modular reinforcing segments, similar to implementations described above. These segments may be, for example, galvanized or epoxy-coated steel rebar sections, or rigid glass-fiber reinforced polymer (GFRP) rods. The segments can be stored in an onboard magazine or hopper. A dispensing mechanism, such as a servo-driven conveyor or a pneumatic shuttle, feeds individual segments to the insertion head. In a particularly advanced embodiment for creating vertical reinforcement. The modular segments can include interlocking ends, such as a bell-and-spigot design, a threaded male/female connection, or a bayonet-style twist-lock feature. The installation mechanism inserts a new segment into the fresh print material of the current layer such that its lower end engages and locks with the upper end of a previously installed segment in the layer below, thus forming a continuous, mechanically-coupled vertical tension rod that extends through multiple printed layers.

In yet another implementation, the installation mechanism is configured for in material that has already substantially or fully cured. The mechanism includes a drilling or coring module, equipped with a diamond-tipped or carbide drill bit, that excavates a channel or hole at a pre-mapped location. Following excavation, the insertion head guides the reinforcing member into the newly created channel, which may then be back-filled with a high-strength grout or epoxy by a separate filling mechanism to ensure a solid bond.

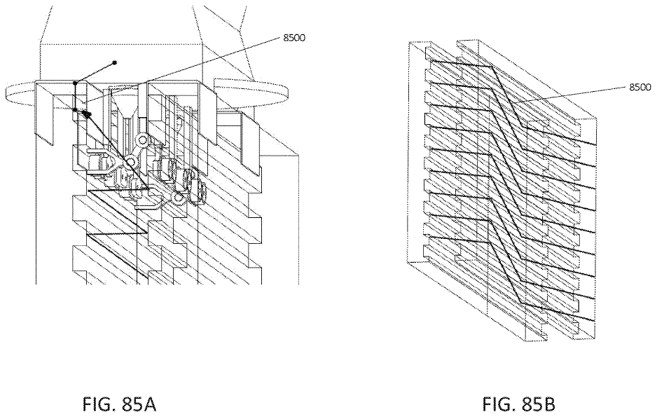

As shown in FIGS. 85A and 85B, to create complex reinforcement patterns, such as a diagonal truss network for enhanced strength, the entire reinforcement installation mechanism may be mounted on a multi-axis robotic armature 8500. This allows the insertion head to move vertically and laterally between the inner and outer wythes during, or after, a single printing pass, laying down the reinforcing material in a precise, engineered pattern (FIG. 85B). At the conclusion of an installation pass, if a continuous material is used, an integrated cutting mechanism can be used to sever the material. The cutting mechanism can be selected based on the reinforcement type; for instance, a high-speed abrasive saw wheel for steel cables, automated carbide shears for GFRP rods, or a focused laser cutter for polymer-based fibers.

Following, or during, the installation of a reinforcing member, a pre-tensioning mechanism can apply a controlled tensile force to place the reinforcing member in tension and the surrounding print material in compression. This can serve to increase the flexural strength of the wall and resistance to cracking under load. The disclosed implementations accomplish pre-tensioning using various technical methods and structures.

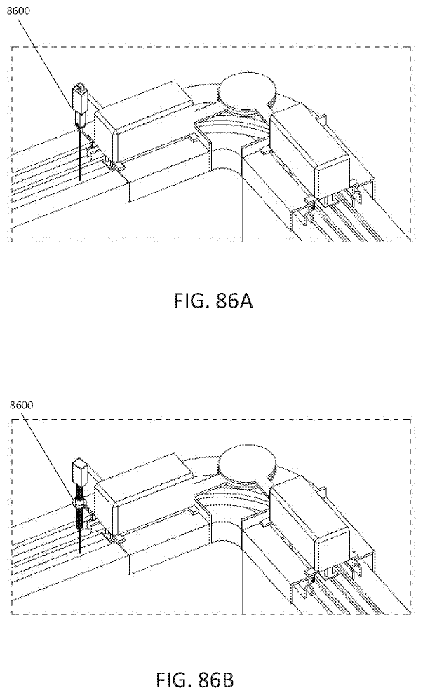

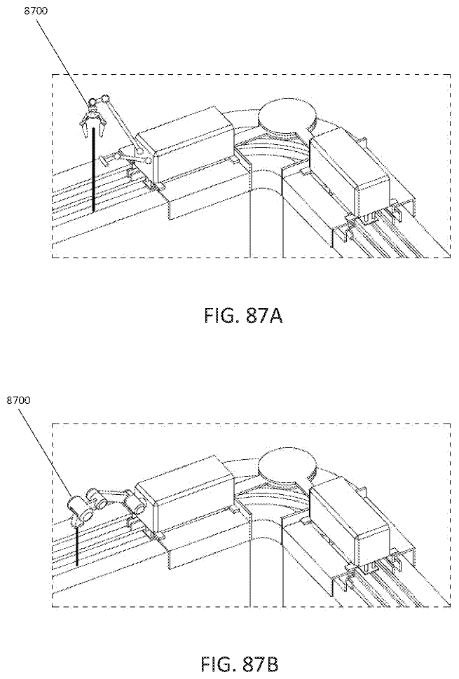

In one implementation illustrated in FIGS. 86A and 86B, the pre-tensioning mechanism includes a mechanical actuator system 8600 which may be of a ball screw, roller screw, or hydraulic cylinder type. In a typical operational sequence, after a reinforcing member is inserted and anchored at its distal end, the proximal end is engaged by a gripper coupled to the linear actuator, as shown in FIG. 86A. The system controller then commands the actuator to retract, stretching the reinforcing member. A sensor (such as a strain gauge on the actuator) can provide real-time feedback on the applied force or displacement. Once the target pre-tensioning value is reached, a secondary mechanism activates an anchor or cap—via mechanical crimping, welding, or a wedge-lock system—to secure the member's proximal end and lock in the tensile force.

In another implementation shown in FIG. 86B, a threaded engagement mechanism is utilized. In this configuration, actuator system 8600 included a threaded rod or connector fitted on the end of the reinforcing member. The pre-tensioning mechanism includes a servo motor with a collet designed to engage a corresponding nut or turnbuckle. The method involves rotating the nut with the servo motor, which progressively pulls on the threaded member. A torque sensor on the motor can be used to provide an initial estimate of the induced tension, while a primary sensor, such as an inline load cell, can be used to provide a direct, calibrated force measurement. The controller uses this primary feedback to precisely regulate the motor's rotation until the target pre-stress is achieved.

A further implementation utilizes a gripper and reaction frame system as pre tensioning mechanism 8700 as shown in FIGS. 87A and 87B. This mechanism is particularly suited for post-tensioning operations. It can include a hydraulic or pneumatic gripper assembly that securely clamps onto an exposed end of the reinforcing member. A reaction frame, featuring wide, polymer-padded feet to distribute force and prevent damage, can be deployed to brace firmly against the surface of the already-hardened printed wall. The gripper assembly then retracts, pulling against the reaction frame and stretching the member. This method allows for tensioning to be performed after the material has been partially or fully cured.

In another implementation, the pre-tensioning mechanism 8700 operates on the principle of thermal expansion. This is suited for use with, for example, metallic reinforcing members or other materials that exhibit significant thermal expansion. The mechanism can include a non-contact heating element (such as an IR or induction heating element) or a direct-contact resistive heating element. The controller calculates the required temperature increase based on the member's known coefficient of thermal expansion and the desired final pre-stress value. The pre-tensioning method involves heating the member to this target temperature thereby causing reinforcing member to elongate. While in this expanded state, both ends of the member are rigidly anchored to the cured material. As the member subsequently cools to ambient temperature, its natural thermal contraction is resisted by the anchors, resulting in a highly predictable and uniform tensile force throughout its length.

Across all these implementations, the pre-tensioning process can be controlled by a sophisticated closed-loop control system. The controller continuously compares the measured tension from the sensor suite (which may include load cells, strain gauges, or laser-based extensometers) to the target setpoint stored in the print job file. To account for potential creep or relaxation in the curing print material, the controller may apply the tension in multiple stages—for example, applying 75% of the target force, holding for a defined period while monitoring for stabilization, and then incrementing to the final 100% value. All data associated with the tensioning of each member (including a unique identifier, location, target force, final measured force, and time-series data of the tensioning process) can be logged to create a comprehensive quality assurance and structural compliance report for the finished building.

Mechanisms for sensing/measuring tension of the tension members during tension operations includes inline load cells or tension transducers that measure axial force applied, strain gauges on the rods or incorporated into anchors that can measure axial strain, which can then be converted into force based on known mechanical properties for the material, current or torque sensing on the motor, with calibration via testing to assess force applied, potentiometers to assess the amount of displacement directly on the tension load bearing member, laser/optical distance sensor to assess the amount of elongation of the tension load bearing member, which is then used to assess amount of tension based on the stress/strain relationship of the material, and inertial measurement unit or accelerometer to detect any releases of energy or jerks in case of a failure event.

Tenison may be applied to the members in small increments (with each step being 20% or less of target deformation). Tension sensing can be performed at each step to measure creep/relaxation in the material and provide a more robust pre-tensioning result. Sensing tension in the tension members with load applied after the tension load bearing member has been locked in place allows for final verification to ensure the correct amount of tension was applied following the locking step.

All tensioning data can be stored onboard the printing device, an insertion device and/or sent to a separate data collection device (local or cloud-based) to be used in assessment of the final quality of the build. Such data can be includes in an automated or manually assembled report that can be assessed in view of local building codes in the jurisdiction where the building is being constructed, thereby demonstrating code compliance.

Flexible tensioning cable can be utilized instead of rigid tension load bearing members that are the direct length, cut to length, or composed of modularly installed pieces. For example, for vertical tension load bearing installation, a vertical hole can be formed (as described above) at regular increments in the inner section of the wall, an outer section of the wall, or both, that allows for placement of the cabling system. These holes may be created during the printing of each layer through a volume displacement cylinder (or other cross-section) that displaces material while the form is being filled. This displacement mechanism can be actuated with hydraulics, pneumatics, linear actuators, steppers, brushed or brushless motors, or other means to create a hole in the cross-section at a specific location during the print operation. Alternatively, the holes cab be formed by boring or drilling after curing of the material used for printing.

Alignment with a specific hole section may be achieved by sensing via optical sensing methods (LiDAR (spinning or solid state), structured light or active stereo sensing methods, depth cameras, photogrammetry methods, multi-view stereo, RGB imaging and edge detection, or via borescope or endoscope cameras. Ground-penetrating radar, ultrasonic pulse echo, impact echo, acoustic or sonic tomography, infrared thermography, microwave or terahertz imaging, or tactile means such as probing with force sensing or ultrasonic contact transducers.

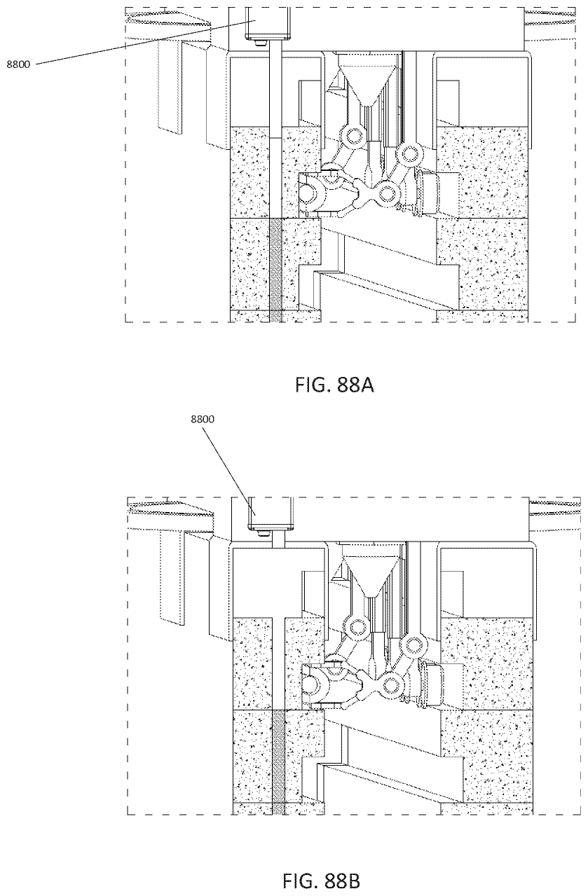

As an example, as shown in FIGS. 88A and 88B, the holes can be formed by controlling material flow to commence at the specific section where the hole is being created after a volume displacement mechanism is deployed into the hole beneath the layer. FIG. 12 depicts an embodiment showing a volume displacement cylinder being deployed, with the hole detected via a depth camera installed. Material can be deposited into the chamber while a piston of the volume displacement cylinder 880 is deployed into the top of the chamber, as shown in FIG. 88A. The piston can be pulled upwards and removed from the chamber after the material has been deposited, as shown in FIG. 88B.

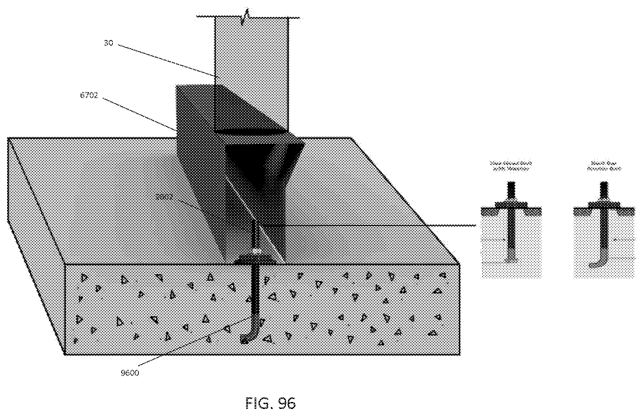

An anchor element 9600 can be installed at the basement/foundation to provide the base support for the reinforcement assembly as shown in FIG. 96. As shown in the at the right of FIG. 96, the anchor element 9600 can be of various configurations including a hex head bolt with a washer and nut and/or a bent bar bolt with a washer and nut. The anchor element 9600 can have a cylindrical receiving member 9602 defined on a top portion thereof that extends above a top surface of the basement/foundation layer. Before concrete is deposited at a previously calculated reinforcement location (determined by use of a sonar sensor or other sensors described herein, for example), a retractable rod can be extended downward through feedline 30 or another channel into the formwork area inside formwork structure 6702. The retractable rod can be placed into a coupling relationship with receiving member 9602 of the anchor element 9600.

Concrete can then be printed around the rod, creating a vertical hole in the first printed layer. Once the layer section is completed, the rod can be retracted upward, and the printer can continue onto the next section to repeat the process.

When the printer reaches the next layer above, any of the sensing methods noted herein can detect alignment with the previously created hole. The rod can be extended downward through the new layer and into the existing void below, to prevent accidental concrete backfill. This also maintains continuous vertical alignment of the void. Concrete is then deposited around the rod again, forming the second wall layer.

Over multiple layers, the repeated rod insertion creates a continuous vertical channel through the printed structure. The void remains open because the rod temporarily occupies the current, and previous, holes during each layer deposition.

At a predetermined height, a reinforcing element such as a steel bar may be inserted into the vertical channel formed during the printing process. In some implementations, the reinforcing element may be placed using an automated insertion mechanism integrated with the printing system. In other implementations, insertion may be performed by a separate robotic or automated placement system.

After the reinforcing element is placed, a secondary deposition system can fill the channel with grout (or another substrate) to bond the outer surface of the reinforcing element to the surrounding printed concrete, allowing stresses to transfer and completing the reinforcement system.

Once the channel is filled, the printer follows and continues depositing layers. Following grout placement, the reinforcement assembly may be subjected to post-tensioning, and the system can anchored at the required location, thereby providing additional structural capacity and stability to the constructed wall.

The retractable system continues forming additional reinforcement channels at other required locations.

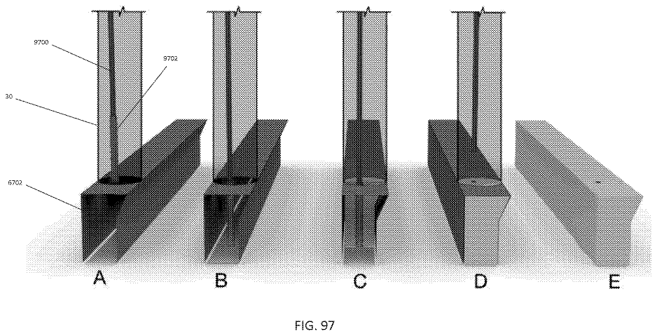

FIG. 97 illustrates an example of reinforcement element installation in accordance with one implementation. In this example, a footing dowel or J anchor element can be embedded within the foundation slab, as the anchor element, prior to wall construction. The anchor element extends upward from the slab and serves as the initial anchorage point for the reinforcement assembly. FIG. 97 shows the various steps of creation of the first printed layer. As shown at A, the retractable rod 9700 can have a a protective sleeve 9702 thereon as it is inserted through feedline 30, or another channel, thereby preventing contact with fresh concrete prior to deployment. As shown at B, the retractable rod is extended downward into the formwork area at the predetermined reinforcement location before concrete deposition begins. As shown at C, concrete is deposited around the deployed rod, forming a vertical void within the first printed concrete layer. As shown at D, the rod is retracted upward after the layer section is completed, leaving the sleeve in the concrete to define a void therein.

As shown at E, the printed wythe has a preserved vertical void within the completed first printed layer.

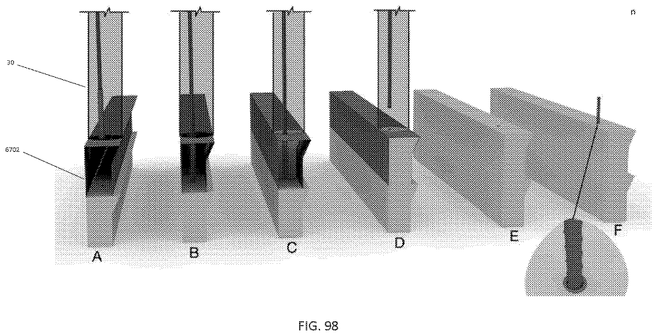

FIG. 98 illustrates the reinforcement placement process during construction of a subsequent wall layer, such as a second layer, in accordance with this implementation. In FIG. 98, A illustrates the sensor or positioning system detecting alignment between the printer and the void created in the previous layer. B illustrates the retractable rod extending through the current layer and into the void below to maintain alignment and prevent concrete backfill. C illustrates concrete being deposited around the rod while preserving the vertical channel formed in the previous layer. illustrates the rod retracting upward after the second layer section is completed. E illustrates the formation of a continuous vertical void between layers as the process repeats to achieve the required structural height. F illustrates the insertion of a reinforcing bar into the completed vertical channel using a secondary automated or robotic placement mechanism prior to grouting and continued printing.

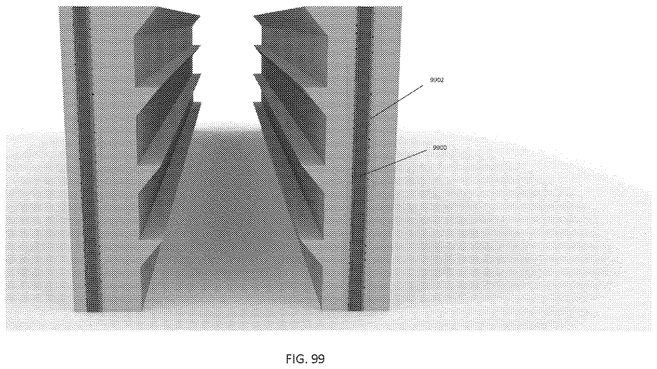

FIG. 99 shows a representative wall section in which a continuous configured reinforcing bar 9900 runs through successive wall wythes within an internal cavity and having grouting 9902 between the outer surface of the reinforcing bar and the hole formed in the wythes.

In other implementations, the sleeve can be omitted and the retractable rod can be left in place long enough for the concrete to cure at least partially to a point in which the hole will be preserved without requiring the sleeve

Alternatively, holes can be created through excavation of material already deposited. Excavation mechanisms can be internal to the formwork chamber or external of the device to form a hole by removing material before the primary wall material has fully set. This may be achieved, for example, via a mechanism that installs one or more sleeves and withdraws the sleeve, with mechanical force and friction causing a material core inside the sleeve to be removed by sleeve withdrawal. Alternatively, a rotary coring tube, a vibratory corer, a vacuum hollow coring tube that sucks material through the tube, an auger drill, a will or cable cutting loop, an oscillating knife or ultrasonic cutter, or a mandrel and jut flush within a tube installed in the fresh material can be used to form holes.

The removed material may be discarded or placed back in the primary material reservoir on the device to be repurposed using vacuum suction methods, soft robotic suction gripper or a gripper on an armature, or other means. FIG. 13 depicts a hollow vacuum coring setup that removes the deposited material at the appropriate location and sucks the removed material into the primary material reservoir.

Embodiments also exist where a sacrificial and/or removable core piece is placed before material is deposited, with this material then removed once the layer is complete and the robotic devices is printing the next layer, or when the entire wall section at full floor height is complete. These pieces may be made of material that is non-stick or coated for ease of removal, such as metals like aluminum and steel that are smooth or have Teflon/PTFE, epoxy, or oil release coating, and then these cores may be easily removed once the layer is finished. The removed core can be either brought back into a core storage reservoir, or lifted up to create the next layer's hole. Other materials may be utilized to achieve this purpose as well, including plastics or composites (High-density polyethylene (HDPE), ultra-high-molecular-weight polyethylene (UHMWPE), Acrylonitrile Butadiene Styrene (ABS), or fiberglass).

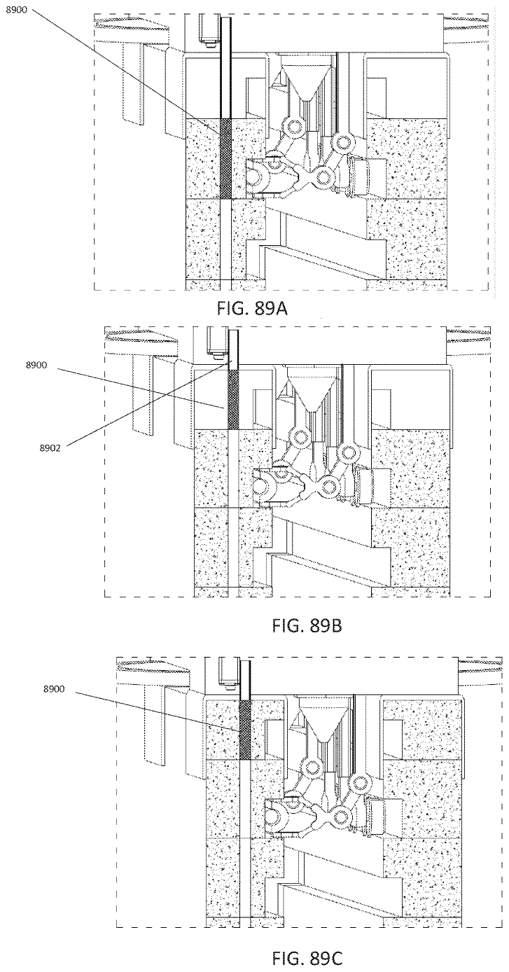

FIGS. 89A, 89B and 89C depict an embodiment where this core piece is lifted up and utilized to create the hole at the next layer. A benefit of this approach is alignment of the hole throughout the wall section. FIG. 89A shows a core piece 8900 disposed in a printed layer to define a hole in the printed layer. FIG. 89B shows the core piece 8900 lifted up to a next layer to be printed (through suction, mechanical, magnetic, or other mechanisms). A guide tube 8902, or other guide mechanism, can be used to position the core piece in the layer to be printed. FIG. 89C shows the core piece 8900 after being lifted up and guided into place in the new layer to be printed on top of the last layer.

Further, sacrificial inserts may also be utilized as the core piece. Such inserts can be left in place and dissolved when the next layer is reached or when the entire wall section is constructed. These may be composed of water soluble materials, such as compressed salt (NaCl), compressed sucrose or dextrose, or polyvinyl alcohol (PVA) plastics. Alkali-sensitive materials, such as foamed aluminum or magnesium alloy, may be used that react with alkaline concrete and weaken over time, and with a water flush, can be removed from the wall section. Ice inserts may also be used, which melt away after the layer is deposited.

At the foundation level, anchors may be placed in the foundation before the foundation fully sets, or after the foundation has set via mechanical insertion methods, to allow for cabling to couple to the foundation. This may be achieved via anchor bolts with eyelets or U-bolts that embedded in the foundation concrete, with loops for cable attachment, via expansion anchors that are drilled into cured concrete and then expand to adequately fasten to the foundation, via chemical, epoxy, or other adhesive means anchors that have cabling inserted into a hole in the foundation and then filled with these adhesive materials (including the primary foundation material as an option) to secure the cable in place, or via cast-in anchor plates (made of steel or other structural material) that is embedded into foundation.

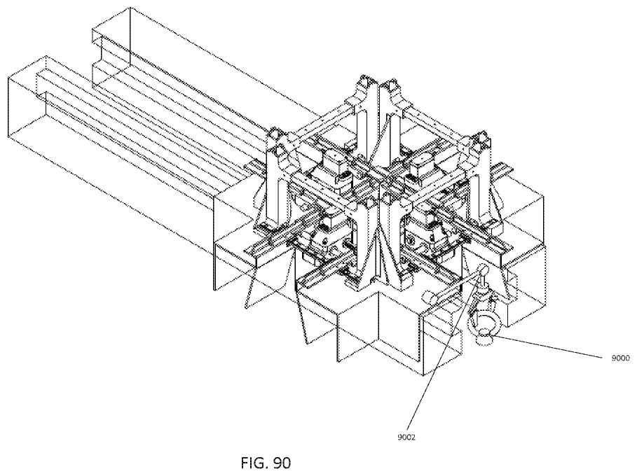

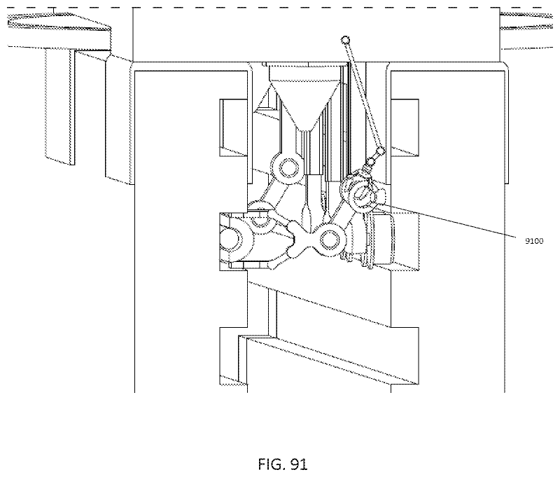

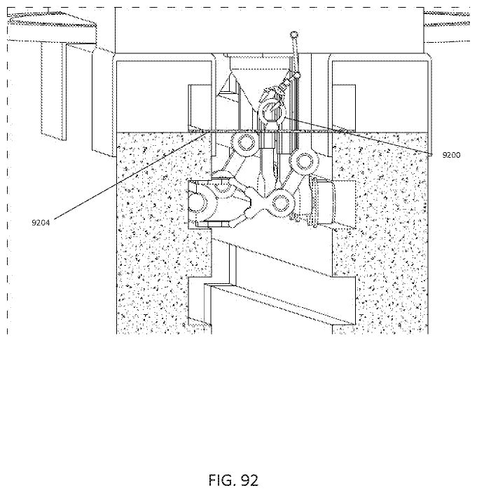

As shown in FIG. 90, anchors may be placed before the foundation is fully cured and set, after the foundation is set but before the wall is printed by the translational slip form device, after any amount of layers are printed, or following completion of the wall section. These anchors may be installed manually, on the printing device, or via a separate, dedicated robotic device for installing these anchors. Anchors 9000, such as anchor bolts with eyelets can be installed in set concrete via a robotic arm 9002 or other mechanism on the translational slipform device during first layer printing operations. It is also possible to install the anchors where holes will be created in the inner, outer, or both sections of the wall being printed, or in the center cavity of the wall being printed, or some combination thereof. Anchors may also be placed at any height within the wall during printing operations. For example, anchors can be placed within the hole sections on the inner, outer, or both sections of the wall, or spanning between the inner and outer sections of the wall. FIG. 91 illustrates an anchor 9110 being installed on an inner surface of a wythe of a printed wall. FIG. 92 illustrates an eyehook anchor 9200 with a cast-in anchor plate 9204 being installed between the inner and outer wythes of wall, bridging the cavity gap between the inner and outer wall wythes.

In some implementations, cabling can be fed down to the installed anchor, with the end of the cabling being such that is fastens to the anchor via a hook that hooks to the U-bolt or eyelet, via a magnetic coupling system, via an adhesive means, via a wedge that wedges into the anchor, or via other means. The cable can then be pulled taught and initially fed via various methods.

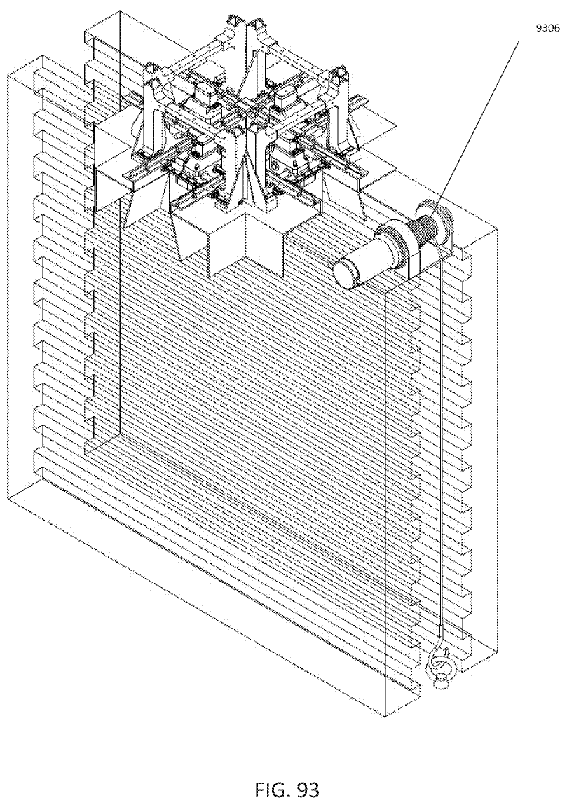

For example, as shown in FIG. 93, a winch or capstan drive 9306 can be utilized to pull a cable taught to the appropriate amount of tension, calculated via displacement with the mechanical properties of the cable known, or via a sensor on the spool drum that senses the amount of force being pulled by the winch system. The spool/drum for the tension cables can be driven via a motor (brushed or brushless), BLDC or servo, and may or may not have a gearbox. An encoder may be used for the spool/drum to sense the amount of material that has been fed. Once an appropriate amount of tension has been applied, the cable may be locked into place via mechanical means. A hook on the cable can be lowered to the anchor, engaged with the anchor through movement of the printer or a robot arm and then the tension can be applied to the cable.

As another example, a wedge and anchor head can be used to pull the cable through a wedge anchor, with the wedge set to lock under load. The cable can be inserted through the anchor head, and a wedge can be driven to lock the cable into place. A similar spool/drum winch may be used in tandem with this method, or the robotic device itself may move to its position vertically (in the Z direction) to apply tension to the wedge anchor system. An actuator-based cable feed and tensioning approach can be used. The cable may be capped or crimped to maintain the tension, and then cut to the appropriate length fulling capping or crimping. A collet or split-cone grip may be installed on the cable to keep it in place, a socket may be installed on the cable end via molten zinc or epoxy grout, which then sets and is larger than the hole to keep the cable in place, of the cable mat be swaged or ferrule crimped. The cable may also be bolted, have a turnbuckle and lock nut installed to more precisely adjust final tension, or any combination of methods to install the cable. Various actuators can be used to thread the cable through various loops and or hooks.

Anchors may also be installed throughout the inner cavity of the wall being printed to allow for cabling to be routed through 3D space to create a tensioned cable system that enhances the structural properties of the final structure, allowing the structure to more adequately deal with shear and tensile loading. These anchors would be installed in a similar fashion to the beginning anchors described above, with the anchors installed at pre-mapped positions such that when cabling is routed through the anchors, the appropriate cable network is created to pre-tension the walls and absorb the appropriate amount of loads in various nominal and off-nominal loading scenarios. Cables may be routed through the appropriate network of anchors using various methods.

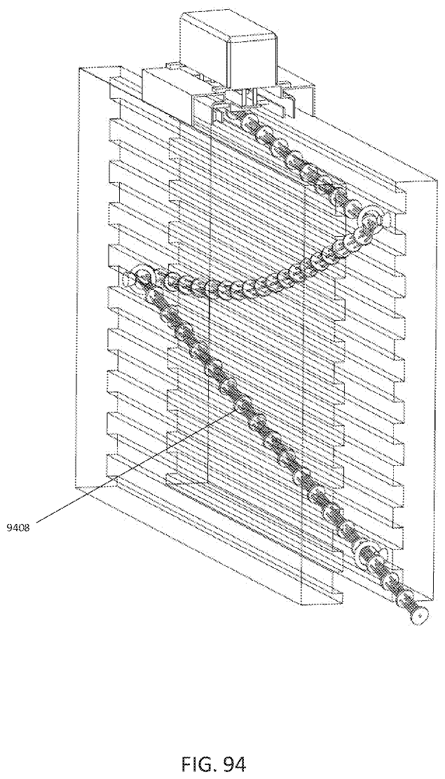

In one example shown in FIG. 94, telescopic feeding via an extendable insertion guide 9408 is used. The insertion guide 9408 can be a tube snaked through the appropriate holes, and the cabling can be fed through the tubing and coupling to the foundation or beginning anchor. Once the cabling is in place, the tubing can be removed. In another example, the extendible insertion guide 904 can be a flexible robotic arm or mechanical tendon driven guide that can maneuver the cable through the appropriate inner wall anchors and couples the cable to the foundation or beginning anchor.

The end effector of robotic arms or manipulators described above, or the undercarriage of the device, may be equipped with sensors as described for the hole sensing section above to sense the location of anchors for cable routing applications. Diagonal tension members can also be installed with the insertion devices adjusted for angular installation and tension members installed when the primary wall material is still setting. Alternative, mechanical installation methods described above can also be used.

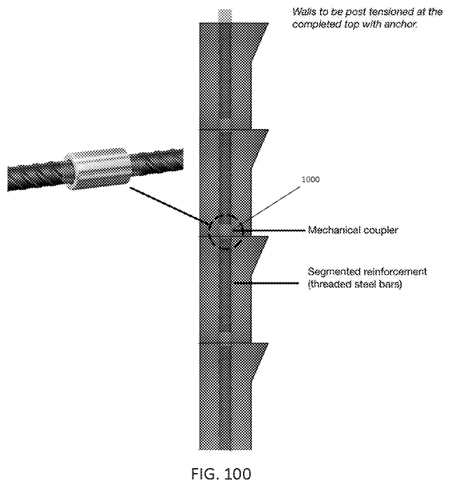

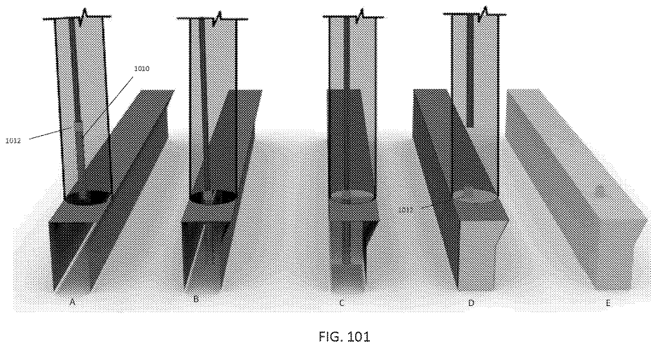

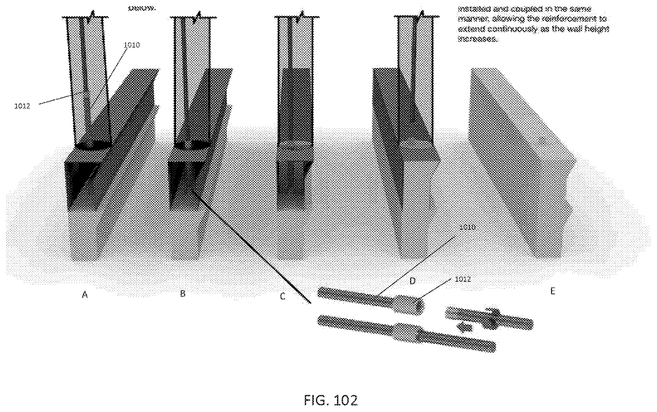

In other implementations sleeves and or the reinforcing elements can include couplings 1000, such as pressure fit or threaded couplings to allow connection of element segments into a single reinforcing element, as shown in FIG. 100. Such a process is illustrated in FIGS. 101 and 102.

Initially, an anchor element is installed at the basement foundation to provide the base support for the reinforcement assembly. As the TSF system progresses and constructs the wall layer by layer, vertical holes or channels are formed within the wall section at predetermined reinforcement locations. As shown in FIG. 101 which shows printing of an initial layer, at A, a first segment of hollow steel bar (or any rigid material) is inserted into the formed opening as reinforcing segment 1010. A vertically retractable rod carries this hollow reinforcement segment and positions it within the wall section before concrete is deposited into the form. Once the hollow bar is positioned, concrete is deposited around the reinforcing segment. The rod can remain inserted during concrete deposition as shown at B and C and retracted after the surrounding material has been placed, as shown at D, preventing concrete (or other wall substrate material) from backfilling into the internal cavity of the hollow bar. The hollow bar is left in place, in direct contact with the concrete, while the coupling extends from the formed concrete as shown at E.

As shown in FIG. 102, as the wall height increases by layer, additional reinforcing segments 1010 may be placed at the same reinforcement location and connected using couplers 1012, such as mechanical couplers, magnetic couplers, adhesive couplers, or other coupling systems, forming a vertically continuous hollow reinforcement assembly. The couplers provide alignment, continuity, and structural connection between adjacent reinforcing segments 1010. Alignment of reinforcing segments 1010 may be assisted by sensing systems that detect previously formed voids or reinforcement locations, ensuring accurate placement as the structure is built layer by layer. The hollow configuration preserves an internal cavity through the reinforcement assembly, allowing later insertion of a solid reinforcing bar.

This process of inserting hollow reinforcing bar segments and connecting them with couplers can continue at predetermined segment heights as the system constructs additional layers of the wall. The hollow bar assembly therefore grows progressively with the structure until the desired or targeted structural height is reached.

After the reinforcement assembly reaches the required height, a solid steel bar (or other material capable of carrying tension loads) can be inserted inside the continuous hollow bar system. Subsequently, the internal cavity between the hollow bar and solid bar can be filled with grout, which improves bonding, stiffness, and load transfer within the reinforcement system.

Following grout placement, the reinforcement assembly may be subjected to post-tensioning, and the system is anchored at the required location, thereby providing additional structural capacity and stability to the constructed wall.

This method enables progressive reinforcement installation within a layered construction system, ensuring structural continuity, improved load transfer, and effective integration of reinforcement elements within the wall structure.

As noted above, FIG. 97 illustrates the sequential process of placing a hollow reinforcing element 9702 within the wall during the first layer printing stage.

At A, a retractable rod retrieves a hollow steel reinforcing bar from a storage location and positions it within the material deposition tube of the TSF construction system.

The rod is enclosed within the hollow reinforcing element, which serves as a protective sleeve that prevents interaction between the rod and the surrounding concrete during placement. The hollow reinforcing bar element is transported by the rod to the designated reinforcement location within the wall section.

At B the hollow reinforcing element is inserted into the forming wall section prior to concrete deposition.

The hollow reinforcing element is positioned vertically within the form, while the retractable rod remains inserted through the center of the hollow reinforcing element. At this stage, the hollow reinforcing element is fixed in position while the surrounding concrete begins to be deposited.

at C, the retractable rod continues to hold the hollow reinforcing element in place as concrete is deposited around the reinforcement element. The rod maintains the alignment and vertical position of the hollow bar while preventing concrete from entering the internal cavity of the hollow reinforcement.

At D, the retractable rod is moved upward and out of the hollow reinforcing element.

After the surrounding concrete has been placed and the hollow reinforcement element is secured within the wall section, the retractable rod is fully withdrawn from the hollow bar. The rod then returns to retrieve the next reinforcement element for placement. At E, the resulting wall section is shown after removal of the retractable rod.

The hollow reinforcing element remains embedded within the wall and maintains an internal cavity or void extending vertically through the reinforcement element. This cavity allows for the later insertion of a solid reinforcing bar and the placement of grout. Thereby forming a composite reinforcement system that improves structural capacity and load transfer within the wall.

FIG. 98 illustrates the reinforcement placement process during construction of a subsequent wall layer, such as a second layer.

A of FIG. 98 shows a retractable rod mechanism that has retrieved the hollow steel reinforcing element from a storage location and positions the hollow steel reinforcing element 9702 within the material deposition tube. In certain embodiments, sensing systems, such as sonar-based sensors or similar alignment technologies, may be used to detect and align the newly placed hollow bar with the reinforcement segment positioned in the previously constructed layer.

At B the retractable rod is extended into the forming wall section prior to concrete deposition. The hollow reinforcing element is positioned vertically within the form and aligned with the hollow bar located in the lower layer. The newly placed hollow bar may be mechanically connected to the previously installed hollow bar segment using a coupler, which may optionally include a fastener to ensure secure alignment and continuity between segments.

At C, the retractable rod temporarily holds the hollow reinforcing bar in position while concrete is deposited around the reinforcement element. The rod maintains the vertical alignment of the reinforcement while preventing concrete from entering the internal cavity of the hollow bar.

At D, the retractable rod is moved upward after the surrounding concrete has been placed and the hollow reinforcing element is secured within the wall section. The rod is withdrawn from the hollow reinforcing element and may then retrieve the next reinforcement element for placement.

E shows the resulting wall configuration after placement of the hollow reinforcement segment in the subsequent layer. The hollow reinforcing element from adjacent layers form a continuous vertical cavity or void, maintained by the aligned hollow reinforcement elements embedded within the wall.

F illustrates a subsequent reinforcement stage in which a solid reinforcing bar is inserted within the internal cavity formed by the aligned hollow reinforcement segments. The gap between the solid bar and the hollow reinforcement assembly may be filled with grout, forming a composite reinforcement system. In certain embodiments, the reinforcement assembly may subsequently be anchored or subjected to post-tensioning, thereby providing structural continuity between the layers and improving load transfer within the wall.

FIG. 99 illustrates a representative wall section showing the internal cavity geometry and the placement of vertical reinforcement elements within the wall structure

FIGS. 101 and 102 show the process for an implementation in which mechanical couplers are used to join the reinforcing elements.

First, an anchor is installed at the basement foundation to provide the base support for the reinforcement assembly. As the system moves upward and constructs the wall layer by layer, reinforcement segments are inserted vertically at predetermined reinforcement locations. These segments are placed within the form prior to concrete deposition.

Unlike cavity-based methods, this approach eliminates the need to pre-form voids within the wall. Instead, the reinforcement segments are positioned during printing, allowing the concrete to flow and consolidate around the reinforcement as it is deposited. As construction progresses, additional bar segments may be installed sequentially, allowing the reinforcement element to extend vertically as the wall height increases.

Additional bar segments may be placed in the same process, and connected sequentially using mechanical couplers, allowing the reinforcement to extend vertically as the wall height increases. Alignment of the reinforcement segments may be maintained using couplers or temporary positioning mechanisms such as magnetic clamps, friction clamps, or other mechanical supports.

Additionally, sensing or tracking systems, such as sonar-based sensors, laser sensors, optical camera systems, RFID tracking systems, magnetic sensors, ground-penetrating radar, or similar detection technologies, may be used to monitor the placement and alignment of the reinforcement segments within the wall system, ensuring accurate positioning during the construction process. [Note: Methods noted in [315] and other sections above]

This process continues until the desired wall height is reached, after which the reinforcement assembly may be anchored and post-tensioned at the top according to structural requirements. This method allows solid steel bar segment reinforcement to be integrated progressively within the layered wall construction, improving structural performance while maintaining compatibility with the TSF construction process.

A of FIG. 101 illustrates the initial condition after installation of the anchor at the foundation. A threaded reinforcement bar 1010 is retrieved and positioned at a predetermined reinforcement location.

B illustrates shows the threaded reinforcement bar, with a mechanical coupler 1012 attached at its upper end, being lowered vertically into the form and positioned within the first wall layer. C illustrates the stage in which positioning mechanisms maintain the correct alignment of the reinforcement element during material deposition.

The mechanical couplers (or other positioning mechanisms such as friction clamps, or magnetic clamps), stabilize the reinforcement bar segment and maintain its vertical alignment as the surrounding concrete material is deposited.

D illustrates the placement mechanism retracting upward upon layer segment completion.

E illustrates that the first reinforcement bar segment remains embedded within the initial printed layer, leaving the coupler 1012 exposed at the top to allow connection with the next reinforcement segment.

FIG. 102 illustrates the sequential process of installing and attaching threaded steel bar reinforcement segments within the wall during the second layer printing stage.

A illustrates a sensing or positioning system detecting the alignment of the newly formed layer with the reinforcement location established in the previous layer. This system confirms the position of the embedded coupler from the previously placed reinforcement segment.

B illustrates the rod or placement mechanism extending downward into the form. The mechanism applies the required torque to engage the threaded end of the new reinforcement bar with the coupler attached to the reinforcement segment below, mechanically fastening the two bars together prior to concrete deposition.

C illustrates the stage in which concrete is deposited around the reinforcement as the placement mechanism holds the bar in its aligned position, forming the next printed layer.

D illustrates the placement mechanism retracting upward upon layer segment completion.

E illustrates the final stage of the reinforcement installation process after completion of the wall layer.

Additional reinforcement segments are connected sequentially until predetermined wall height is reached. As the wall construction progresses upward, additional solid steel bar segments may be connected to the previously installed segment using couplers, thereby extending the reinforcement element vertically through successive layers of the printed wall.

Once the required wall height or layer is completed, the reinforcement element is post-tensioned and secured at the top using an anchor element. This anchorage provides additional structural stability and ensures that the reinforcement assembly remains properly integrated within the wall system.

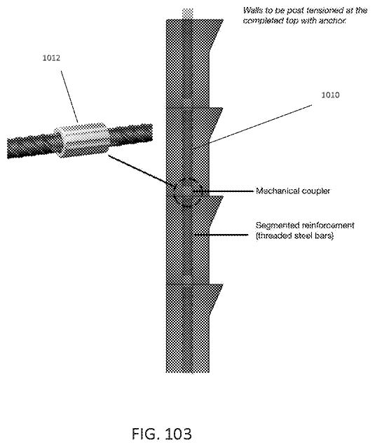

FIG. 103 shows a representative wythe section illustrating segmented threaded reinforcing elements 1010 connected by a mechanical coupler 1012 and extending through successive wall layers, with the reinforcement configured to be post-tensioned and anchored at the completed wall top.

The translational slipform device can include an automated insulation installation system which can introduce insulation material (heat insulation, sound insulation, radio frequency insulation . . . ) into the interstitial cavity that is naturally formed between the inner and outer wythes, during or after the printing process. This integration of insulation installation directly into the construction workflow eliminates a significant manual post-processing step, thereby accelerating the overall building timeline and ensuring consistent quality. The system is designed to handle a wide variety of insulation materials and can be implemented through several distinct technical embodiments.

In one disclosed implementation, the insulation installation system is configured as a nozzle-based spraying apparatus for applying two-part, expanding foam insulation. This system is particularly effective for creating a monolithic, air-tight insulation barrier that conforms perfectly to the interior surfaces of the wall cavity. The insulation installation system can include one or more pressurized reservoirs for holding the chemical components of the foam, typically an “A” component (e.g., isocyanate) and a “B” component (e.g., a polyol resin blend). These reservoirs are communicatively coupled to a proportioning pump system. The proportioning pump, which may be, for example, a pneumatic or hydraulic piston pump, is precisely controlled to draw the A and B components at a specific volumetric ratio (e.g., 1:1) and deliver them under high pressure through separate, often heated, feed lines.

The feed lines can terminate at a specialized spray nozzle assembly mounted on the translational slipform device. The nozzle assembly can be positioned to direct its spray into the wall cavity, either trailing the extruder on the same printing layer or positioned to fill the cavity of a previously completed layer below. The nozzle head itself includes a mixing chamber where the A and B components impinge upon each other at high velocity immediately before atomization and ejection. This impingement mixing ensures a thorough and rapid chemical reaction between the A and B components.

In operation, the system controller can signal the proportioning pump to deliver the components to the nozzle. As the device translates along the printing path, the nozzle can eject the reacting mixture into the cavity in an atomized form. The foam expands upon contact to fill the void, adhering to the inner surfaces of the wall wythes and creating a continuous thermal and acoustic barrier. The controller can modulate the flow rate and pressure to adjust the density and thickness of the applied foam. To prevent clogging, the nozzle assembly may further include an automated purging system, which uses a solvent or compressed air to flush the mixing chamber and nozzle tip whenever spraying is paused. Alternative examples of materials for this system include, but are not limited to, open-cell polyurethane foam, closed-cell polyurethane foam, polyisocyanurate (polyiso) spray foam, phenolic spray foam, and various bio-based or water-blown spray foam formulations.

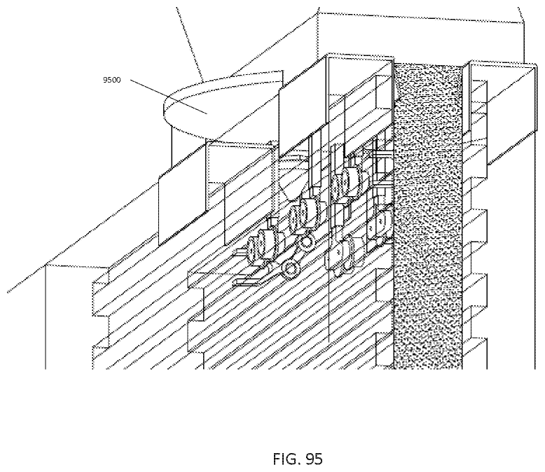

In another implementation, the insulation installation system is designed to deposit loose-fill insulation materials, as shown in FIG. 95. This approach is advantageous for its simplicity and the use of cost-effective, often recycled, insulation products. Such a system can include a hopper 9500 integrated into the chassis of the translational slipform device. The hopper 9500 can be designed to store bulk loose-fill materials, such as expandable polystyrene (EPS) beads, cellulose fibers (e.g., from recycled paper), loose fiberglass, mineral wool, perlite, or vermiculite. To prevent material bridging and ensure consistent flow, the hopper may be equipped with an internal agitation mechanism, such as a slow-moving auger or a vibratory motor.

A dispensing mechanism can be disposed at the base of the hopper. The dispensing mechanism can include a servo-actuated sliding gate, a rotary airlock, and/or a trapdoor. This mechanism can be positioned directly over the wall cavity. In operation, the system controller can activate the dispensing mechanism to release a controlled volume of the loose-fill material, allowing it to fall under gravity into the cavity below. To facilitate even distribution and settling, especially in wider cavities, the system may further include a low-pressure blower or air-assist system that directs a gentle stream of air into the cavity along with the insulation material. Level sensors, such as ultrasonic or infrared proximity sensors, may be positioned to monitor the fill level within the cavity and signal the terminated activation of the dispenser once the desired height is reached.

For applications requiring the installation of pre-formed insulation panels or batts, implementations of the insulation installation system can include a robotic manipulator. Such an insulation installation system can include a multi-axis robotic arm mounted on the device, equipped with a specialized end-effector. The end-effector may be a vacuum gripper with multiple suction cups for handling rigid foam panels (e.g., extruded polystyrene (XPS) or polyisocyanurate boards) or a mechanical clamp with padded fingers for grasping flexible batts of fiberglass or mineral wool.

The rigid panels or batts can be stored in a vertical or horizontal magazine rack on the printing device. In a typical operational cycle, the robotic arm can move to the magazine, acquire a single panel or batt with its end-effector, and then maneuver to a position above the wall cavity. Using feedback from vision systems and position sensors, the arm can precisely lower the insulation piece into the cavity, ensuring a snug fit between the inner and outer walls. For continuous installation, the arm may be programmed to place panels in an interlocking or staggered pattern to minimize thermal bridging at the seams.

In another implementation, the insulation system can be configured to create a superior thermal barrier by modifying the gaseous environment within the sealed wall cavity. For a vacuum insulation implementation, the system can include capping layers automatically or manually places along the top and bottom of the cavity formed by the wythes to form a hermetically sealed cavity. The insulation installation system in this implementation can include a vacuum pump connected via a port and valve system to the cavity. After a wall section is fully printed and sealed, the controller can activate the vacuum pump to evacuate air from the cavity. High-precision pressure transducers can monitor the internal pressure, signaling the controller to close the valve and shut off the pump once a target pressure level is achieved. This leaves a vacuum or low pressure within the cavity, which dramatically reduces heat transfer by convection and conduction. Prior to evacuation, a porous filler material may be introduced to prevent the walls from collapsing under atmospheric pressure.

Alternatively, for an inert gas-filled implementation, the system can use a similar port and valve configuration connected to a pressurized tank of an inert, low-conductivity gas, such as Argon, Krypton, or Xenon. In this method, the system first purges the air from the cavity and then back-fills it with the inert gas to a specified pressure. The lower thermal conductivity of the inert gas compared to air provides an enhanced insulation value.

In another implementation, the system insulation installation system can be designed to facilitate the growth of mycelium (the root structure of fungi) as an organic, in-situ insulation. For example, the installation mechanism can introduce a growth medium or substrate—such as a mixture of sawdust, hemp hurd, or other agricultural waste—into the wall cavity. This substrate can be pre-inoculated with, for example, mycelium spores. The mechanical mechanism can be similar to the loose-fill system, using a hopper and dispenser to deposit the substrate. The system may further include modules for managing the growth environment within the cavity, such as a misting nozzle to maintain humidity and embedded temperature sensors, to optimize conditions for mycelial colonization. Over time, the spores grow to fill the entire cavity, forming a dense, rigid, and highly effective thermal and acoustic insulation material that is naturally fire-resistant and biodegradable.

The insulation installation process can be managed by the central controller of the translational slipform device, which synchronizes the insulation deposition with the printing of the walls, the movement of the locomotion system, and the operation of other integrated subsystems. The insulation may be inserted during the printing of a given layer, or once a set number of layers have been printed, or after the entire wall section has been created by the translational slipform device.

Spray foam variants that may be utilized via a nozzle-based spraying method include open-cell polyurethane foam, closed-cell polyurethane foam, polyisocyanurate (polyiso) spray foam, phenolic spray foam, bios-based spray foams, and water-blown foams. Other foam variants that may be inserted in the cavities included expandable bead and loose-fill foams, extruded polystyrene (XPS), expanded polystyrene (EPS), icynene or cellulose-based foam variants, or other foam variants. These may be extruded through a nozzle, released through a trapdoor and/or hopper configuration, or inserted mechanically as rigid sections that are stored on the device or manually fed to the device.

Insulation materials can include foam, fiberglass (which may be loose or in batts), mineral, rock, or slag wool, cellulose, cotton, sheep's wool, cork, perlite, vermiculite, shredded paper, or mycelium. For mycelium, implementations can allow mycelium to grow within the cavities of the walls after initial insertion. Radiant barriers and waterproofing materials may also be installed within the cavities of the walls created, further improving insulative and waterproofing properties of the structure being built.

The disclosed implementations can be configured to accomplish printing upside down relative to gravity (in an inverted orientation relative to the nominal printing orientation described therein. This is enabled by an adapted locomotion system that either grips on the internal wythe protrusions, onto the outer surface of the wythes, or some combination therein, or hangs off the wythes protrusions or top surface of the already printed wythes, allowing for the device to articulate and scale with appropriate function to carry out construction operations. In further embodiments, the device has quick curing devices described therein that prevents wythe layers being deposited from delaminating due to gravity. Other implementations apply a special adhesive, mortar, quick curing or reactive substance, or mechanical form of coupling (screws, nails, staples, magnets, etc.) between layers to keep them bonded to each other.

In various implementations, the device described herein is capable of printing in extraterrestrial environments, including zero-gravity environments, near-zero gravity environments, reduced gravity environments, and increased gravity environments. These environments can include on the lunar surface, the Martian surface, in space environments, on the surface of an asteroid or meteoroid, or on satellites or other bodies in space. The principle operations described therein apply in these environments, with certain pressures, actuation forces, and other variables able to be tuned to allow for appropriate operation in these environments. Shielding can be incorporated onto the device to protect from radiations forms in harsher, radiation exposed environments to preserve device functionality. In zero or near-zero gravity environments, the locomotion system can be adapted such that the system grips on the internal wythe protrusions, onto the outer surface of the wythes, or some combination therein, that allows for the device to articulate and scale with appropriate function to carry out construction operations.

In various implementations, the device described herein can be equipped with an internal fused deposition modelling (FDM), fused filament fabrication (FFF), stereolithography (SLA), Digital light processing (DLP), LCD-based resin printing, selective laser sintering (SLS), direct metal laser sintering (DMLS), Binder jetting, multi jet fusion, material jetting, direct energy deposition, laminated object manufacturing, or selective deposition lamination (SDL), or any combination thereof, that allows for the device to internally print conduit, plumbing, electrical cables or sheaths, reinforcement, insulation, HVAC ducting, or any related MEP items.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

1. A translational slipform device for three-dimensional (3D) printing of a structure, the device comprising:
an extruder having at least one chamber for receiving a print material, wherein the at least one chamber is defined by an inner formwork structure coupled to the outer formwork structure and movable with respect to the outer formwork structure, wherein the inner framework structure defines a cross section of a wall element in combination with the outer formwork structure;
a material supply in communication with the at least one chamber via at least one feed line;
a translational mechanism configured to translate the extruder along a printing path; and
an outer formwork structure defining an outer perimeter of a wall section to be printed.

2. The device of claim 1, further comprising an integrated inspection system configured to enable real-time data acquisition, processing, and closed-loop feedback to dynamically control a printing process.

3. The device of claim 2, wherein the inspection system comprises a multi-modal sensor suite and a data processing and control unit configured to receive data streams from the sensor suite.

4. The device of claim 3, wherein the multi-modal sensor suite comprises at least one sensor selected from the group consisting of: a Light Detection and Ranging (LiDAR) unit, a digital camera system for photogrammetric reconstruction, a structured light scanner, an Ultra-Wideband (UWB) radar sensor, and a thermal camera.

5. The device of claim 3, wherein the data processing and control unit is configured to:
generate a real-time digital model of the structure from the data streams;
compare the digital model to a pre-defined model to identify discrepancies; and
generate corrective commands to adjust a printing process based on the identified discrepancies.

6. The device of claim 2, wherein at least a portion of the inspection system is housed on a separate, ancillary robotic device wirelessly connected to a chassis containing the extruder, a material supply, translational mechanism, outer formwork structure, and an inner formwork structure.

7. The device of claim 1, further comprising an automated insertion system for installing reinforcing members within printed walls of the structure.

8. The device of claim 7, wherein the insertion system is configured to install a continuous reinforcing material, the continuous reinforcing material being fed from a spool assembly.

9. The device of claim 7, wherein the insertion system is configured to install discrete, modular reinforcing segments configured to be coupled together with couplers.

10. The device of claim 7, wherein the insertion system further comprises a pre-tensioning mechanism configured to apply a controlled tensile force to an installed reinforcing member to place the reinforcing member in tension.

11. The device of claim 10, wherein the pre-tensioning mechanism comprises at least one of: a mechanical actuator system including a ball screw, roller screw, or hydraulic cylinder; a threaded engagement mechanism including a servo motor and a corresponding nut or turnbuckle; or a non-contact heating element configured to apply tension via thermal expansion and contraction.

12. The device of claim 1, further comprising an automated insulation installation system configured to introduce insulation material into an interstitial cavity formed within printed walls of the structure.

13. The device of claim 12, wherein the insulation installation system comprises a nozzle-based spraying apparatus for applying a two-part, expanding foam insulation, the apparatus comprising pressurized reservoirs for holding chemical components and a proportioning pump system.

14. The device of claim 12, wherein the insulation installation system comprises a hopper configured to store bulk loose-fill insulation materials and a dispensing mechanism configured to release a controlled volume of the loose-fill material into the cavity.

15. The device of claim 12, wherein the insulation installation system comprises a multi-axis robotic arm mounted on the device, the robotic arm being equipped with a specialized end-effector configured to acquire a pre-formed insulation panel or batt and precisely lower the insulation into a cavity of the walls.

16. The device of claim 12, wherein the insulation installation system is configured to modify a gaseous environment within a sealed wall cavity by either using a vacuum pump to evacuate air from the cavity or using a pressurized tank to back-fill the cavity with an inert gas.

17. A method of printing a three-dimensional (3D) structure with a translational slipform device, the slipform device including an extruder having at least one chamber for receiving a print material, the chamber being defined by an outer formwork structure defining an outer perimeter of a wall section to be printed, and an inner formwork structure coupled to the outer formwork structure and movable with respect to the outer formwork structure, wherein the inner framework structure defines a cross section of a wall element in combination with the outer formwork structure, the slipform device further including a material supply in communication with the at least one chamber via at least one feed line, and a translational mechanism engaged with the structure and configured to translate the extruder along a printing path, the method comprising:
causing print material to flow from the material supply through the at least one feed line to the chamber to print a portion of a wall element; and
activating the translational mechanism to move the slipform device along the wall element.

18. The method of claim 17, further comprising dynamically controlling the printing process with an integrated inspection system configured to enable real-time data acquisition, processing, and closed-loop feedback.

19. The method of claim 18, wherein the inspection system comprises a multi-modal sensor suite and a data processing and control unit configured to receive data streams from the sensor suite.

20. The method of claim 3, wherein the multi-modal sensor suite comprises at least one sensor selected from the group consisting of: a Light Detection and Ranging (LiDAR) unit, a digital camera system for photogrammetric reconstruction, a structured light scanner, an Ultra-Wideband (UWB) radar sensor, and a thermal camera.

21. The method of claim 19, wherein the data processing and control unit is configured to:
generate a real-time digital model of the structure from the data streams;
compare the digital model to a pre-defined model to identify discrepancies; and
generate corrective commands to adjust a printing process based on the identified discrepancies.

22. The method of claim 18, wherein at least a portion of the inspection system is housed on a separate, ancillary robotic device wirelessly connected to a chassis containing the extruder, the material supply, the translational mechanism, the outer formwork structure, and the inner formwork structure.

23. The method of claim 17, further comprising installing reinforcing members within printed walls of the structure using an automated insertion system.

24. The method of claim 23, wherein the insertion system is configured to install a continuous reinforcing material, the continuous reinforcing material being fed from a spool assembly.

25. The method of claim 23, wherein the insertion system is configured to install discrete, modular reinforcing segments configured to be coupled together with couplers.

26. The method of claim 23, wherein the insertion system further comprises a pre-tensioning mechanism configured to apply a controlled tensile force to an installed reinforcing member to place the reinforcing member in tension.

27. The method of claim 26, wherein the pre-tensioning mechanism comprises at least one of: a mechanical actuator system including a ball screw, roller screw, or hydraulic cylinder; a threaded engagement mechanism including a servo motor and a corresponding nut or turnbuckle; or a non-contact heating element configured to apply tension via thermal expansion and contraction.

28. The method of claim 17, further comprising introducing insulation material into an interstitial cavity formed within printed walls of the structure using an automated insulation installation system.

29. The method of claim 28, wherein the insulation installation system comprises a nozzle-based spraying apparatus for applying a two-part, expanding foam insulation, the apparatus comprising pressurized reservoirs for holding chemical components and a proportioning pump system.

30. The method of claim 28, wherein the insulation installation system comprises a hopper configured to store bulk loose-fill insulation materials and a dispensing mechanism configured to release a controlled volume of the loose-fill material into the cavity.

31. The method of claim 28, wherein the insulation installation system comprises a multi-axis robotic arm mounted on the device, the robotic arm being equipped with a specialized end-effector configured to acquire a pre-formed insulation panel or batt and precisely lower the insulation into a cavity of the walls.

32. The method of claim 28, wherein the insulation installation system is configured to modify a gaseous environment within a sealed wall cavity by either using a vacuum pump to evacuate air from the cavity or using a pressurized tank to back-fill the cavity with an inert gas.

33. The method of claim 23, wherein installing reinforcement members within printed walls comprises:
retrieving a reinforcement bar and positioning the reinforcement bar at a predetermined reinforcement location;
moving the reinforcement bar into the chamber with an insertion member;
maintaining the correct alignment of the reinforcement element during material deposition;
depositing concrete material into the chamber to form a layer segment; and retracting the insertion member upward after layer segment completion.
